(19) United States
(12) Patent Application Publication
(10) Pub. No.: US 2003/0177202 A1
(43) Pub. Date: Sep. 18, 2003

(54) Method and apparatus for executing an instruction in a web page

(76) Inventors: Aruna Rohra Suda, Yokohama-Shi (JP); Suresh Jeyachandran, Yokohama-Shi (JP); Prem Anand Joseph, Yokohama-Shi (JP)

Correspondence Address: MORGAN & FINNEGAN, L.L.P., 345 Park Avenue, New York, NY, 10154-0053, US

(21) Appl. No.: 10/387,002

(22) Filed: Mar. 12, 2003

(30) Foreign Application Priority Data
Mar. 13, 2002 (JP) 2002-067868
May 16, 2002 (JP) 2002-141403

(51) Int. Cl. G06F 15/16

(52) U.S. Cl. 709/218; 715/501.1

(57) ABSTRACT

In an information processing apparatus, a processing instruction is obtained from a displayed web page in response to an operation of a button or a mark provided on the page, the obtained processing instruction is transferred to a processing unit which is able to execute the processing instruction, and the transferred processing instruction is executed by the processing unit which is also in the processing apparatus or in a server connected to the apparatus via a network.

### CLAIM FOR PRIORITY

This application claims priority from Application Nos. 2002-067868 and 2002-141403, filed on Mar. 13, 2002 and May 16, 2002 respectively in JAPAN.

### FIELD

This invention relates to an information processing method and apparatus, and more particularly a method and apparatus for executing a processing instruction during a web page is displayed.

### BACKGROUND

A conventional personal computer can access to the Internet and display a web page using browser software. Currently, some web sites, provide a mechanism which can print, send the contents, or store the links of web pages. However, they do not allow the saving of the contents of the web page, processing of the web page like annotating the contents, sending annotated contents, extracting only required data from the displayed page.

Accordingly, there is a need for a method and apparatus that resolves the above-mentioned problems.

### SUMMARY

According to one embodiment, the present invention relates to an information processing method comprising the steps of obtaining a processing instruction from a displayed web page; and transferring the obtained processing instruction to a processing unit which is able to execute the processing instruction.

According to another embodiment, the present invention relates to an information processing method comprising the steps of obtaining a processing instruction from a displayed web page; and executing the obtained processing instruction.

According to still another embodiment, the present invention relates to an information processing apparatus comprising obtaining means for obtaining a processing instruction from a displayed web page; and transfer means for transferring the obtained processing instruction to a processing unit which is able to execute the processing instruction.

According to yet another embodiment, the present invention relates to an information processing apparatus comprising obtaining means for obtaining a processing instruction from a displayed web page; and execution means for executing the obtained processing instruction.

According to a further embodiment, the present invention relates to an information processing system in which a plurality of client terminals are connected to a server via a network, wherein each of said client terminals comprising obtaining means for obtaining a processing instruction from a displayed web page; and transfer means for transferring the obtained processing instruction to a processing unit which is able to execute the processing instruction.

According to a further embodiment, the present invention relates to a computer-executable program for controlling a computer to perform information processing, said program comprising codes for causing the computer to perform obtaining a processing instruction from a displayed web page; and transferring the obtained processing instruction to a processing unit which is able to execute the processing instruction.

According to a further embodiment, the present invention relates to a computer-executable program for controlling a computer to perform information processing, said program comprising codes for causing the computer to perform obtaining a processing instruction from a displayed web page; and executing the obtained processing instruction.

Other features and advantages of the present invention will be apparent from the following description taken in conjunction with the accompanying drawings, in which like reference characters designate the same or similar parts throughout the figures thereof.

### BRIEF DESCRIPTION OF THE FIGURES

The accompanying drawings, which are incorporated in and constitute a part of the specification, illustrate embodiments of the invention and, together with the description, serve to explain the principles of the invention.

FIG. 1 is a block diagram illustrating the hardware configuration according to an embodiment of the present invention.

FIG. 2 is a flowchart of the procedural steps of an information processing system to process a web page.

FIG. 3 shows an example of the web page to be processed by the information processing system embodying the present invention.

FIG. 4 is a flowchart of the procedural steps of Instruction Fetcher of this embodiment.

FIG. 5 is a flowchart of the procedural steps of Instruction Processor of this embodiment.

FIG. 6 is a flowchart of the procedural steps of Instruction Processor of this embodiment.

FIG. 7 shows an example user interface of step S602 of this embodiment.

FIG. 8 is a flowchart of the procedural steps of Instruction Execution of this embodiment.

FIG. 9 is a flowchart of the procedural steps of Saving the displayed web page to a Filing System.

FIG. 10 shows example KPT System architecture for the information processing system embodying the current invention.

FIG. 11 is a flowchart of the procedural steps of Saving the displayed web page to KPT System.

FIG. 12 is a flowchart of the procedural steps of GetInput.

FIG. 13 shows an example web page along with the save user interface of the KPT System.

FIG. 14 shows an example web page along with the user interface directly embedded onto the web page.

FIG. 15 is a flowchart of the procedural steps of GetInput, wherein part of the parameters are obtained by the embodiment.

FIG. 16 shows an example web page along with the save user interface directly embedded onto the web page.

FIG. 17 shows another example of web page along with the save user interface directly embedded onto the web page.

FIG. 18 is a flowchart of the procedural steps of Send Instruction Processor.

FIG. 19 shows an example web page along with the send user interface directly embedded onto the web page.

FIG. 20 shows an example web page along with the send user interface of the KPT System.

FIG. 21 shows an example web page along with the embedded send user interface.

FIG. 22 shows an example web page along with the annotate user interface of the KPT System.

FIG. 23 is a flowchart of the procedural steps of annotate instruction processor of this embodiment.

FIG. 24 shows an example web page along with the embedded annotate user interface.

FIG. 25 shows another example web page along with the embedded annotate user interface for highlighting.

FIG. 26 shows an example web page along with the information extraction user interface of the KPT System.

FIG. 27 is a flowchart of the procedural steps of information extraction processor of this embodiment.

FIG. 28 shows an example web page along with the embedded information extraction user interface.

FIG. 29 shows an example User Interface of Retrieve, sorted by time or session order.

FIG. 30 shows an example User Interface of Retrieve, Get All Links UI sorted by Domains.

FIG. 31 shows an example User Interface of Get All Links UI sorted by Keywords.

FIG. 32 shows example User Interface of Retrieve.

FIG. 33 shows a Client-Server type implementation.

FIG. 34 shows an Application Service Provider (ASP) type implementation.

FIG. 35 is a flowchart of the procedural steps of Instruction Processor.

FIG. 36 shows an example user interface of the login screen displayed.

FIG. 37 is a flowchart of the procedural steps of Instruction Processor for Client Server or ASP type of architecture.

FIG. 38 shows an example web page after the save has been performed.

FIG. 39 shows an example User Interface of Retrieve, sorted by time or session order.

FIG. 40 is a flowchart of the procedural steps to determine if an instruction can be executed.

FIG. 41 shows an example user interface of the error message displayed to the user, when the save cannot be executed.

FIG. 42 is another flowchart of the procedural steps to determine if an instruction can be executed.

FIG. 43 shows an example web page along with the user interface after the save has been performed.

FIG. 44 shows an example display to explain how the limitation becomes applicable.

FIG. 45 shows an example user interface of the error message displayed to the user, when the save cannot be executed.

FIG. 46 shows an example web page along with the processing toolset directly embedded on the web page.

FIG. 47 shows an example web page along with the processing toolset for getting details of save.

FIG. 48 shows an example web page along with the annotation toolset for directly annotating on the web page being displayed.

FIG. 49 shows another example of web page along with the highlight annotation toolset for annotating on the web page being displayed.

FIG. 50 shows an example web page along with Extraction tool set to extract relevant information directly from the web page.

FIG. 51 shows another example User Interface of Retrieve.

FIG. 52 shows an example of other processes performed by this embodiment.

FIG. 53 shows an example knowledge base to keep track of the processing performed for a given page.

FIG. 54 shows an example of toolset to search for keywords within the displayed page.

FIG. 55 shows alternative system architecture for the embodiment.

FIG. 56 shows an example web page along with the ‘Keep this’ button and anchor displayed as part of the page.

FIG. 57 shows an example JavaScript program embedded within the web page shown in FIG. 56.

FIG. 58 is a flowchart of the procedural steps of Broker Agent.

FIG. 59 is a flowchart of the procedural steps of CheckForKPTSystem.

FIG. 60 is a flowchart of the main procedural steps.

FIG. 61 is a flowchart of INITIALIZE procedure.

FIG. 62 is a flowchart of MAIN-PROCESSOR.

FIG. 63 is a flowchart of the procedural steps of UserAction.

FIG. 64 is a flowchart of the procedural steps of CheckExisting.

FIG. 65 is a flowchart of the procedural steps of Annotate.

FIG. 66 is a flowchart of the procedural steps of Extract.

FIG. 67 is a flowchart of the procedural steps of Mgmt.

FIG. 68 is a flowchart of the procedural steps of ExecuteAction.

FIG. 69 is a flowchart of the procedural steps of SaveContents.

FIG. 70 is a flowchart of the procedural steps of WebFetch.

FIG. 71 is a flowchart of the procedural steps of SendContents.

FIG. 72 is a flowchart of the procedural steps of SaveFileContents.

FIG. 73 is a flowchart of the procedural steps of FillKptAction.

FIG. 74 is a flowchart of the procedural steps of TERMINATE.

FIGS. 75 and 76 show examples of the knowledge structures in the knowledge base.

FIGS. 77 and 78 show examples content of the knowledge base.

FIG. 79 is a flowchart of the procedural steps to process the PRINT command.

FIG. 80 is an example of Select Printer UI.

FIG. 81 is an example print output of the web page.

FIG. 82 is an example user interface within the web page to obtain the various parameters for PRINT.

FIG. 83 is an example print output of multiple web pages laid out onto a single page.

FIG. 84 shows another system architecture for this embodiment, when applied to Information Kiosk.

FIG. 85 shows an example web page displayed on the Information Kiosk along with commands embedded within the web page.

FIG. 86 is a flowchart of the procedural steps to process the commands on the Information Kiosk.

FIG. 87 shows an example UI of user settings.

FIG. 88 shows an example UI of user settings for making a CD for the information selected by the user.

FIG. 89 shows an example UI of for making the CD for the information collected by the user.

FIG. 90 shows another example of web page related to historic information with ‘Get this!’ button.

FIG. 91 shows another example of web page related to product information with ‘Get this!’ button.

FIG. 92 shows an example user settings for printed matter delivery.

FIG. 93 shows an example information database for this embodiment.

FIG. 94 shows another system architecture for the implementation of a standalone Information Kiosk for this embodiment.

FIG. 95 shows another system architecture for the implementation of a networked Information Kiosk for this embodiment.

FIG. 96 shows example architecture, when multiple clients access the embodiment.

FIG. 97 is a flowchart of the procedural steps of INITIALIZE for the system shown in FIG. 96.

FIG. 98 is an example Login UI for the step S9704.

FIG. 99 is a flowchart of the procedural steps of TERMINATE for the system shown in FIG. 96.

### DETAILED DESCRIPTION

A preferred embodiment of the present invention will now be described in detail with reference to the accompanying drawings.

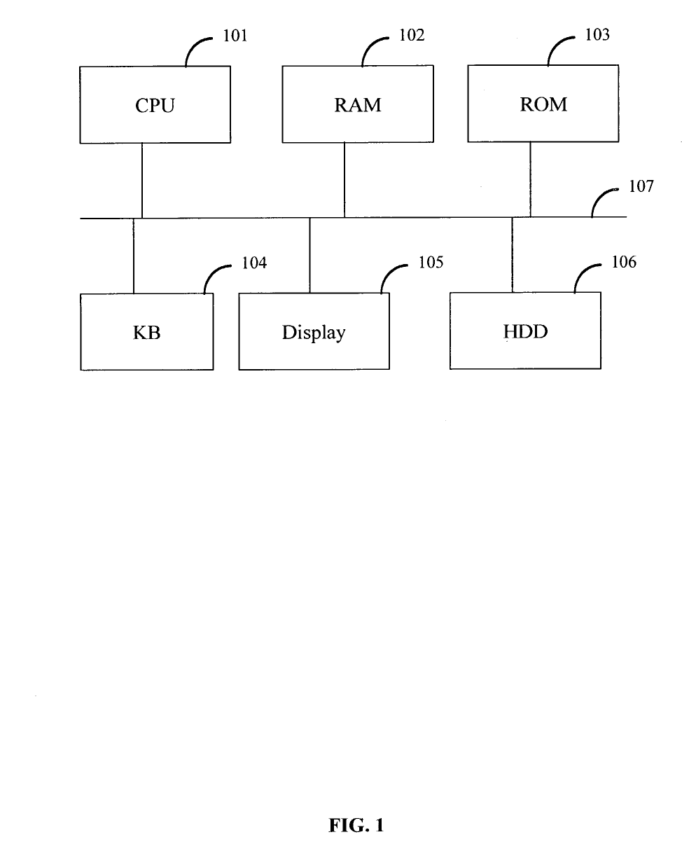

FIG. 1 is a block diagram illustrating the hardware configuration according to an embodiment of the present invention. In this figure, a central processing unit (CPU) 101 is operative to perform operations for various processing and make a logical decision or the like and further controls each composing element connected to a bus 107.

A RAM 102 temporarily stores variables and intermediate data generated during the processing. A program from an external source may be loaded into the RAM 102. A ROM 103 is used to store programs, which correspond to individual flowcharts that will be described later and which are to be executed by the CPU 101, and fixed data.

A keyboard (KB) 104 is used for inputting data and an instruction by a user. A mouse or other input devices may be used with the keyboard 104. Display 105 displays data and a hard disk drive (HDD) stores data of a database, a program, and the like.

The bus 107 is used to transfer an address signal indicating a composing element to be controlled by the CPU 101, a control signal used for controlling each composing element and data to be exchanged between the composing equipments.

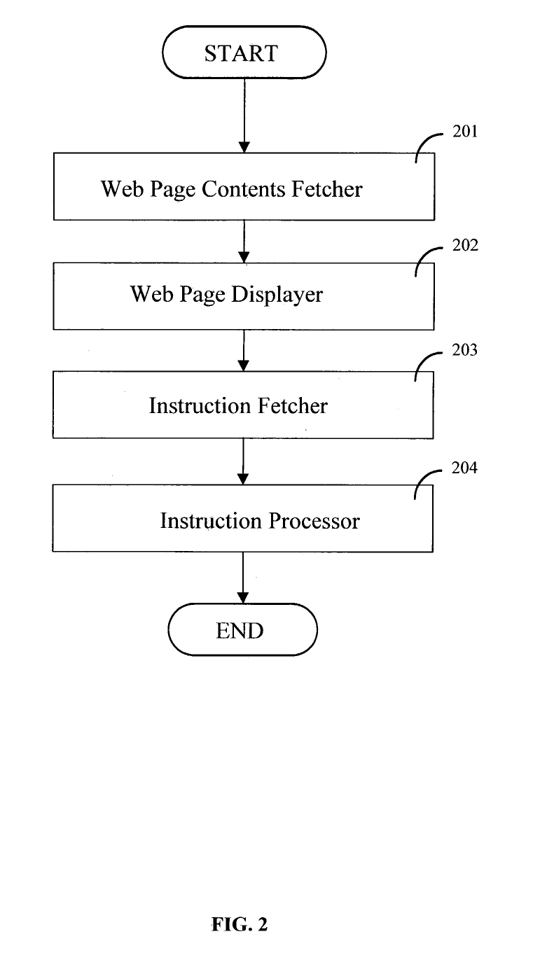

FIG. 2 is a flowchart of the procedural steps of an information processing system to process a web page. Web Page Contents Fetcher 201 is used for fetching the information from the server for allowing the information browsing of the web. Web Page Displayer 202 is used for displaying the actual contents of the web information. Instruction Fetcher 203 is an input means to used to get the instruction for processing the contents of the web page. Instruction Processor 204 is for processing and executing the instructions fetched by the Instruction Fetcher.

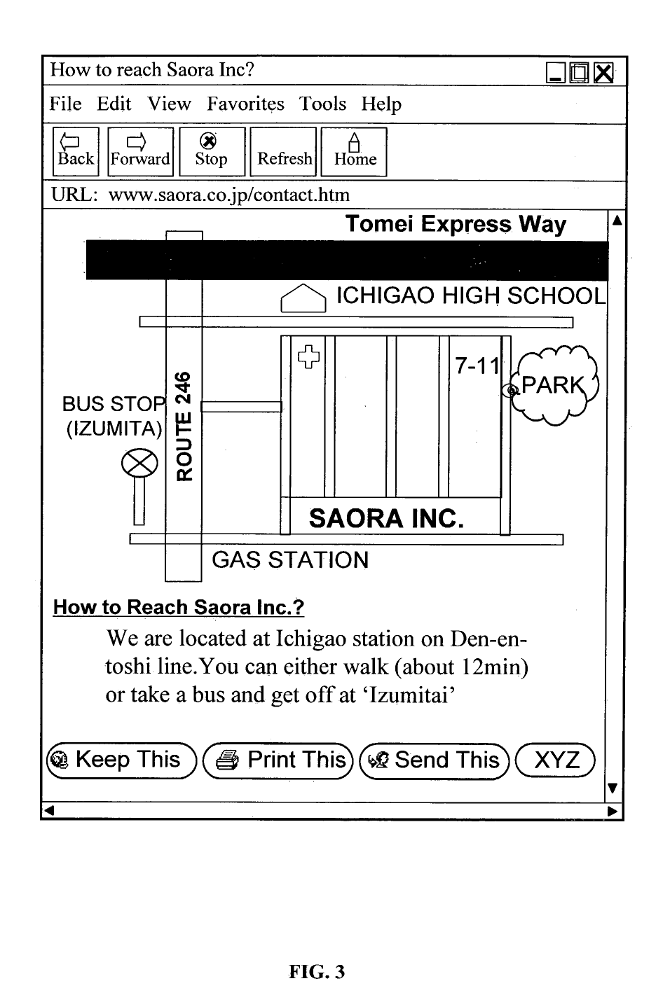

FIG. 3 shows an example of the web page to be processed by the information processing system embodying the present invention. As can be seen from the figure, using the “Keep This”, the web page currently being displayed can be saved. Similarly, using the “Print This” button, to print the page contents, “Send This” button to send the contents. Similarly, any other functionality can be added to the “XYZ” button, which lets the user while browsing, to perform various actions on the web page. For example, the user can annotate, highlight the contents of the web page, save or file the annotated web page, send the information to other people or extract only relevant information, retrieve saved information, translate the whole contents or part of contents, get a abstract of key points of the page and so on. The button referred to in this embodiment can also be implemented in other ways like for example an anchor or a link or a menu or any other type of display control.

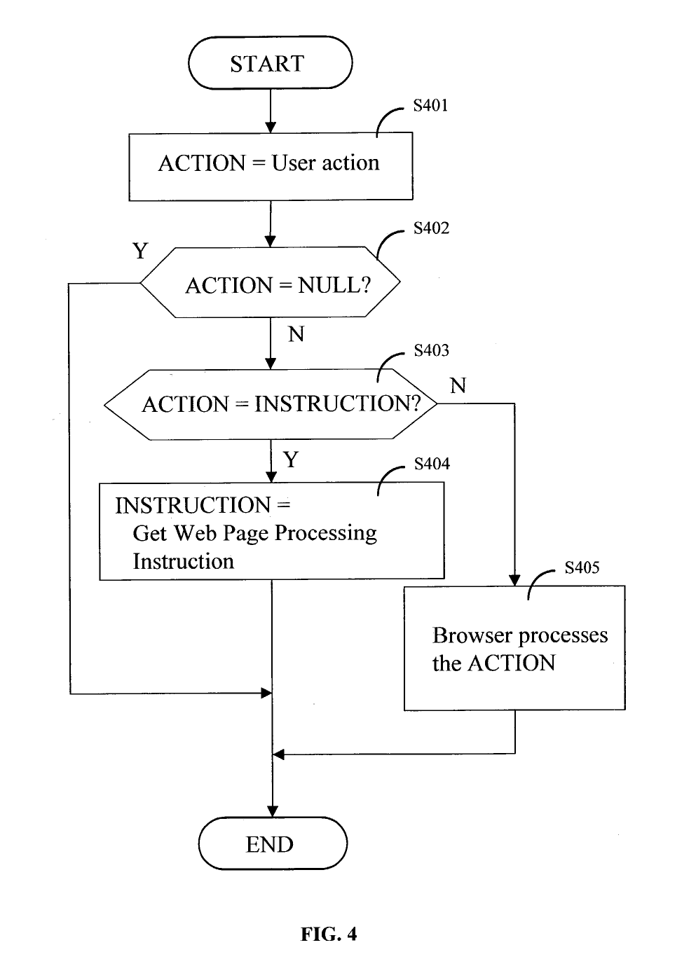

FIG. 4 is a flowchart of Instruction Fetcher 203 of this embodiment. In step S401, ACTION is set the user action performed by the user. In step S402 a check is made to determine if the ACTION is null or not. If so, the process ends otherwise, a check is made in step S403 to determine if the ACTION is an INSTRUCTION. If not, the browser in step S405 processes the ACTION and the process ends. The normal user actions like navigating to a different page or link, changing the character-set or encoding of the displayed page, changing the font size etc. are typical actions, which are performed by the browser. Otherwise, the instruction for processing the web page, for annotating, saving, processing the currently displayed web page is fetched and set as INSTRUCTION in step S404 and the process ends.

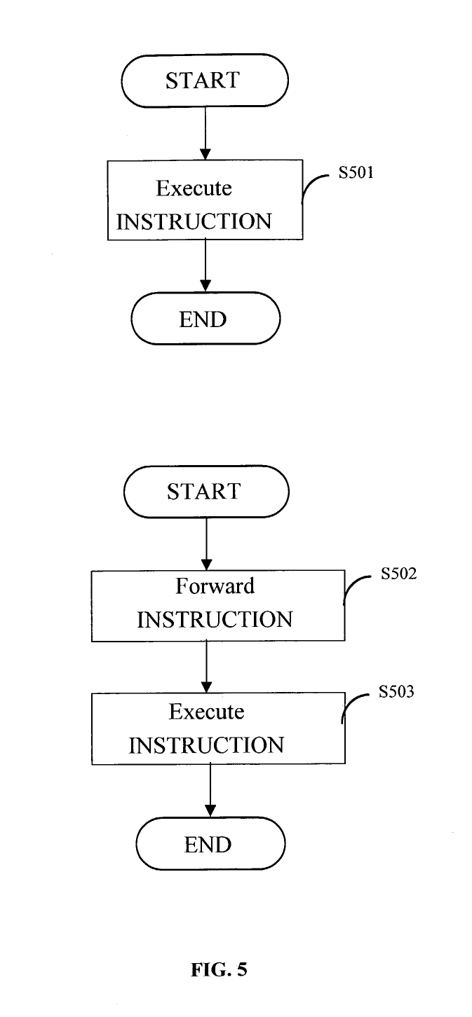

FIG. 5 is a flowchart of the procedural steps of Instruction Processor 204 of this embodiment. The Instruction Processor can be of two types. In the first case, the INSTRUCTION procured is directly processed by the program embedded onto the web page in step S501. For example, annotating onto a web page or data extraction from a web page can be directly performed. In the second case, the Instruction is forwarded in step S502 to the actual Instruction executor, which executes the instruction in step S503. For example, saving or sending the web page contents can be processed in either of the above two ways.

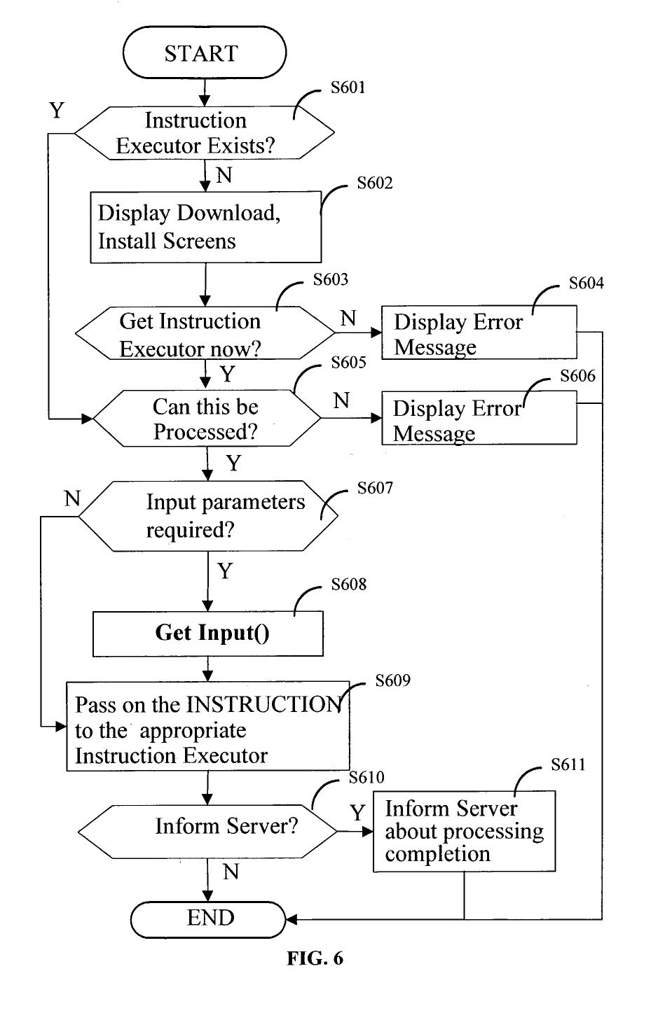

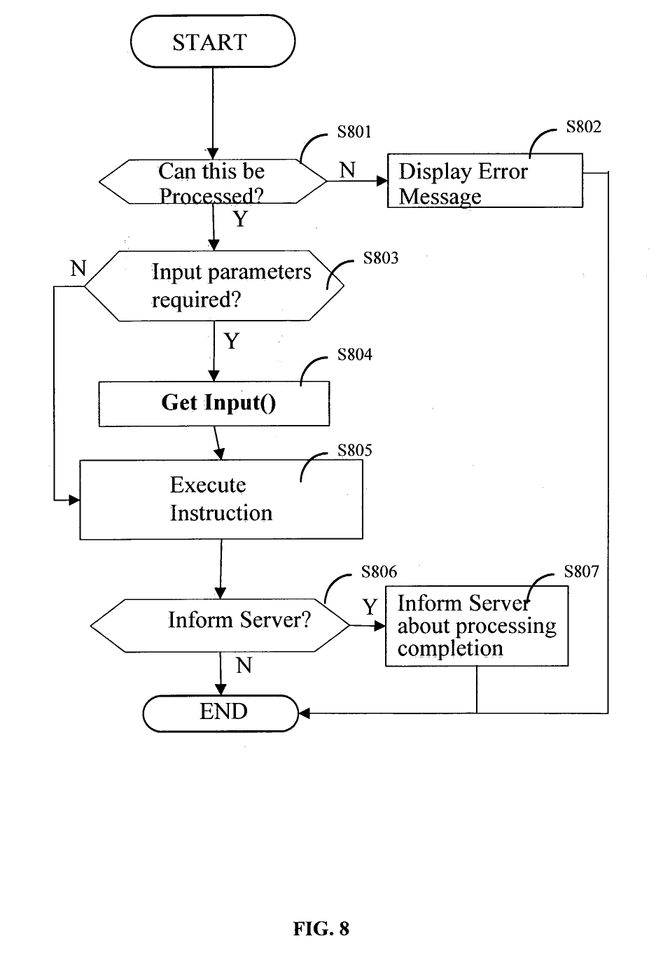

Instructions can be broadly classified into two types. Instruction Type A, whose processing is explained in FIG. 6, like Save, Send, . . . which do not directly affect the contents of the page being displayed and are final actions which can be performed by either the client or on the server. Instruction Type B like Annotate, Extract, . . . , whose processing explained in FIG. 8 affect the contents of the web page being displayed and are not the final resultant actions. For example, after annotating the page, the user needs to perform some other action like Save, Send, Print etc . . . Similarly after Extracting, the user needs to save, send, export to address book, print or dump to file etc . . . Also the Instructions of Type B have to be performed on the client, since they directly affect or have to performed on the contents of the web page.

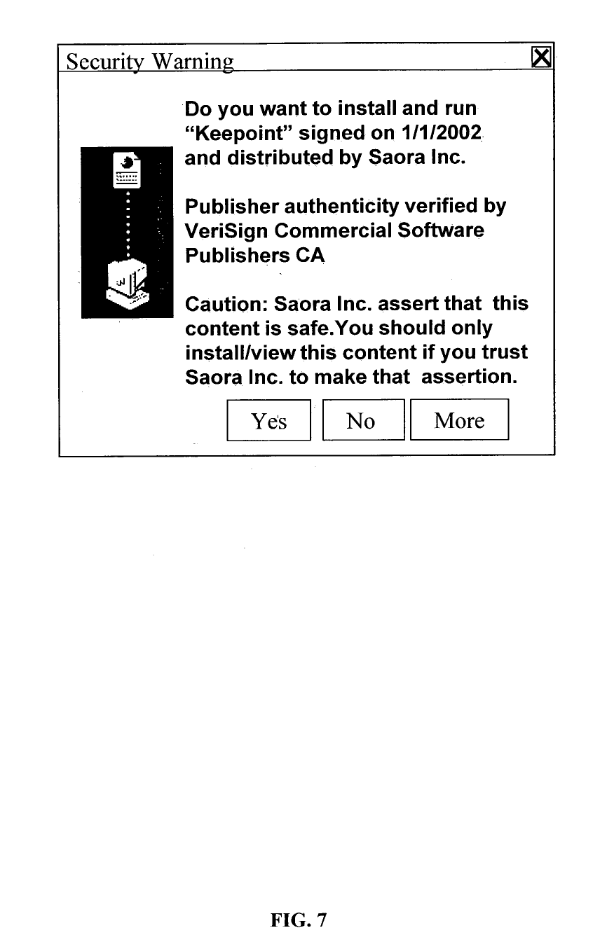

FIG. 6 is a flowchart of the procedural steps of Forward Instruction S502 of this embodiment. A check is made in step S601 to determine if the instruction execution module for this Instruction exists. If so, the process proceeds to step S605, otherwise, step S602 is executed, wherein the download and install screens are shown to the user, an example of which is shown in FIG. 7 and proceeds to step S603, to determine if the Instruction executor needs to be obtained or downloaded now. If not, an error message is displayed in step S604 and the process ends. Otherwise step S605 is executed, wherein a check is made to determine if the instruction can be processed. If so the process proceeds to step S607, otherwise an error message is displayed in step S606 and the process ends. In step S607, a check is made to determine if the input parameters are required to be obtained. If so, the process proceeds to step S608, wherein GetInput is executed whose details will be explained later. In either case step S609 is executed, wherein the instruction is passed on to the appropriate instruction executor. In step S610, a check is made to determine if the server needs to be informed. If so step S611 is executed wherein, a message is sent to the server to inform that the page has been processed by the client or the user and if a knowledge base exists in the client it is also updated. This step is performed to collect a log of actions performed by various users and can also be used to generate statistics for e.g., most popular ie., most saved, most sent etc . . . In either case the process ends. In step S602, the message can be to download and start the installation process or just a message to inform the user that the program does not exist and has to be downloaded and installed, at which point the user can either download from a website, install using a CD-ROM etc.

FIG. 7. is an example user interface of S602. A security warning screen is displayed to assure the user of the authenticity of the component being installed. If user chooses not to install, an error message will be displayed.

FIG. 8 is a flowchart of the procedural steps of Execute Instruction S501 of this embodiment. A check is made in step S801 to determine if the instruction can be processed. If not, an error message is displayed and the process ends. Otherwise, step S803 is executed, wherein, a check is made to determine if the input parameters are required to be obtained. If so, the process proceeds to step S804, wherein GetInput is executed whose details will be explained later. In either case step S805 is executed, wherein the actual instruction is executed. In step S806, a check is made to determine if the server needs to be informed. If so step S807 is executed wherein, a message is sent to the server to inform that the page has been processed by the client or the user and if a knowledge base exists in the client it is also updated.

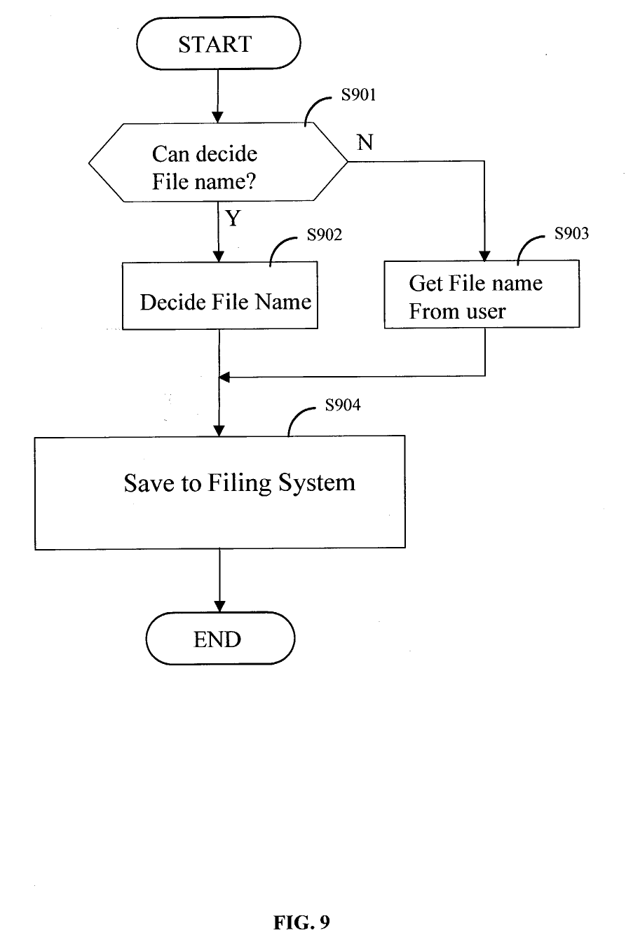

FIG. 9 is a flowchart of the procedural steps of Saving the displayed web page to a Filing System. In step S901, a check is made to determine if the file name can be decided without user intervention. If so, the file name is decided in step S902, otherwise step S903 is executed wherein the file name is obtained from the user. In either case in step S904, the actual save to the filing system is performed and the process ends.

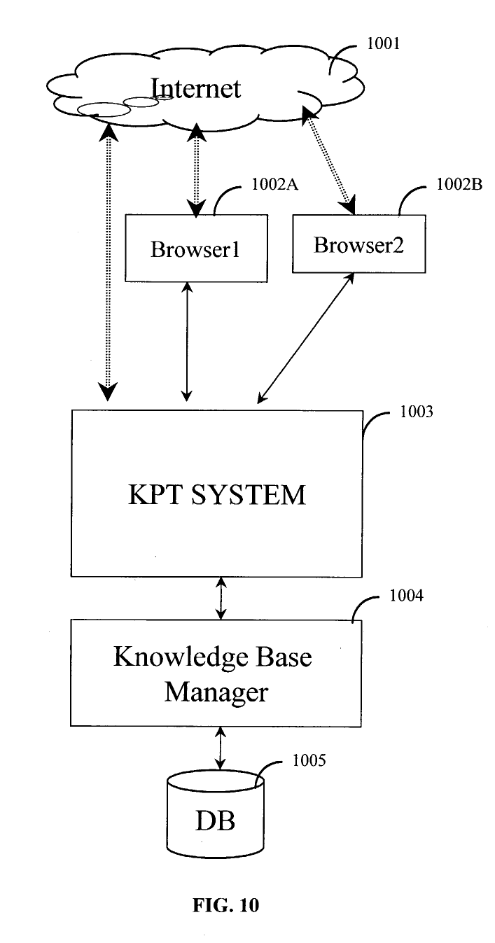

FIG. 10 shows example KPT System architecture information processing system embodying the current invention. The information on the Internet 1001 is browsed using multiple browsers 1002A, 1002B simultaneously and as explained in this embodiment. KPT System 1003 handles and processes them separately, interacts and acts as a controlling system as explained in detail in this embodiment to Browser 1002. Knowledge Base Management 1004, is the management of knowledge accessed/stored from/to the Database 1005.

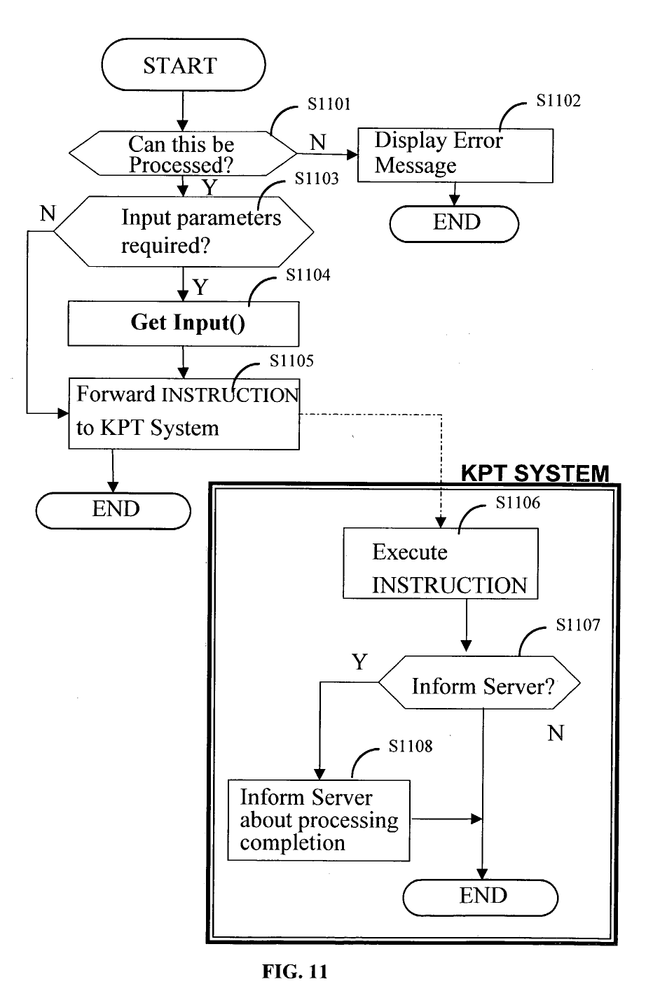

FIG. 11 is a flowchart of the procedural steps of Saving the displayed web page to KPT System. Steps S1101 to S1104 are exactly same as S801 to S804 of FIG. 8. In step S1105, the parameters obtained are passed along with the Instruction to the KPT System. The KPT System executes the forwarded instruction in step S1106 and in step S1107, a check is made to determine if the server needs to be informed. If so, step S1108 is executed wherein, a message is sent to the server to inform that the page has been processed by the client or the user and if a knowledge base exists in the client it is also updated. For example, it is not necessary for the KPT System to have a user interface and hence for example, when the user presses ‘Keep This, the KPT System, without any more user intervention, saves the contents of the web page.

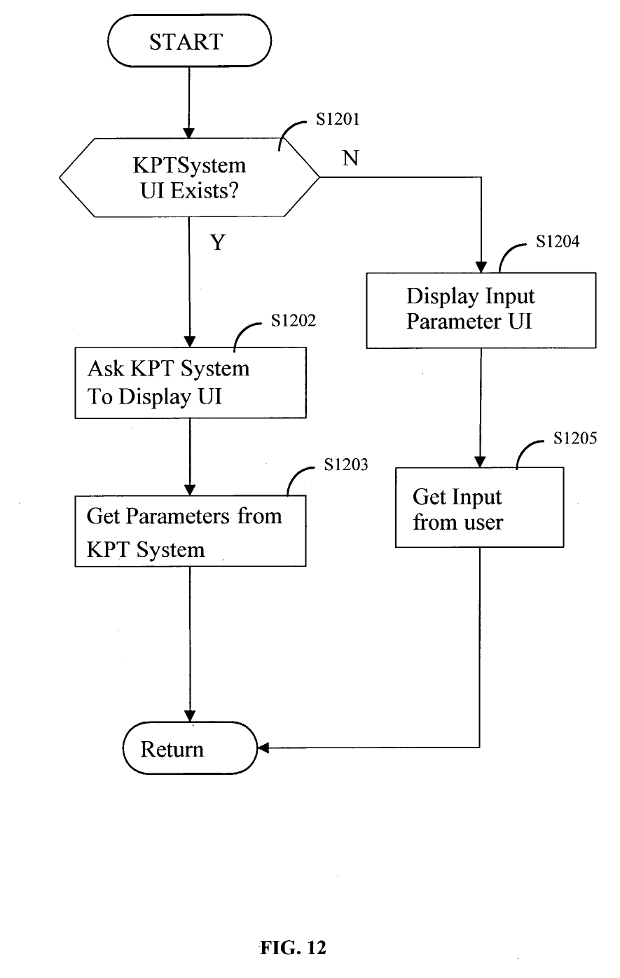

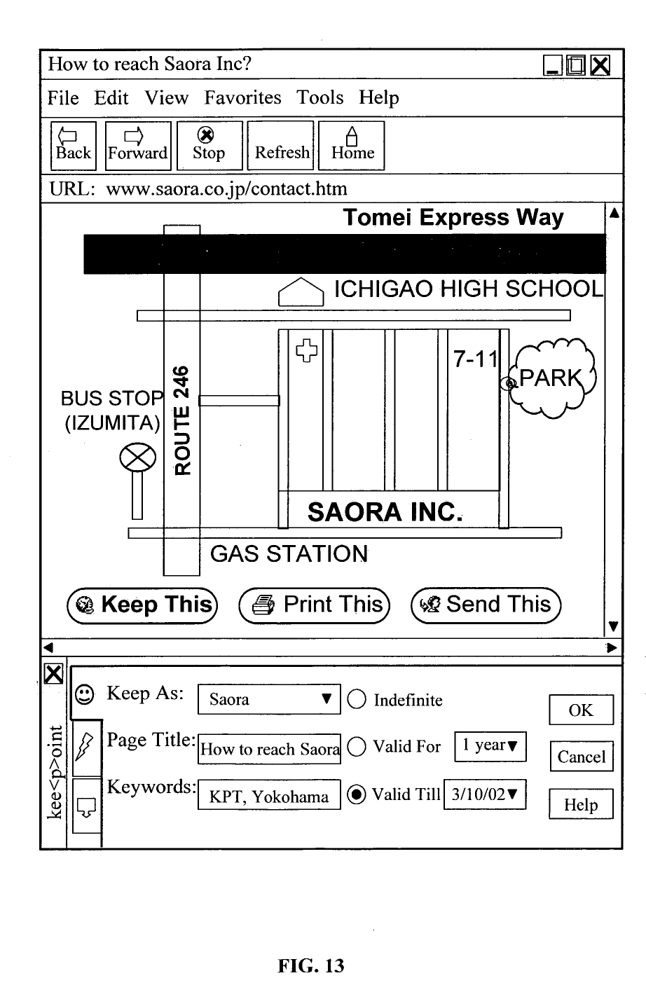

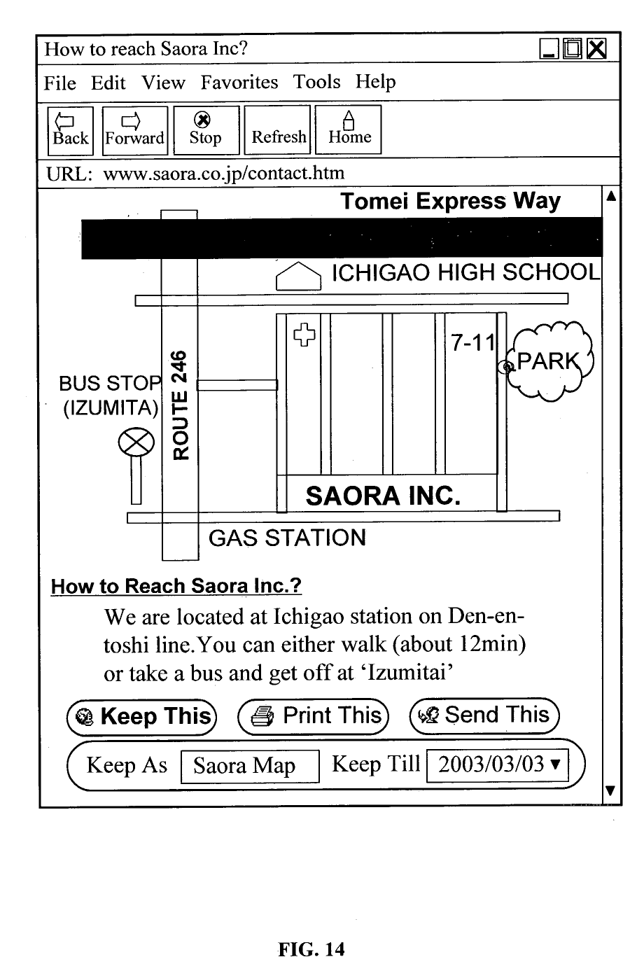

FIG. 12 is a flowchart of the procedural steps of S608, S804 GetInput. A check is made in step S1201, to determine if KPT System has user interface to get the input parameters from the user or otherwise. If so, request or message is sent to KPT System to display UI in S1202, for example FIG. 13 and the parameters obtained from the KPT System in step S1203. Otherwise, the input parameter user interface is displayed directly within the web page, by the associated function in step S1204, for example FIG. 14 and the actual input obtained from the user in step S1205 and the process ends.

FIG. 13 shows an example web page along with the save user interface displayed by the KPT System in step S1202.

FIG. 14 shows an example web page along with the user interface directly embedded onto the web page, displayed in step S1204.

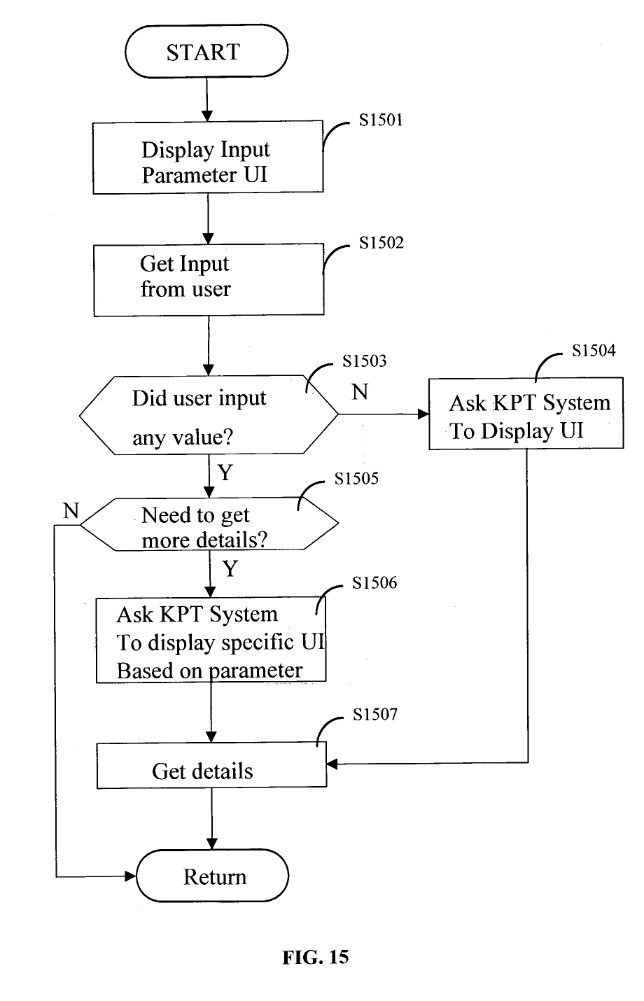

FIG. 15 is a flowchart of the procedural steps of GetInput, wherein part of the parameters are obtained by the embodiment. GetInput can also be implemented in other ways. For example, the associated function can first get either the complete input or partial input and then request KPT System to display appropriate user interface. In step S1501, the input parameter user interface is displayed and the input obtained from the user in step S1502. A check is made in step S 1503 to determine if the user input values. If no, the KPT system is asked to display the user interface in step S1 504, otherwise, a check is made in step S1505 to determine if more details are to be input, if not the process returns, otherwise step S1506 is executed wherein the KPT System is asked to display the specific user interface based on the parameters input by the user. In step S1507, the parameters are obtained and the process returns.

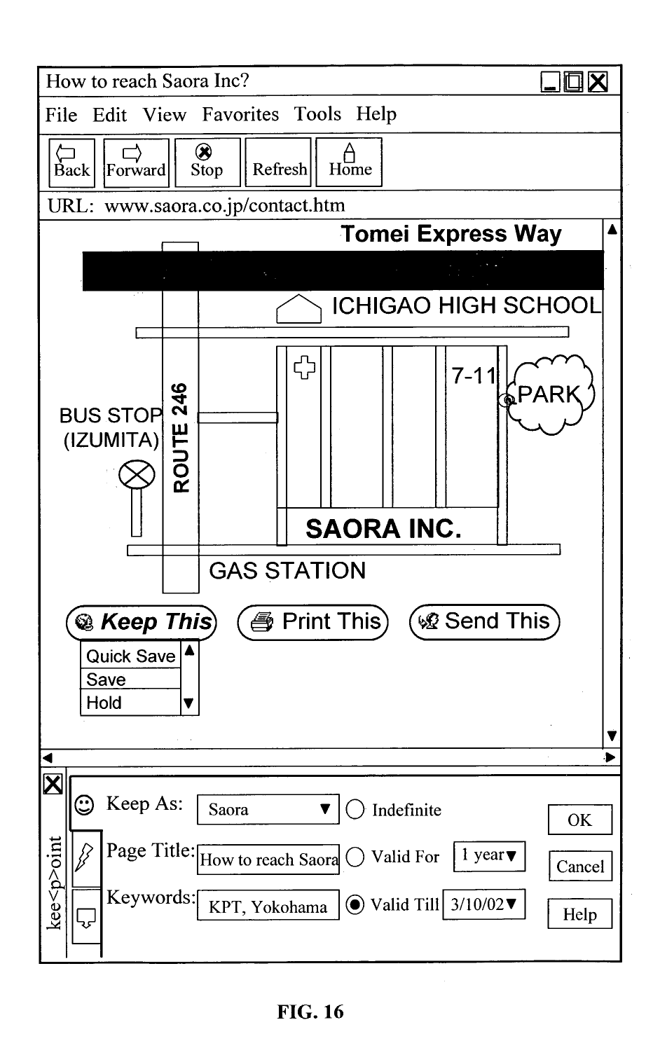

FIG. 16 shows an example web page along with the save user interface directly embedded onto the web page

When user presses, ‘Keep This’, the user is prompted to select the type of Save e.g., Quick Save, Save, Hold etc . . . in the shown example, user has selected Save, hence Save ser interface is presented by KPT System. If QuickSave had been selected no user interface would have been shown by KPT system and the process would have just saved the page.

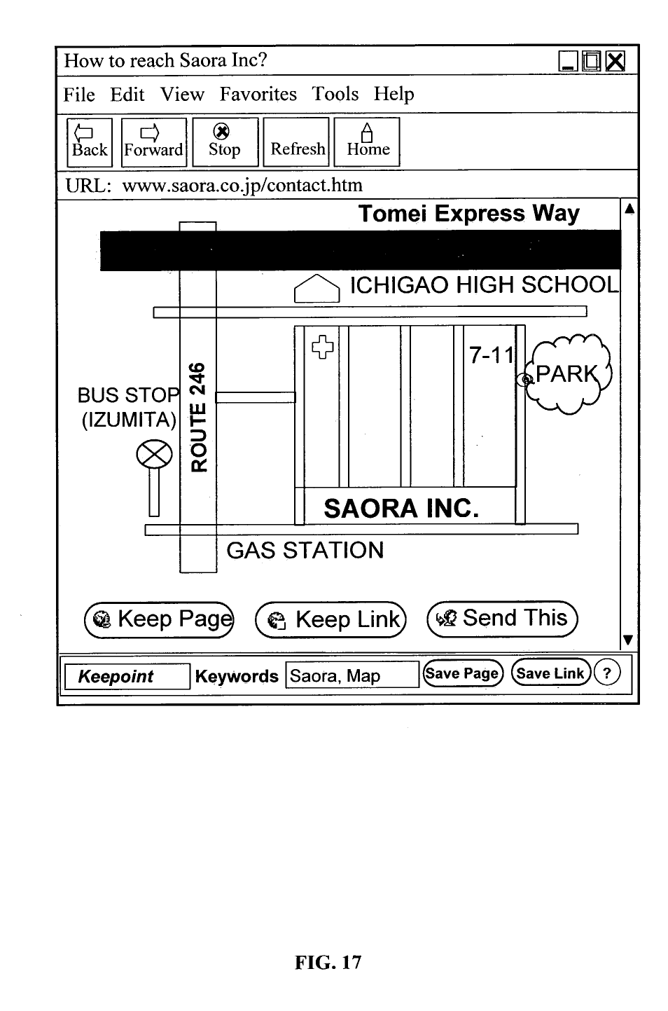

FIG. 17 shows another example of web page of FIG. 16 in which case each of the functionality can be put into separate buttons or anchors. For example, if Keep Page and Keep Link can be presented to user as two different buttons.

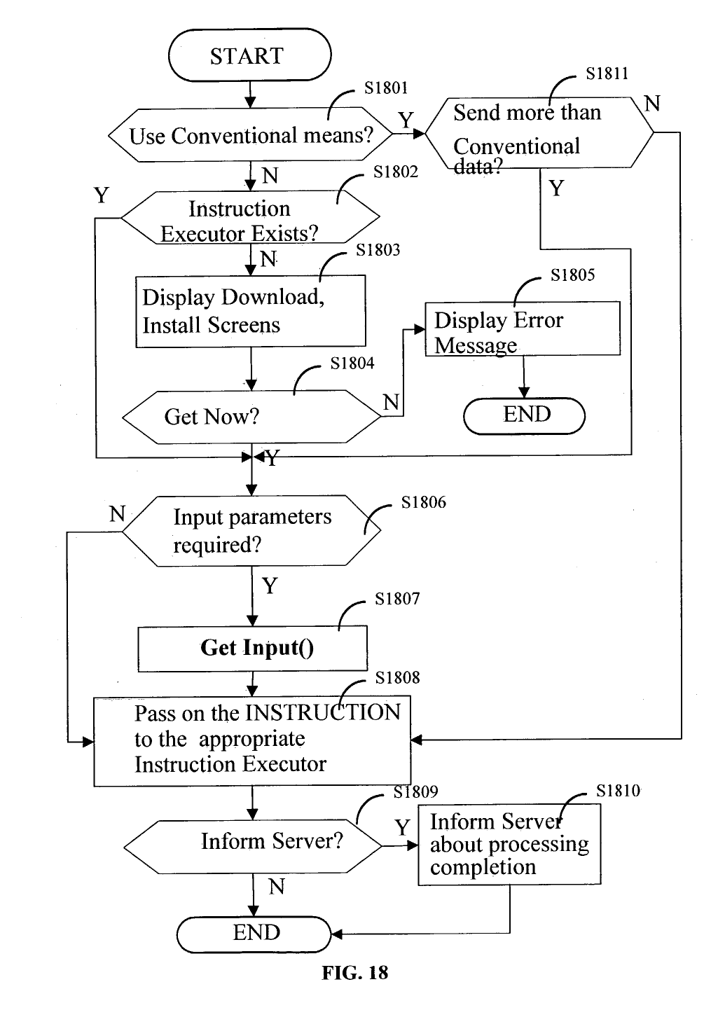

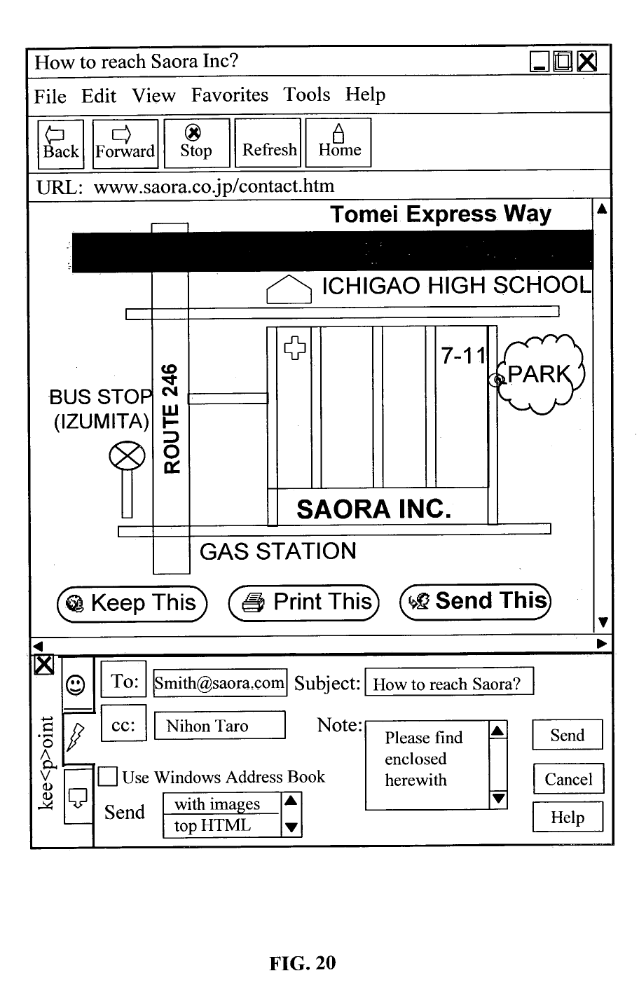

FIG. 18 is a flowchart of the procedural steps of Send Instruction Processor, which is similar to FIG. 6. A check is made in step S1801 to determine if conventional means are to be used for sending the information. Conventional means imply, browser or the messaging system will display the user interface, construct the email message, by getting the email recipients, subject and other details, before the message is sent. But in conventional means only send a link, or the page contents without the embedded images is allowed. If conventional means are to be used, a check is made in step S1811 to determine if more than conventional data, implying either link only or the page contents without embedded images is to be sent. If only conventional data is to be sent then process proceeds to step S1808 and passes the data to browser or the messaging system. If more than conventional data has to be sent i.e., for example, embedded images, the input parameter need to be obtained and process proceeds to step S1806. If conventional means are not be used then, step S1802 is executed wherein, a check is made in step S1802 to determine if the instruction execution module for this Instruction exists. If so, the process proceeds to step S1804, otherwise, step S1803 is executed, wherein the download and install screens are shown to the user, an example of which is shown in FIG. 7 and proceeds to step S1804, to determine if the Instruction executor needs to be obtained or downloaded now. If not, an error message is displayed in step S1805 and the process ends. In step S1806, a check is made to determine if the input parameters are required to be obtained. If so, the process proceeds to step S1807, wherein GetInput is executed whose details were explained in earlier, the details of what to send, i.e., send only the link, or send the top level page i.e., without embedded images or send the contents along with the embedded images etc . . . are obtained in S1807, an example user interface of this is shown in FIG. 20. In either case step S1808 is executed, wherein the instruction is passed on to the appropriate instruction executor. In step S1809 a check is made to determine if the server needs to be informed. If so step S1810 is executed wherein, a message is sent to the server to inform that the page has been processed by the client or the user and if a knowledge base exists in the client it is also updated.

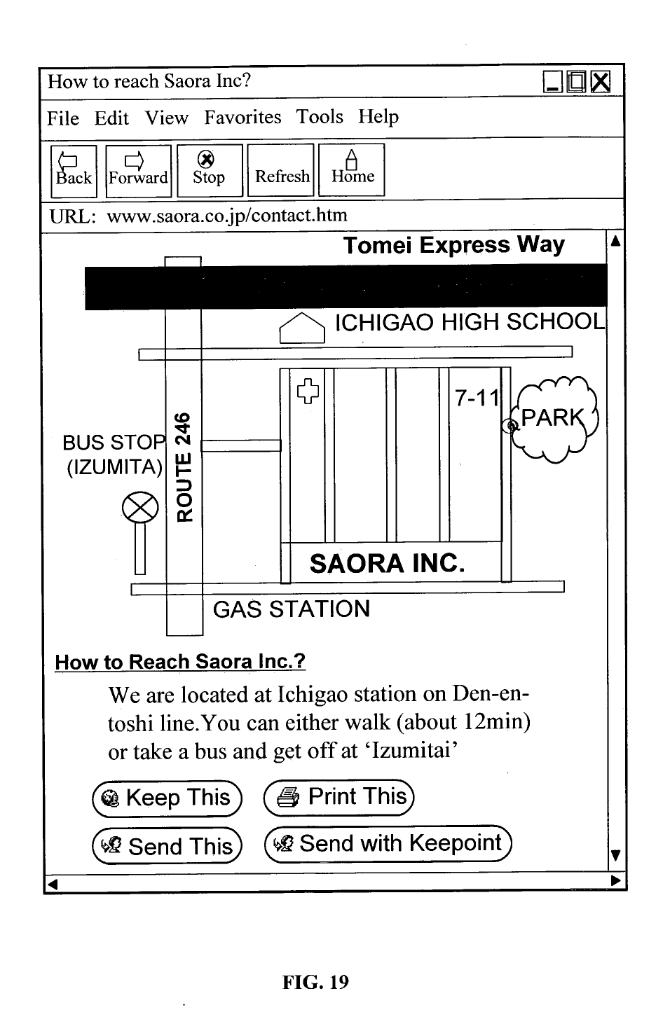

FIG. 19 shows an example web page along with the send user interface directly embedded onto the web page. As can be seen from the figure, send by conventional means or otherwise are implemented as two separate options i.e., buttons or anchors—“Send This” and “Send with Keepoint” respectively.

FIG. 20 shows an example web page along with the send user interface of the KPT System.

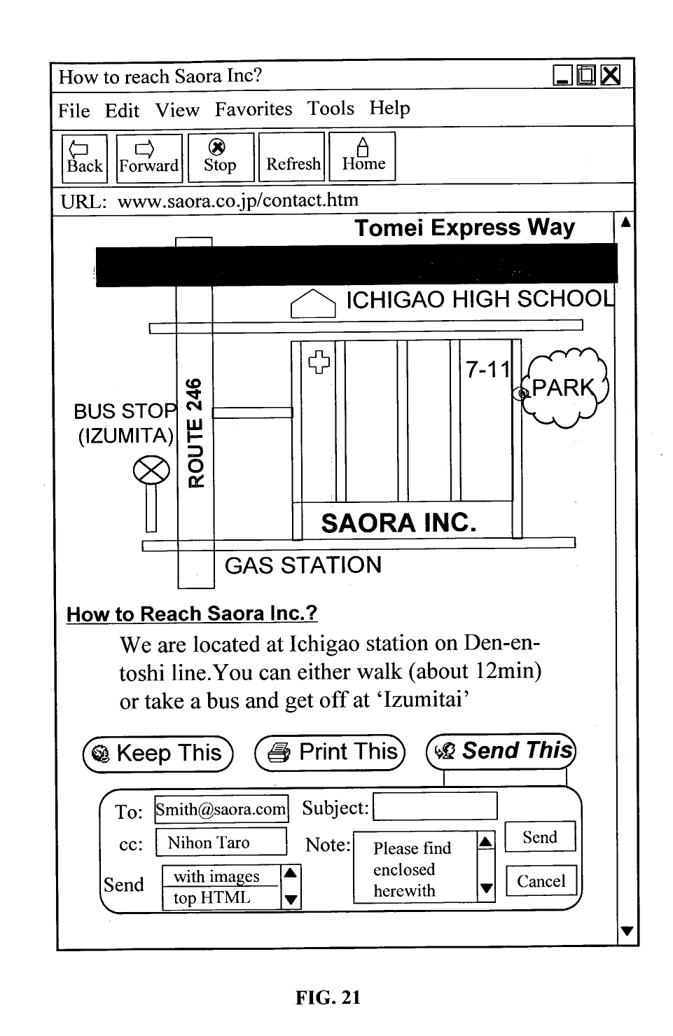

FIG. 21 shows an example web page along with the embedded send user interface. As can be seen from the figure the user interface is displayed by the button itself or within web page. The details of what to send, i.e., send only the link, or send the top level page i.e., without embedded images or send the contents along with the embedded images etc . . . are obtained before executing the actual send.

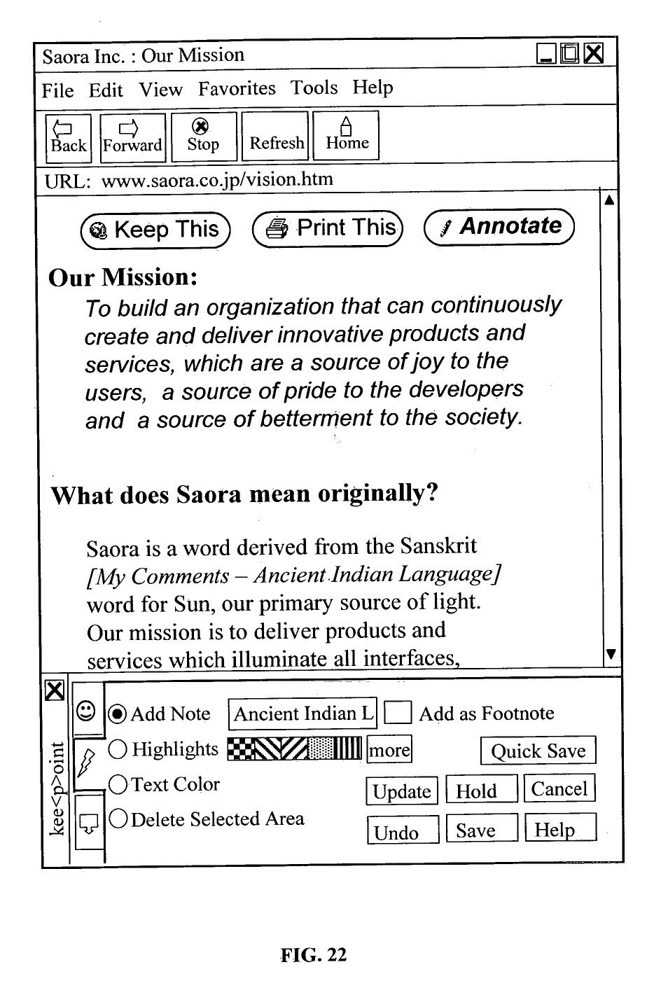

FIG. 22 shows an example web page along with the annotate user interface of the KPT System.

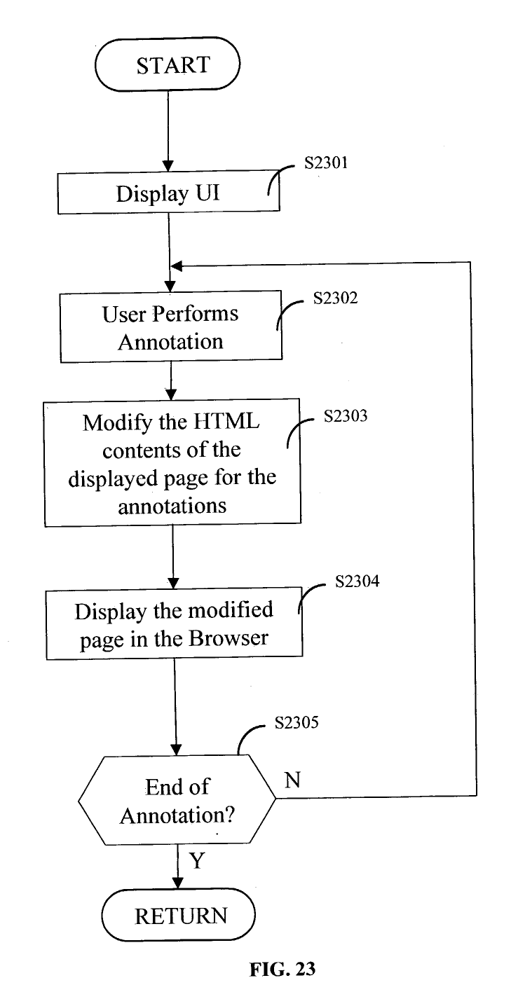

FIG. 23 is a flowchart of the procedural steps of annotate instruction processor of this embodiment. As can be seen from the figure, in step S2301, the user interface to allow the user to annotate the page, is displayed. In step S2302, annotations performed by the user are obtained. In step S2303, the embodiment, incorporates the annotations performed by the user into the page's HTML being displayed and proceeds to step S2304, where the modified HTML page is displayed by the browser. A check is made in step S2305 to determine if the user has finished with the annotation process. If so, the process returns otherwise, the process moves back to S2302 to allow the user to perform more annotations on the page.

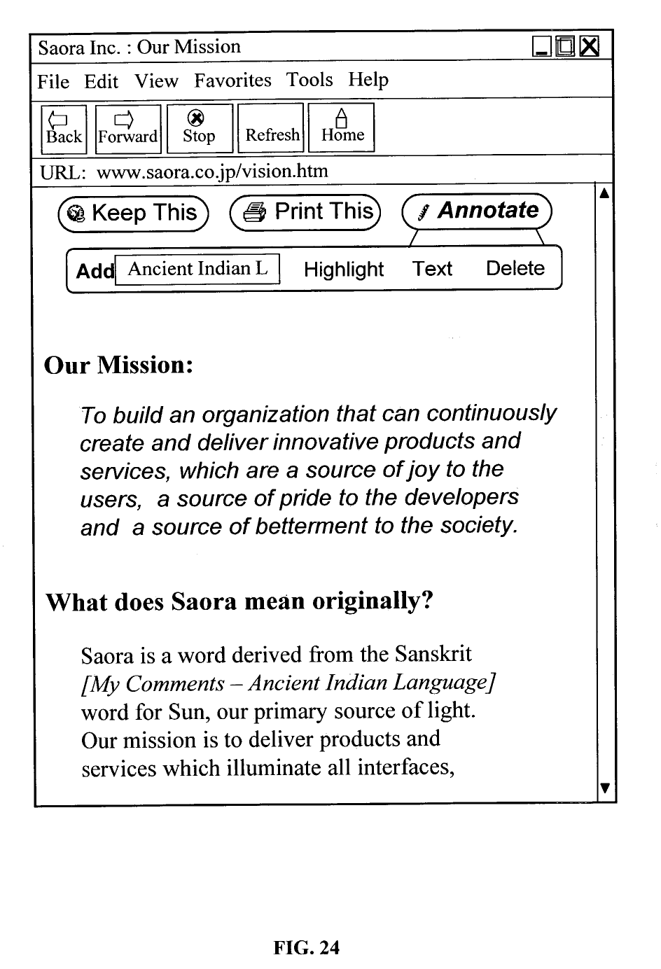

FIG. 24 shows an example web page along with the embedded annotate user interface for directly annotating on the web page being displayed. As can be seen in the figure, the user has added a note ‘[My Comments—Ancient Indian Language]’ directly onto the web page next to the word ‘Sanskrit’ using the ‘Add’ functionality embedded directly on the web page. The user can also change the text color, highlight portions of text or delete unnecessary text.

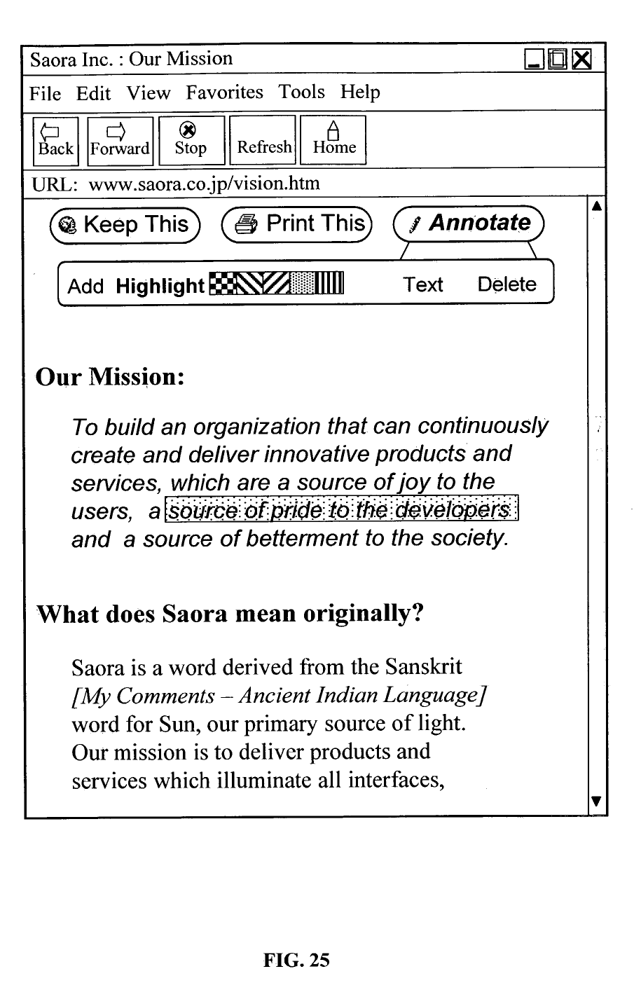

FIG. 25 shows another example web page along with the embedded annotate user interface for highlighting. As can be seen from this figure, part of the text ‘source of pride to the developers’ has been highlighted using the ‘highlight’ facility of the toolset. The annotations are directly embedded into the web page as standard HTML tags and no proprietary mechanism is required to achieve the annotations, which is beneficial to the user, since the user can send the annotated page by email to a recipient, who can view the annotated page using a standard web browser.

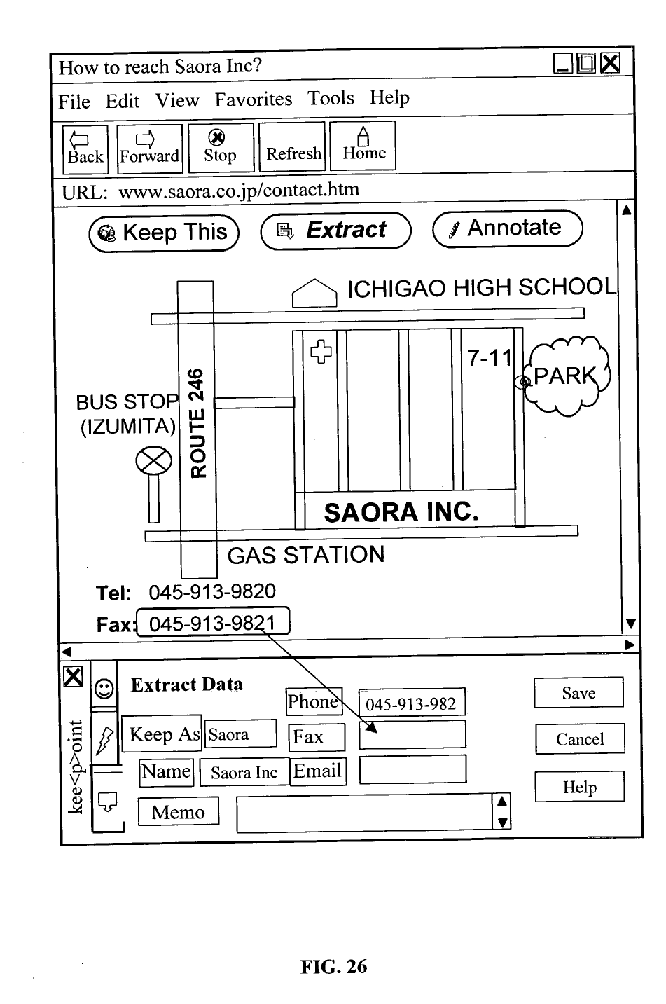

FIG. 26 shows an example web page along with the information extraction user interface of the KPT System. As can be seen from the figure, the user has extracted the telephone number, ‘045-913-9820’ and the arrow indicates that the user is extracting the number ‘045-913-9821’ as fax number, by just dragging and dropping the same to the fax field of user interface.

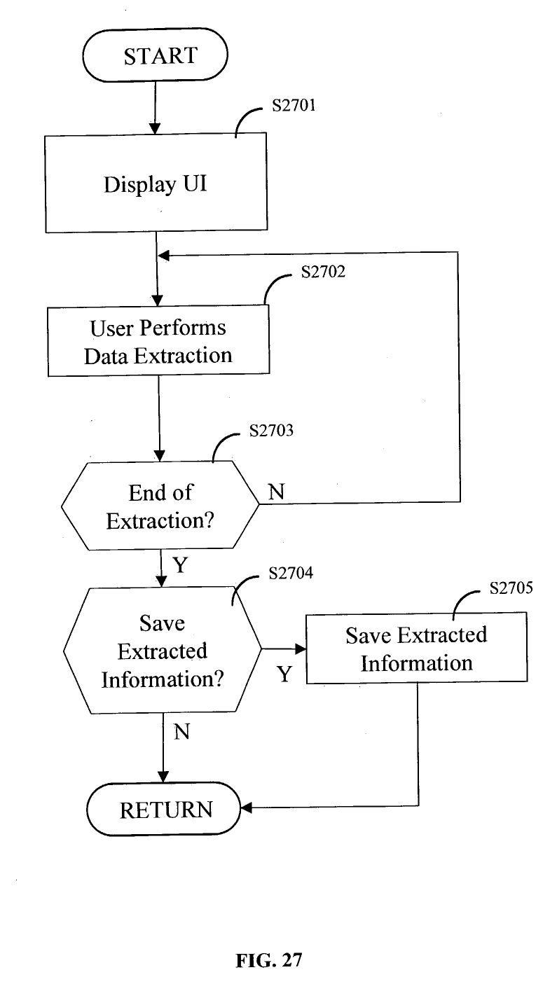

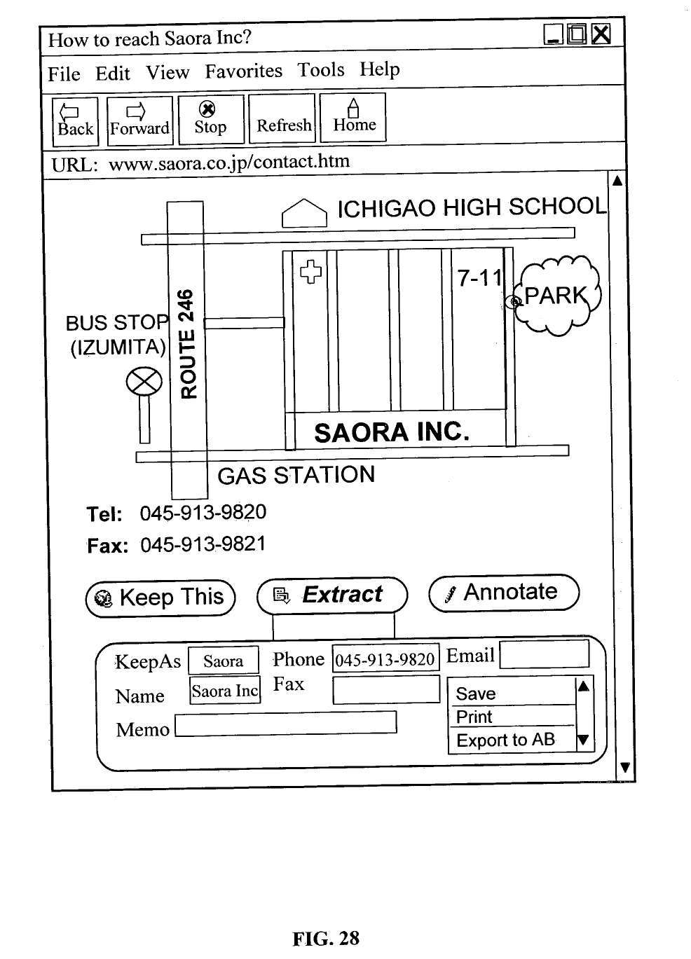

FIG. 27 is a flowchart of the procedural steps of information extraction processor of this embodiment. As can be seen from the figure, in step S2701, the user interface which allows the user to extract data from the page is shown, an example of which is shown in FIG. 28. In step S2702, relevant information or data extracted by the user are obtained. In step S2703, a check is made to determine if the user has finished with the processing of the data extraction. If not, the process moves back to S2702, otherwise, a check is made in step S2704 to determine if the extracted information needs to be saved. If so, step S2705 is executed, wherein the extracted information is stored either on the client or on the server. In either case, the process returns.

FIG. 28 shows an example web page along with the embedded information extraction user interface. As explained before information extraction is not a final action and hence after extraction the user needs to decide what he or she would like to do with the extracted data. E.g., save, print of export to address book etc . . . . As can be seen from the figure, it is possible to embed this onto pages which have addresses or phone numbers and by clicking on the ‘Extract’ the user interface with the fields to be extracted are shown.

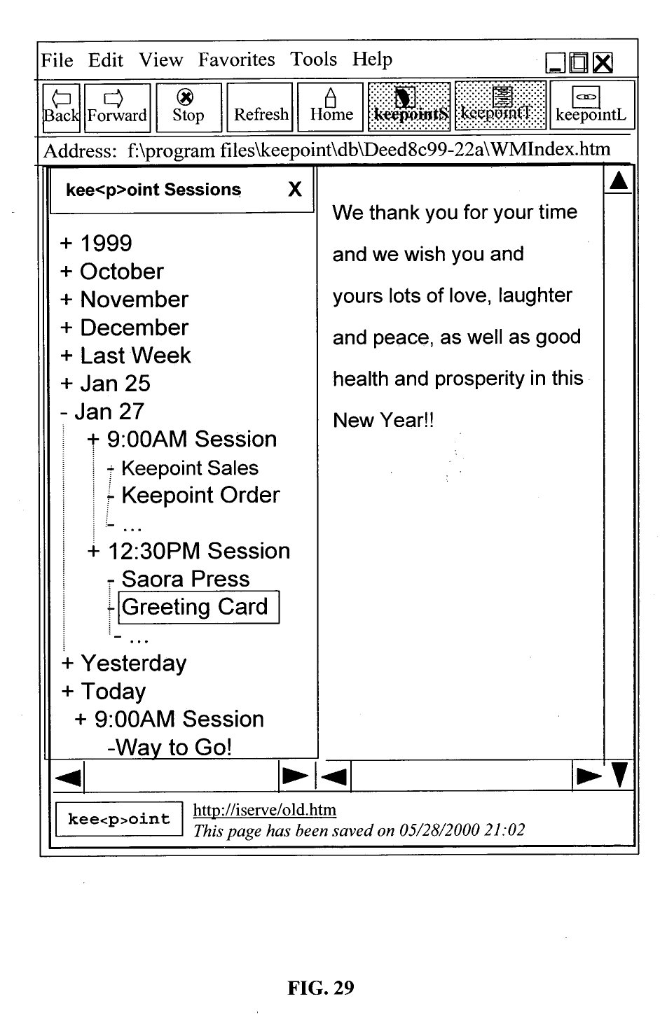

FIG. 29 shows an example User Interface of Retrieve, sorted by time or session order. As can be seen from the figure, the stored links or pages are sorted based on domain and listed to enable to the user to easily browse through the stored information.

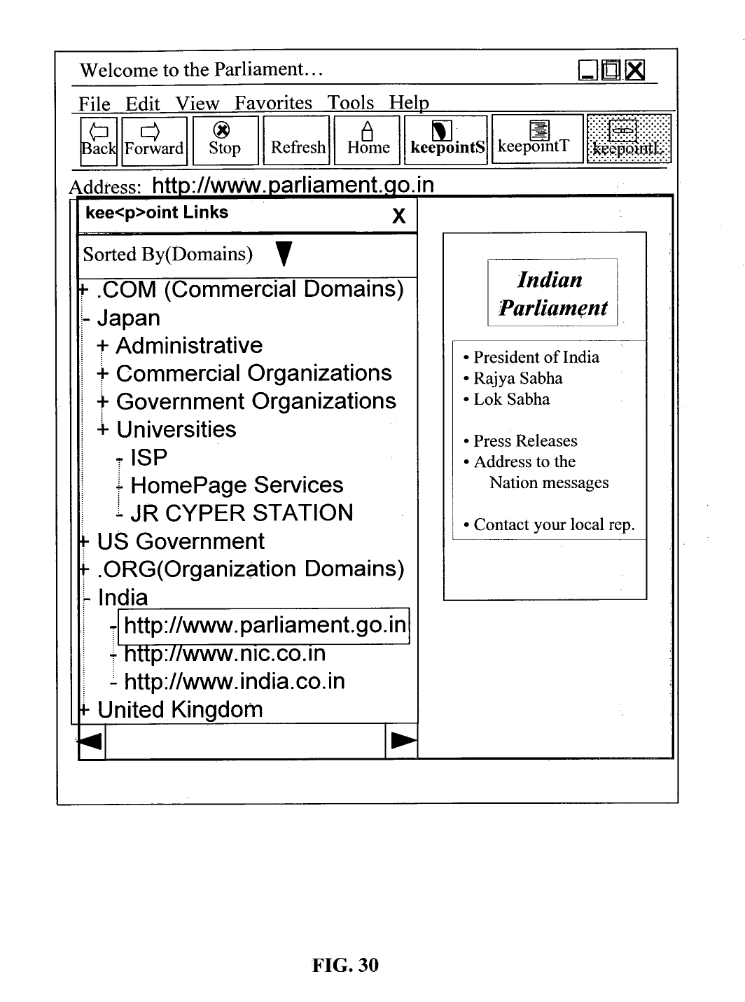

FIG. 30 shows an example User Interface of Retrieve, Get All Links UI sorted by Domains.

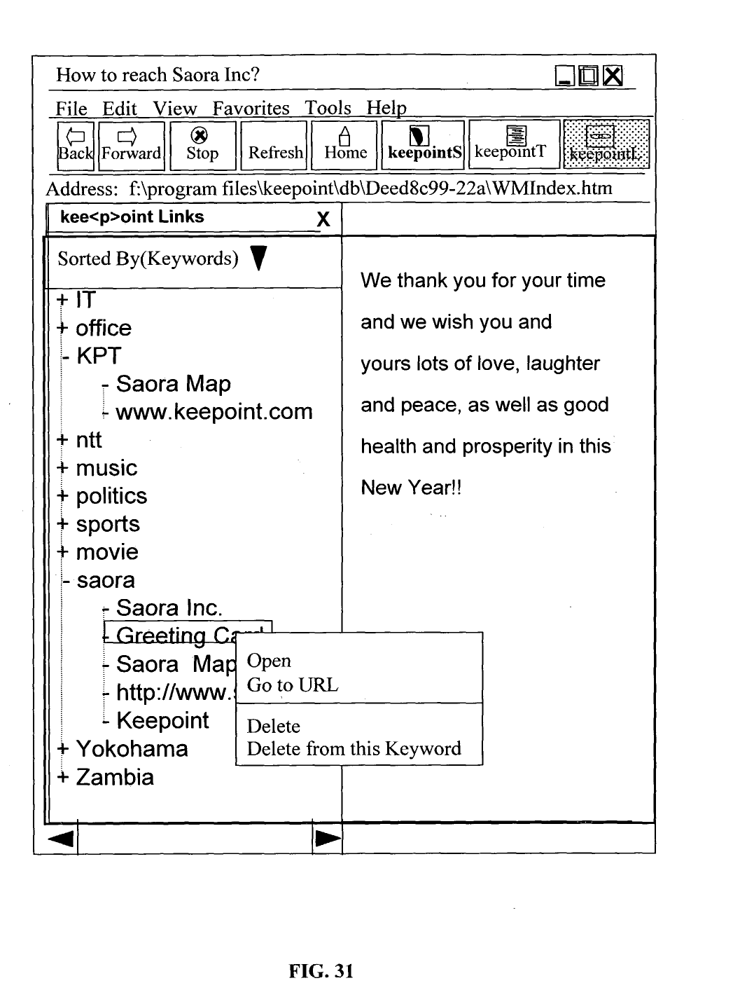

FIG. 31 shows an example User Interface of Get All Links UI sorted by Keywords. As can be seen in FIG. 13, the web pages have embedded keywords to enable the search engine and other web spiders to classify the document. This is used by to enable easily retrieval of the stored information.

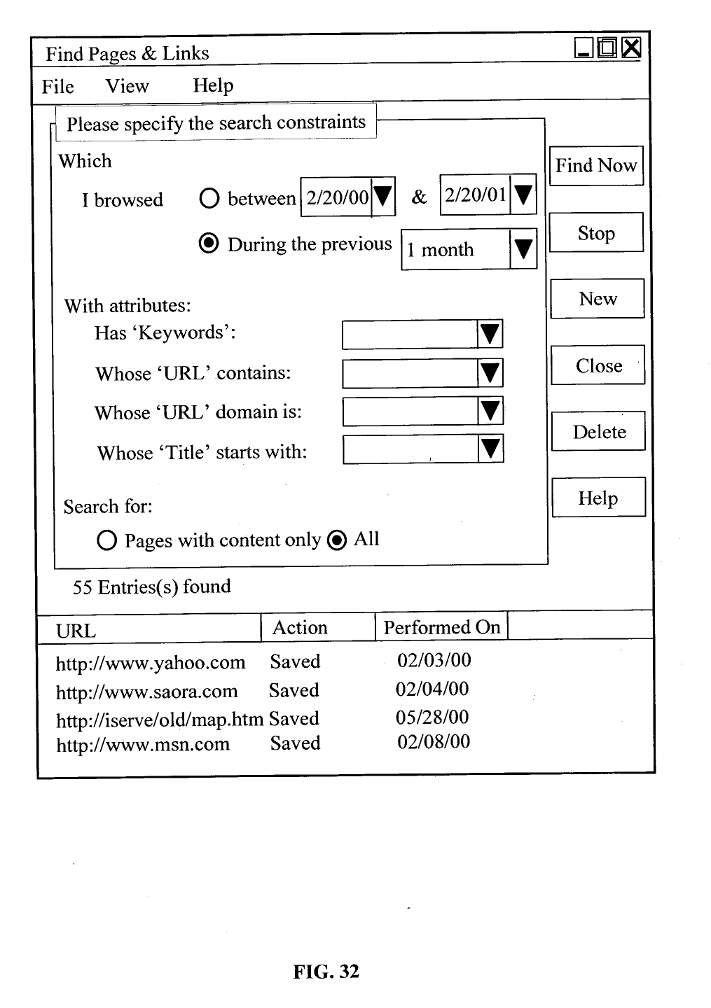

FIG. 32 shows example User Interface of Retrieve. As can be seen from the figure, various parameters can be input for the search

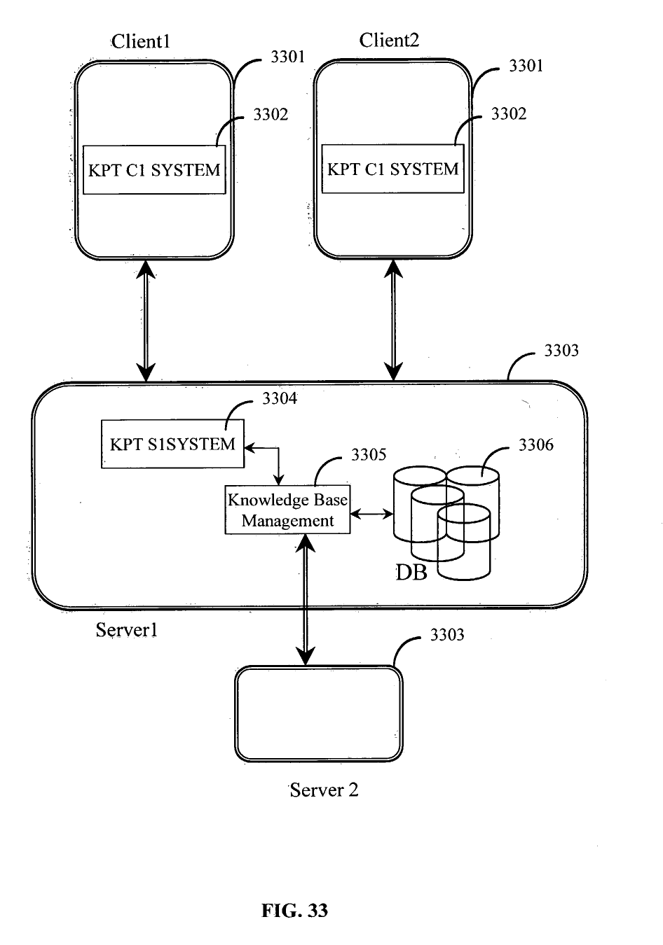

FIG. 33 shows a Client-Server type implementation. The figure illustrates an example Client-Server type implementation. Multiple clients 3301 have KPT C1 system 3302, and communicate with Server 3303. Server 3303 is equipped with KPT S1 System 3304, knowledge base management 3305 and Database 3306. Server 3303 can also communicate with other servers to access their information stored in database, via knowledge base management.

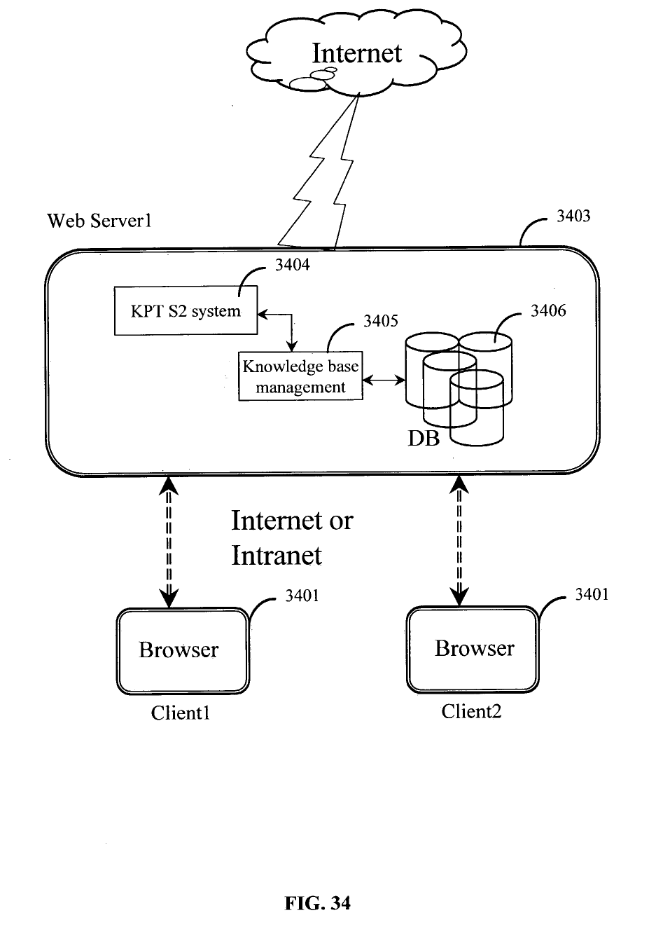

FIG. 34 shows an Application Service Provider (ASP) type implementation. The figure illustrates another possible architecture implementation of the KPT System. Multiple clients 3401, using only a standard web browser, communicate to the web server 3403. The web server 3403 is equipped with KPT S2 System, knowledge base management 3405 and Database 3406. The client and server can be either on the Internet or on the Intranet. This architecture is a typical example of Application Service Provider (ASP) type of implementation of the KPT System.

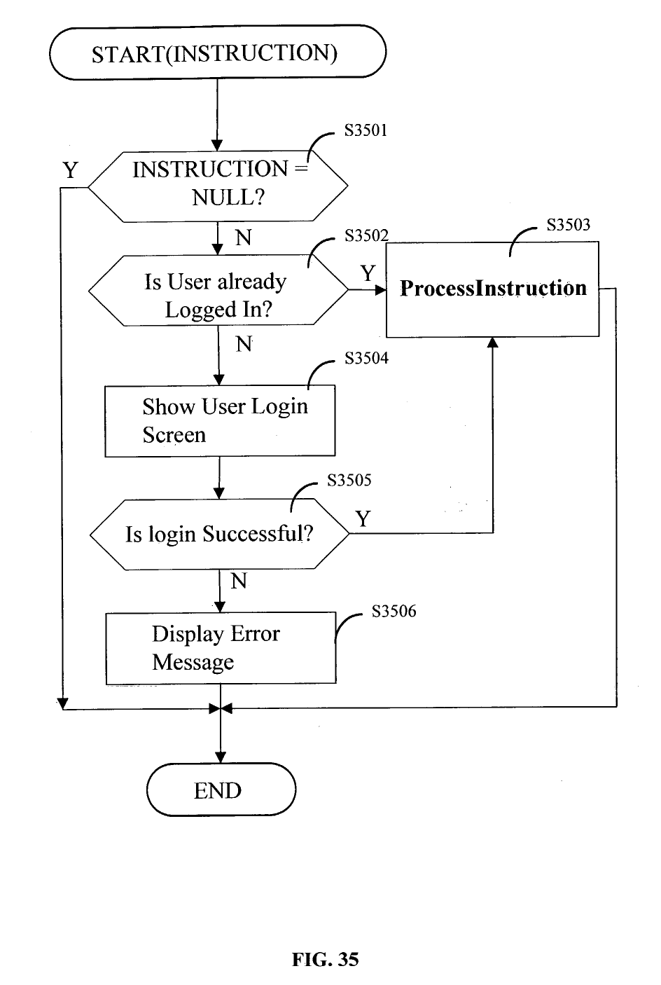

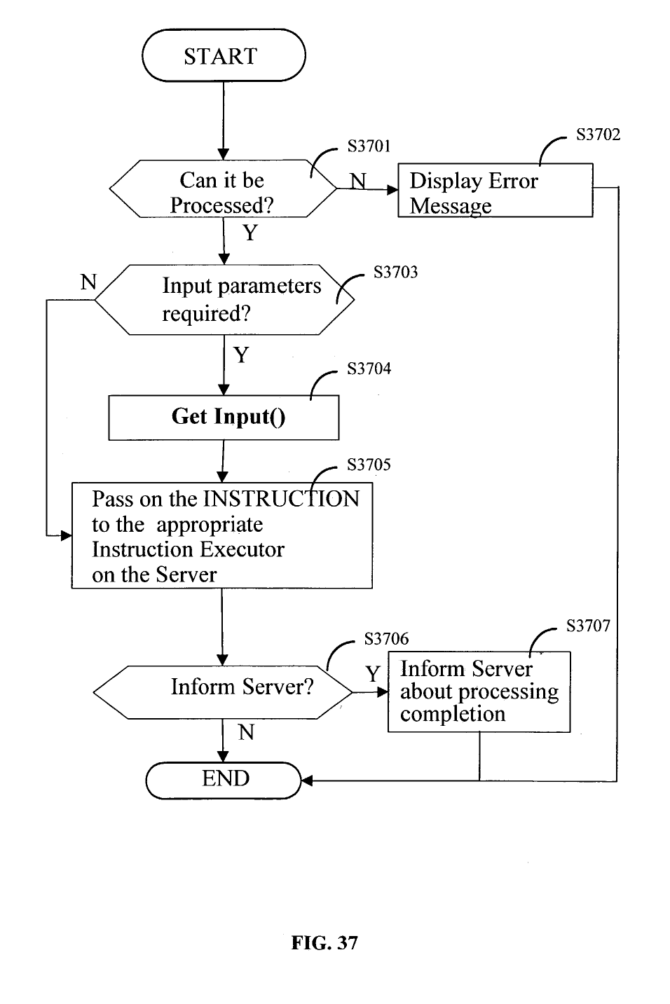

FIG. 35 is a flowchart of the procedural steps of Instruction Processor 204 for a typical client server or ASP type of implementation. As can be seen from the figure, a check is made in step S3501 to determine if the INSTRUCTION is null or not. If so, the process ends, otherwise the process goes to step S3502, wherein a check is made to determine if the user is already logged in. If so, the process moves to step S3503, ProcessInstruction (Instruction) as was explained in detail in FIG. 37 and the process ends. Otherwise, step S3504 is executed, wherein the user is shown the login screen to logon to the server, be it server of client server or server of ASP or other client of the distributed client systems. In step S3505, a check is made to determine if the login was successful, if so the process moves to step S3503, otherwise an error message is displayed in S3506 and the process ends.

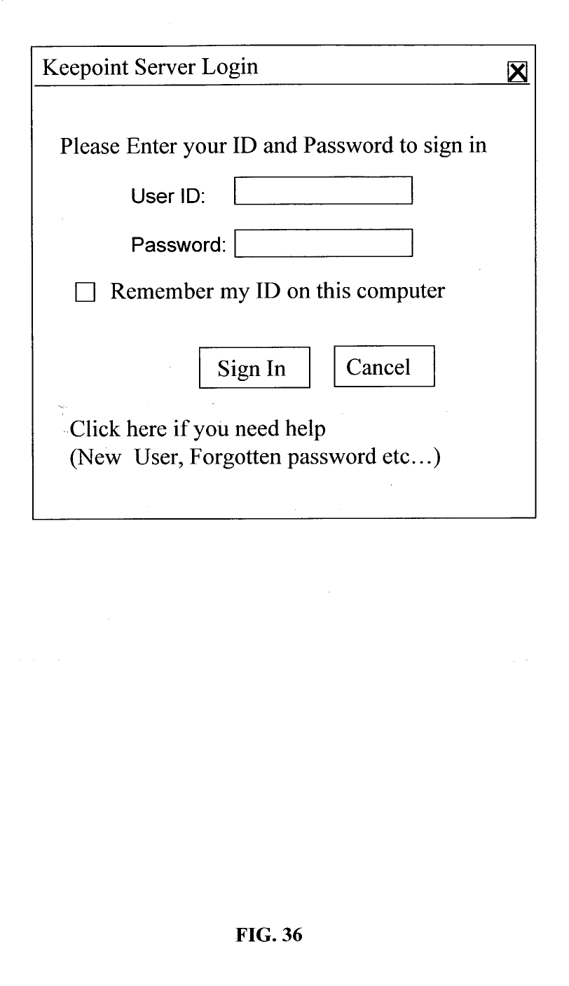

FIG. 36 shows an example user interface of the login screen displayed by this embodiment in step S3504.

FIG. 37 is a flowchart of the procedural steps of Instruction Processor for Client Server or ASP type of architecture. A check is made in step S3701 to determine if the instruction can be processed. If so the process proceeds to step S3703, otherwise an error message is displayed in step S3702 and the process ends. In step S3703, a check is made to determine if the input parameters are required to be obtained. If so, the process proceeds to step S3704, wherein GetInput is executed whose details were explained earlier. In either case step S3705 is executed, wherein the instruction is passed on to the appropriate instruction executor on the server. In step S3706, a check is made to determine if the server needs to be informed. If so step S3707 is executed wherein, a message is sent to the server to inform that the page has been processed by the client or the user.

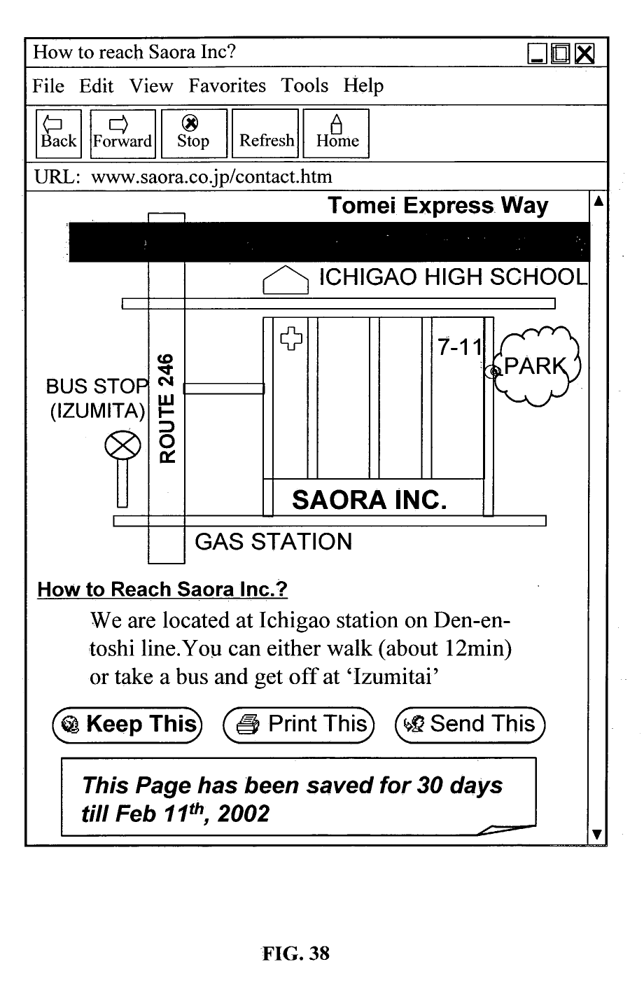

FIG. 38 shows an example web page after the save has been performed. After the user uses the ‘Keep This’ button on the web page to save the web page onto the server, the page is refreshed with the message ‘This Page has been saved for 30 days till Feb 11th, 2002’ to inform the user that the save was successful.

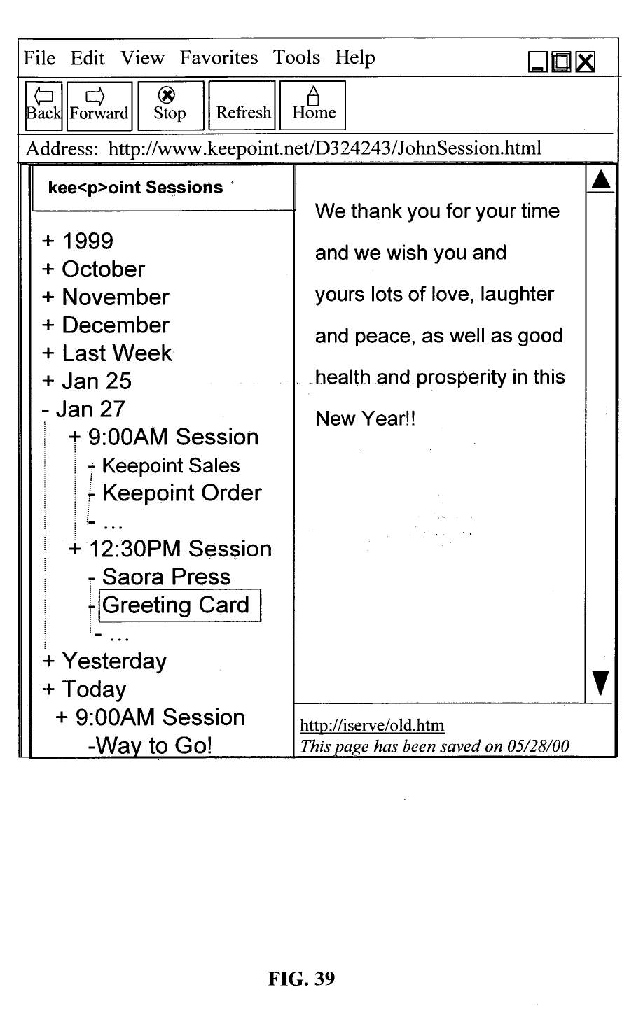

FIG. 39 shows an example User Interface of Retrieve, sorted by time or session order for a typical client server or ASP type of implementation of KPT System.

Thus it can be seen that this embodiment can also be used in traditional client-server architecture, ASP type of implementation and it could be easily seen that it be similarly used with various other different types of architectures.

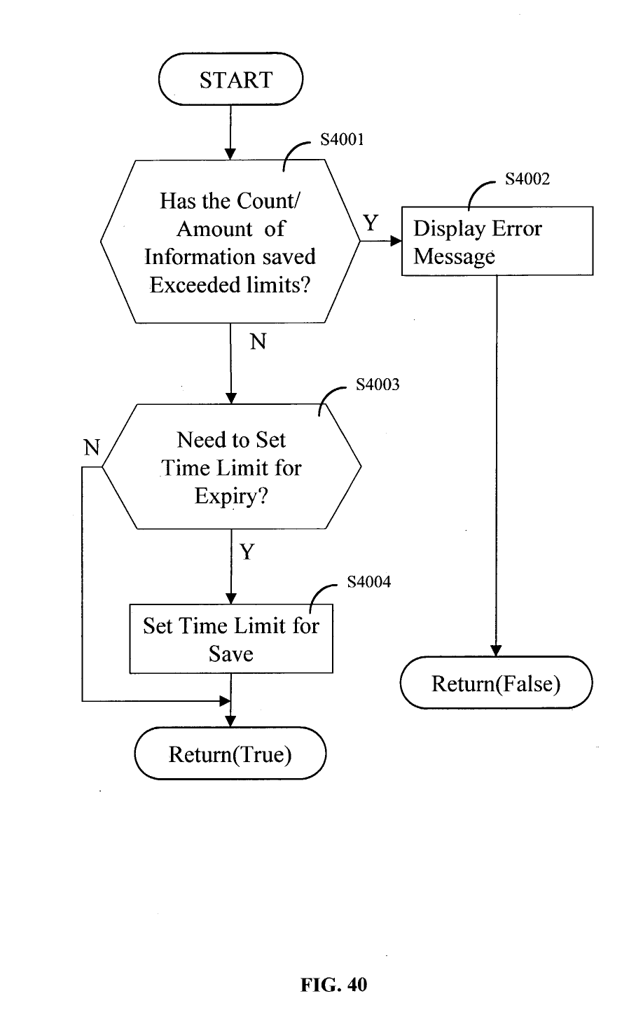

FIG. 40 is a flowchart of the procedural steps to determine if an instruction can be executed. In steps S605, S801 or S3701, an example flow chart for the check to determine if the save instruction can be performed is shown in this figure. It is possible to special version with certain limits, for example, the special version can be limited to save a total of only 100 links or pages and/or limit the space consumed in saving the information to 10 MB etc. A check is first made in step S4001 to determine, if certain limits of the special versions have been exceeded, for example, the special version can be limited to save a total of only 100 links or pages and/or limit the space consumed on the server in saving the information to 5 MB etc. If the limits have been exceeded an error message is displayed in step S4002 and the process returns false. If not, a check is made in step S4003 to determine if any expiry time limit is to be set on the information being saved. For example, it is possible to set the expiry time limit to say 15 days or one month, so that the KPT System automatically deletes the information after the expiry period. If so, the time limit is set in step S4004. In either case, the process returns true. The idea behind the special or limiting the features of the system, is to provide the above limited version for free and in order for the user to use all the features without any hassles or limitations, the user needs to purchase or procure the full unlimited version.

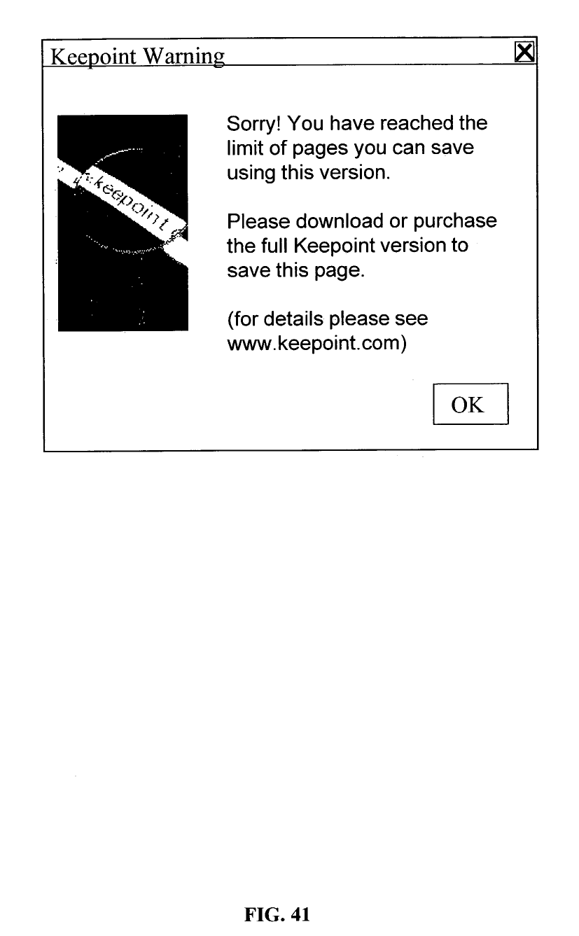

FIG. 41 shows an example user interface of the error message displayed to the user, when the save cannot be executed in step S4002.

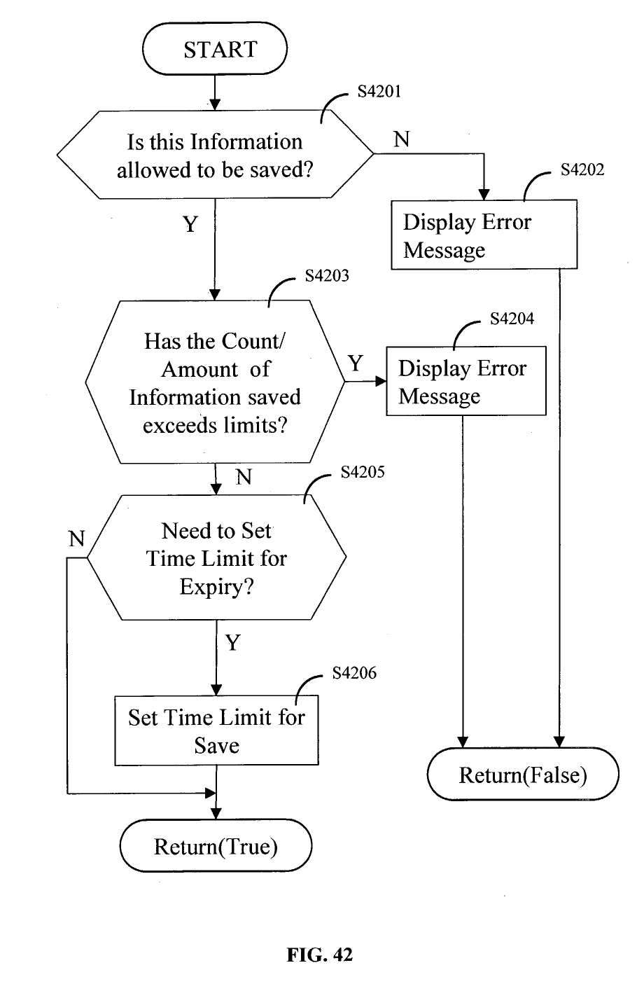

FIG. 42 is another flowchart of the procedural steps to determine if an instruction can be executed. A check is first made in step S4201 to determine if the information currently being displayed can be saved. If not, an error message is displayed in step S4202 and the process returns false. The special version can be constrained to save only limited information, for example, only web pages of a particular web site or a group of web sites or to only sites having the ‘Keep This’ or ‘Keepoint Toolset’. Otherwise, a check is made in step S4203 to determine, if certain limits of the special versions have been exceeded, for example, the special version can be limited to save a total of only 100 links or pages and/or limit the space consumed in saving the information to 10 MB etc If the limits have been exceeded an error message is displayed in step S4204 and the process returns false. If not, a check is made in step S4205 to determine if any expiry time limit is to be set on the information being saved. For example, it is possible to set the expiry time limit to say 15 days or one month, so that the KPT System automatically deletes the information after the expiry period. If so, the time limit is set in step S4206. In either case, the process returns true.

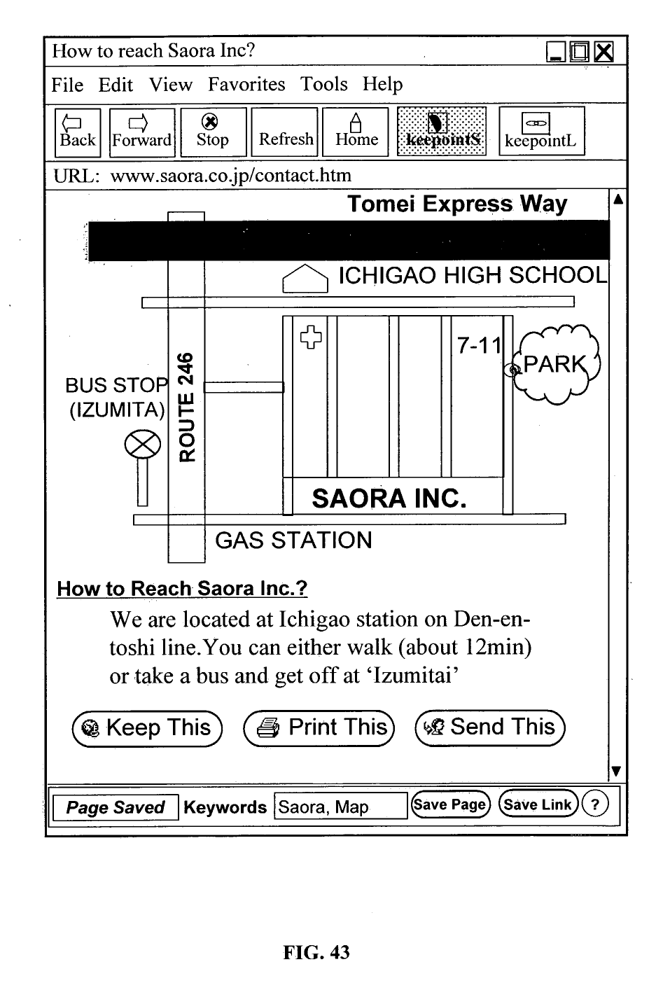

FIG. 43 shows an example web page along with the user interface after the save has been performed.

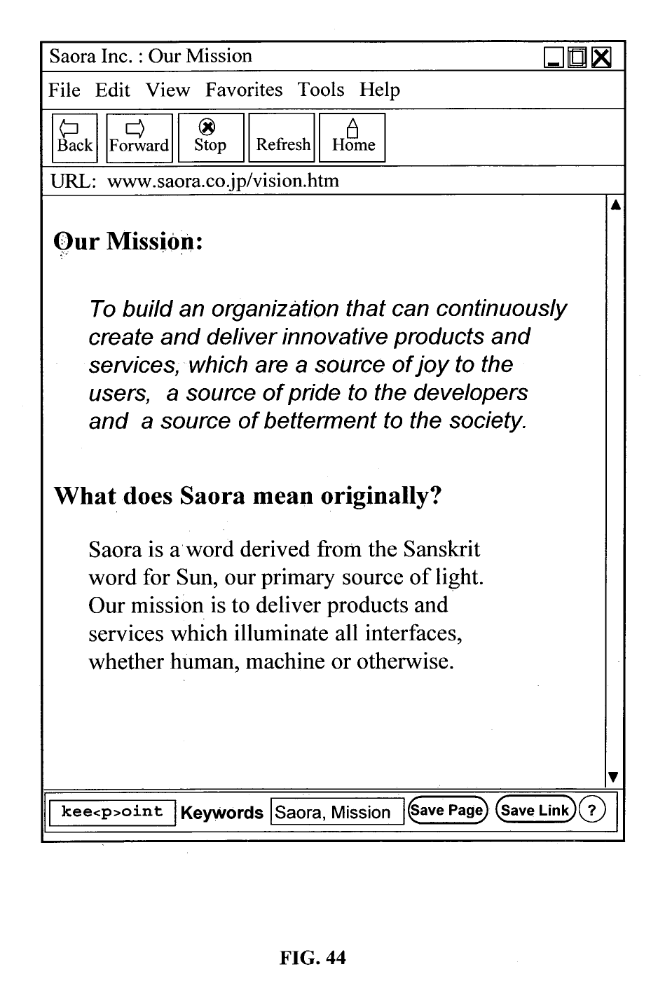

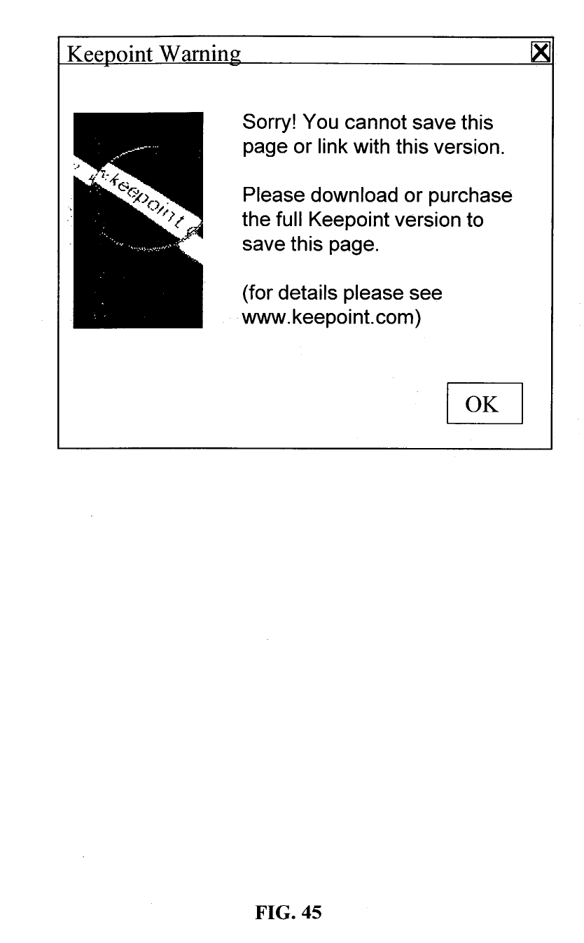

FIG. 44 shows an example display to explain how the limitation becomes applicable. The special version can be constrained to save only limited information, for example, only web pages of a particular web site or a group of web sites or to only sites having the ‘Keep This’. After the ‘Keep This’ has been pressed by the user, the KPT System can display the Save UI. Thus, in FIG. 44, the user can try to save the page by using the ‘Save Page’ of the KPT System. It is possible to limit this operation in a Special Version, if the page or link is not permitted to be saved, a error message as shown in FIG. 45 will be displayed.

FIG. 45 shows an example user interface of the error message displayed to the user, when the save cannot be executed.

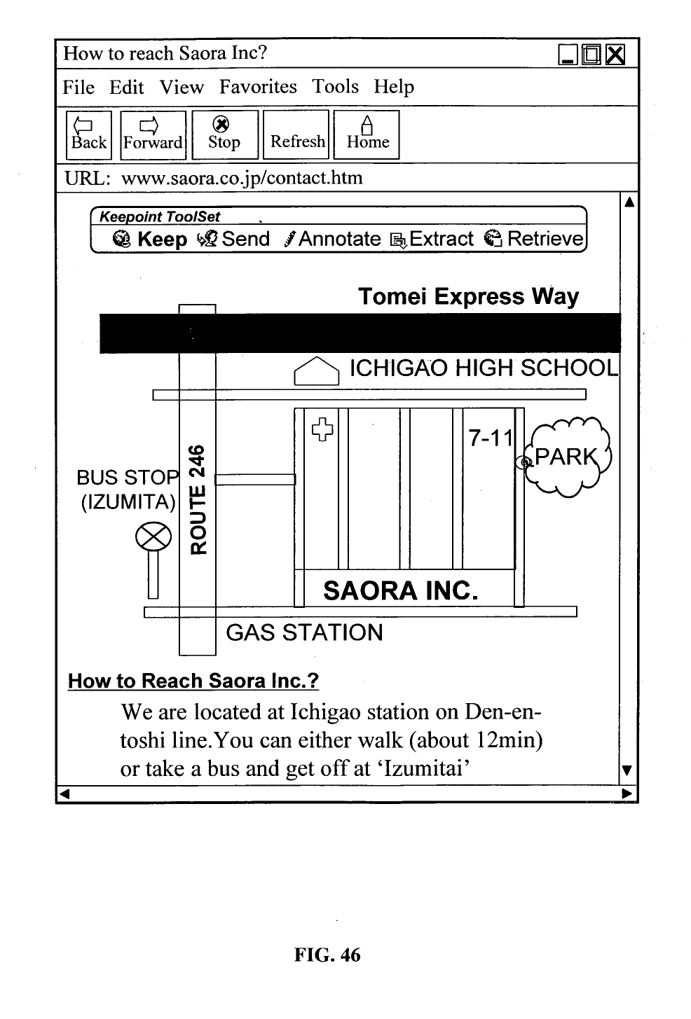

FIG. 46 shows an example web page along with the processing toolset directly embedded on the web page. As can be seen from the figure, instead of individual buttons or anchors, the necessary processing buttons or anchors can be grouped together and presented to the user in form a toolset. The main advantage of presenting this in one set, is the web developer or information provider can easily embed the same onto their web pages.

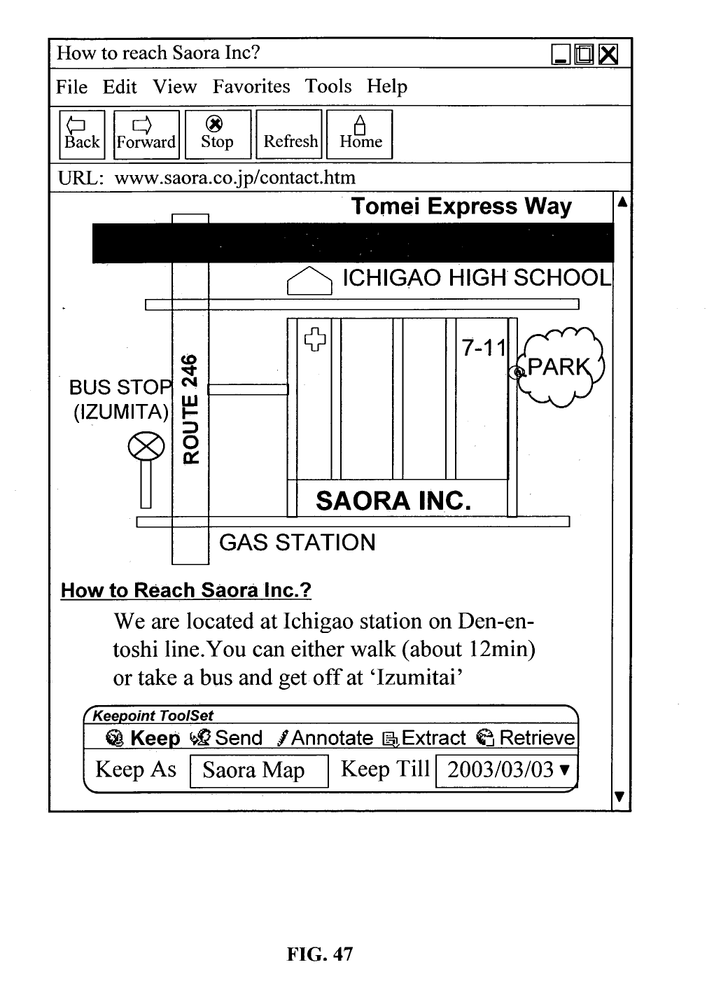

FIG. 47 shows an example web page along with the processing toolset for getting details of save. As can be seen from the figure, the user for example, can input an identifier in ‘Keep As’ field, and also specify the validity or the expiry of the information being stored.

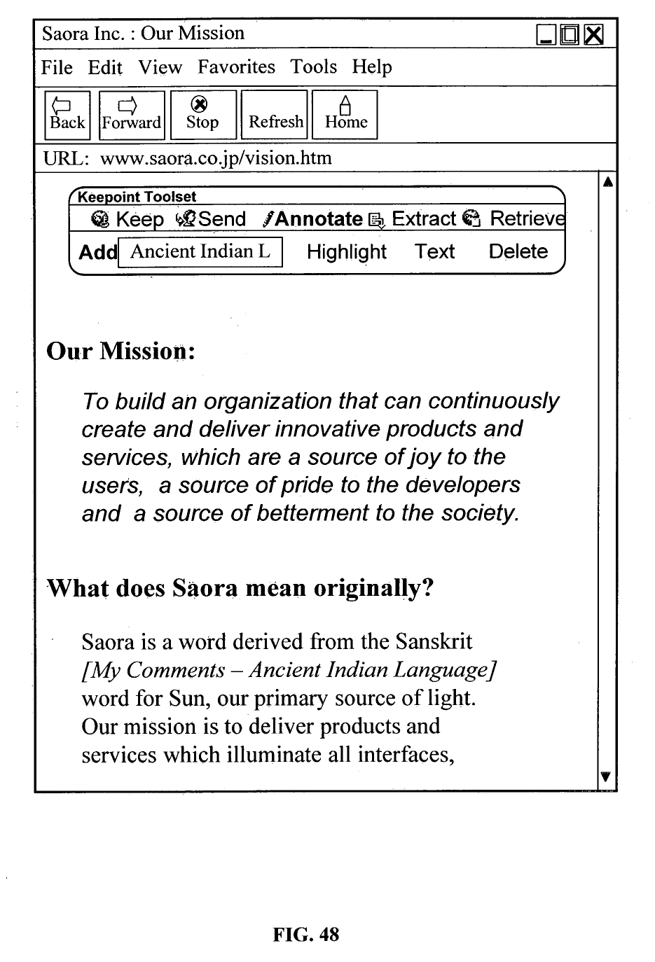

FIG. 48 shows an example web page along with the annotation toolset for directly annotating on the web page being displayed. As can be seen in the figure, the user has added a note ‘[My Comments—Ancient Indian Language]’ directly onto the web page next to the word ‘Sanskrit’ using the Toolset embedded directly on the web page.

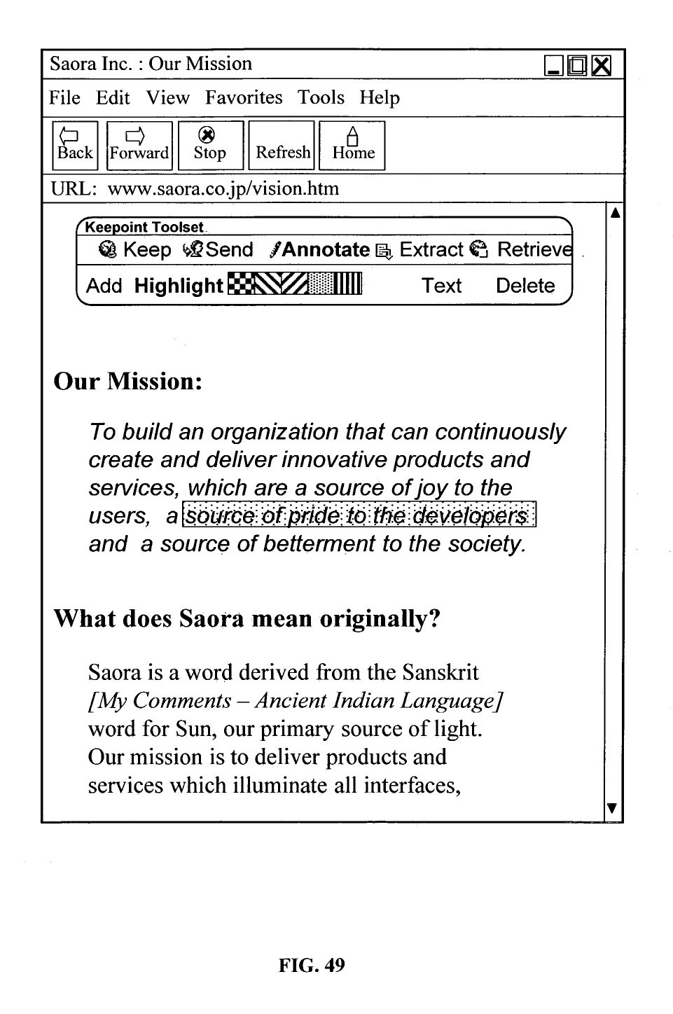

FIG. 49 shows another example of web page along with the highlight annotation toolset for annotating on the web page being displayed.

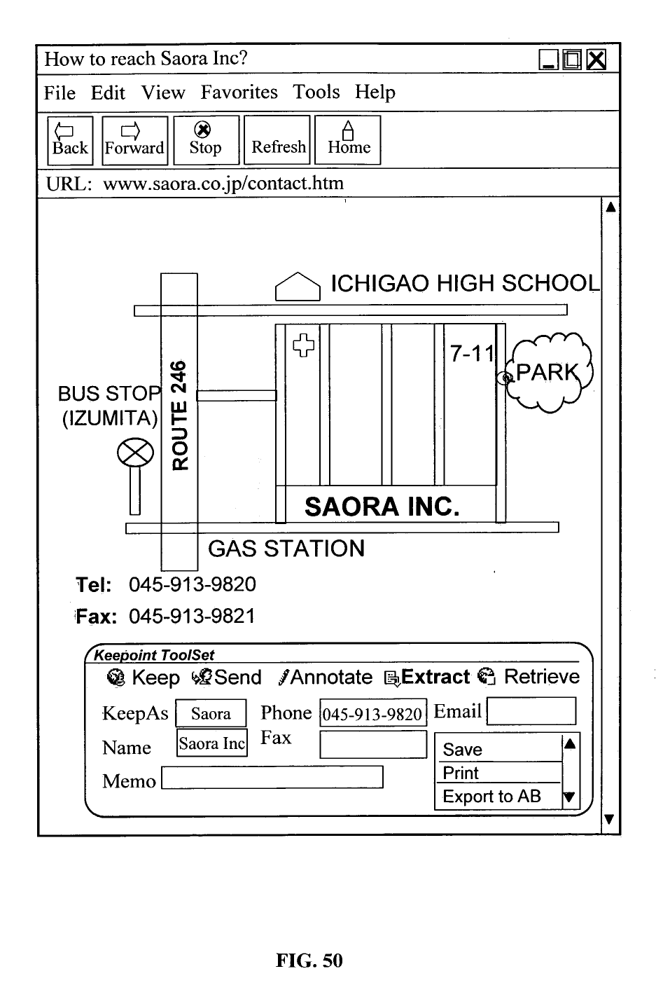

FIG. 50 shows an example web page along with Extraction tool set to extract relevant information directly from the web page. As can be seen from the figure, the user has extracted the ‘Phone’ and also assigned ‘Keep As’ and ‘Name’ fields. As can be seen from the figure, it is possible to embed the toolset onto pages which have addresses or phone numbers and by clicking on the ‘Extract’ the user interface with the fields to be extracted are shown.

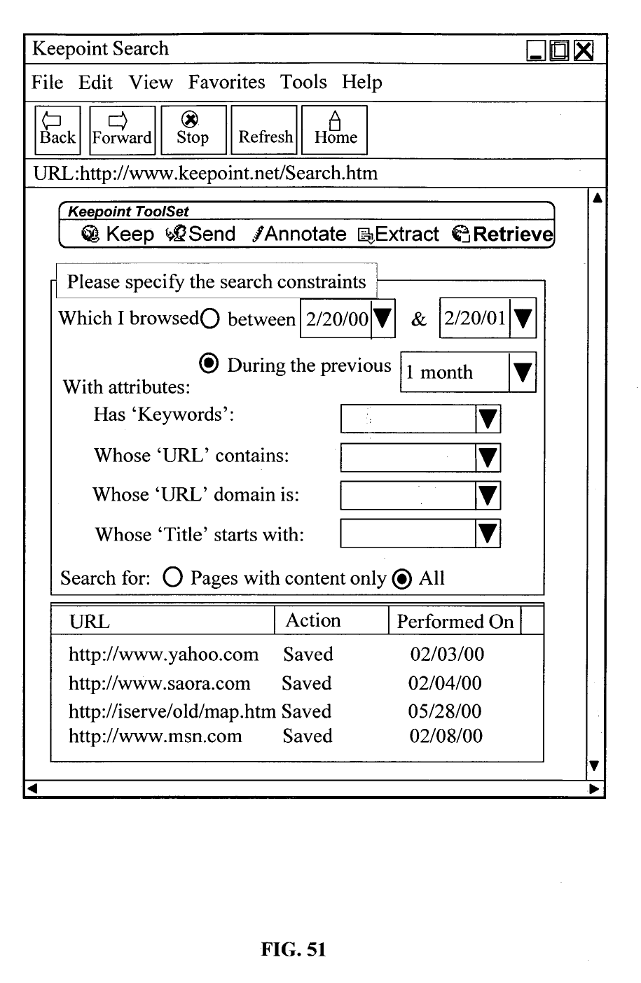

FIG. 51 shows another example User Interface of Retrieve. When the user presses the ‘Retrieve’ button on the toolset, a user interface, example of which is shown in this figure, is displayed to allow the user to specify various parameters for searching the information.

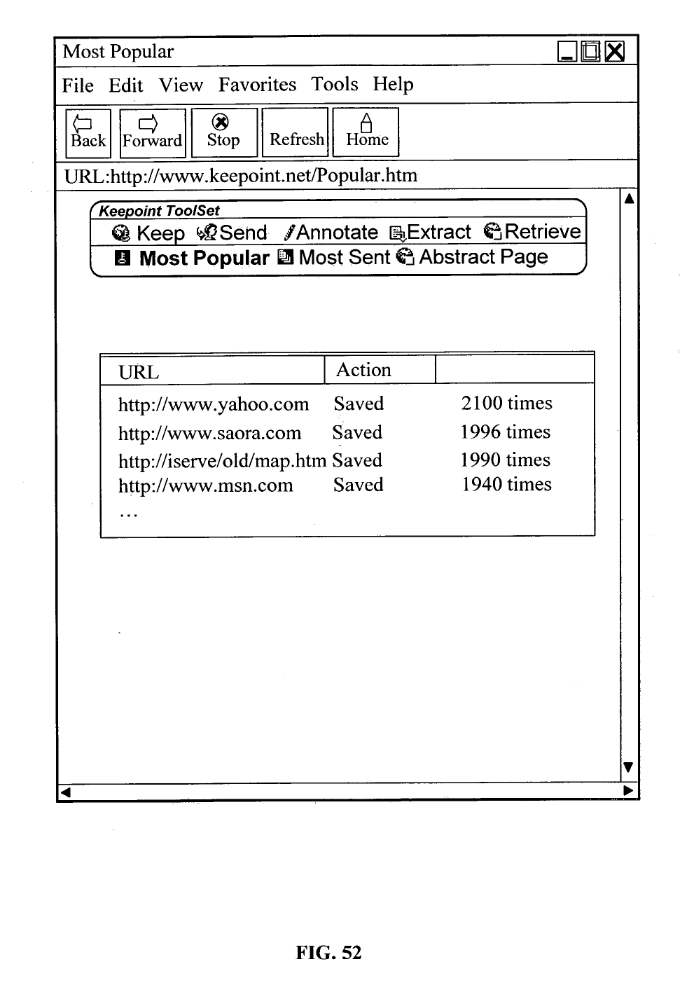

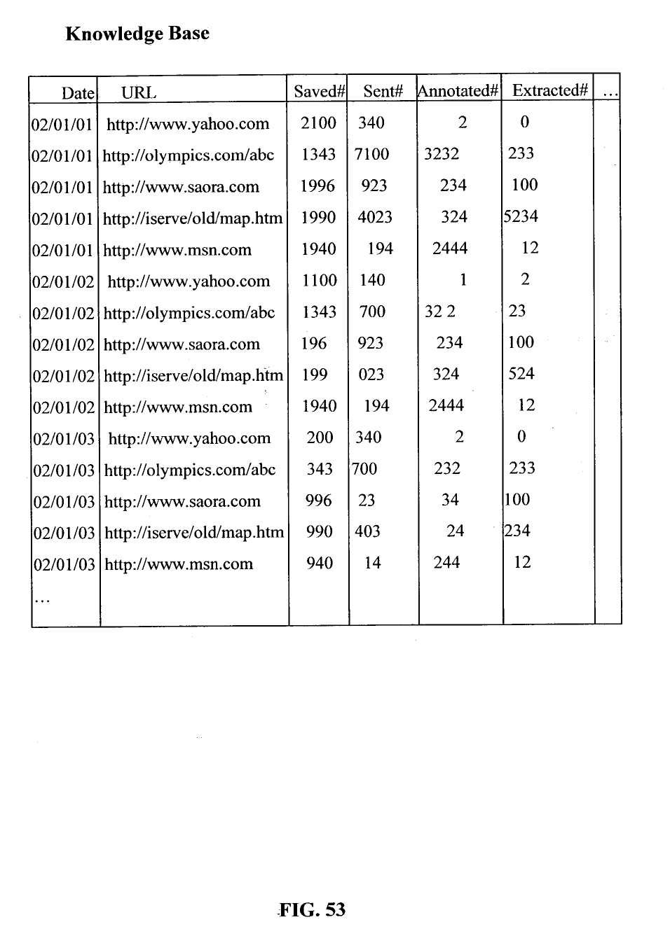

FIG. 52 shows an example of other processes performed by this embodiment. As can be seen from the figure, for example, the user can decide to view the ‘Most Popular’ i.e., the content that was saved most by the users across the ASP System or ‘Most Sent’, i.e., the content that was sent to friends or other people after viewing by the users of the ASP or client server system. The actual count or statistics is collected by in step S611 or S807 or S1108 etc . . . , wherein a message is sent by this embodiment to the server that the process has been preformed by the client and the knowledge base is also updated, an example of which is shown in FIG. 53. Hence, the on the server side can maintain the information of the number of times; a page has been saved, sent, annotated upon etc.

FIG. 53 shows an example knowledge base to keep track of the processing performed for a given link on a per to day basis. It is obvious that the data can be collected individually as log i.e., each specific entry or only per URL etc . . .

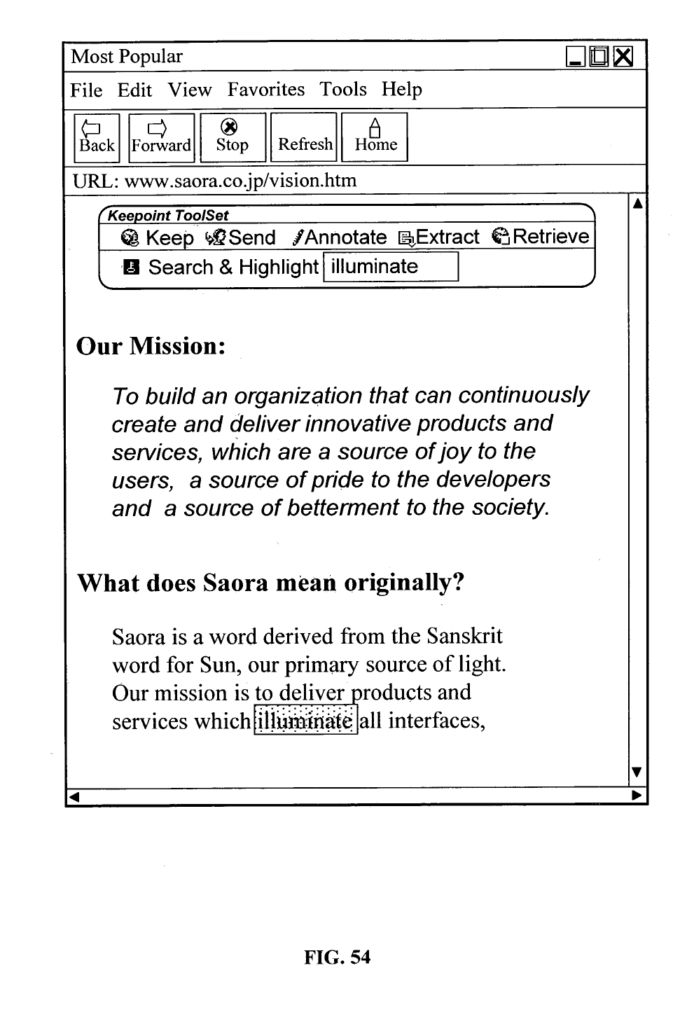

FIG. 54 shows an example of toolset to search for keywords within the displayed page.

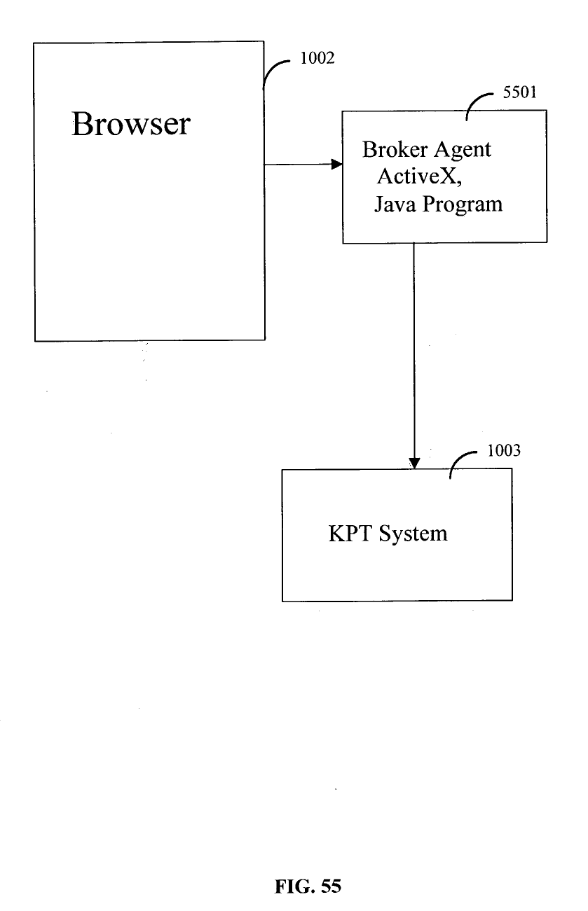

FIG. 55 shows alternative system architecture for the embodiment. As can be seen from the figure, the command or request obtained in the browser is forwarded to the KPT System, which is actually performs the actions via the Broker Agent 5501. The Broker Agent could be for example an Active X Control or a Java Program embedded within the web page.

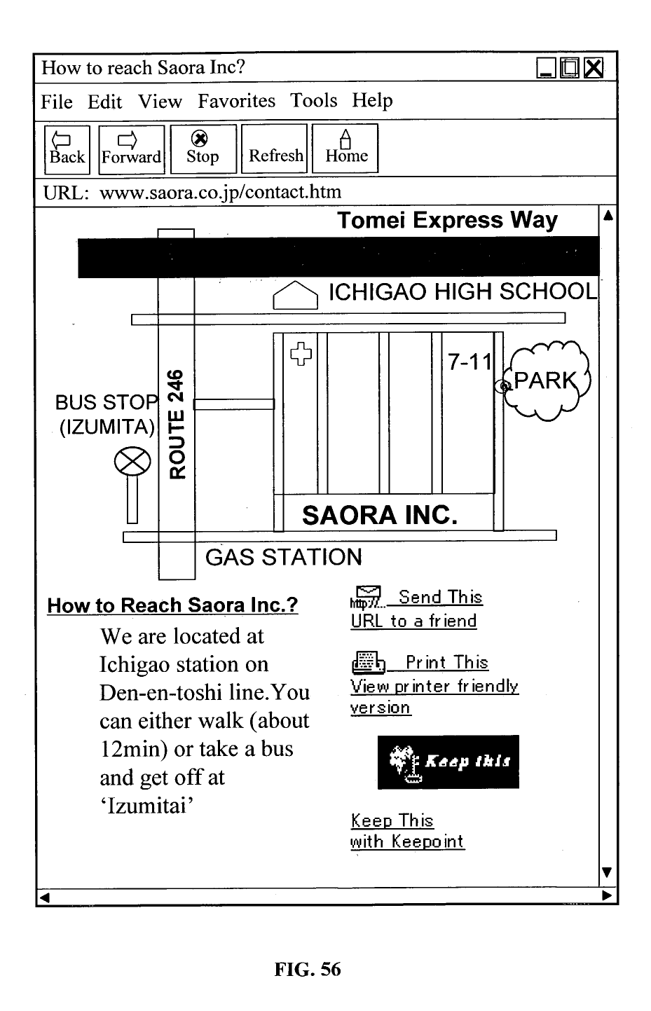

FIG. 56 shows an example web page along with the ‘Keep this’ button and anchor displayed as part of the page. As can be seen from the figure, the page contents can be saved by either clicking on ‘Keep this’ button or clicking on the anchor ‘Keep This with Keepoint’.

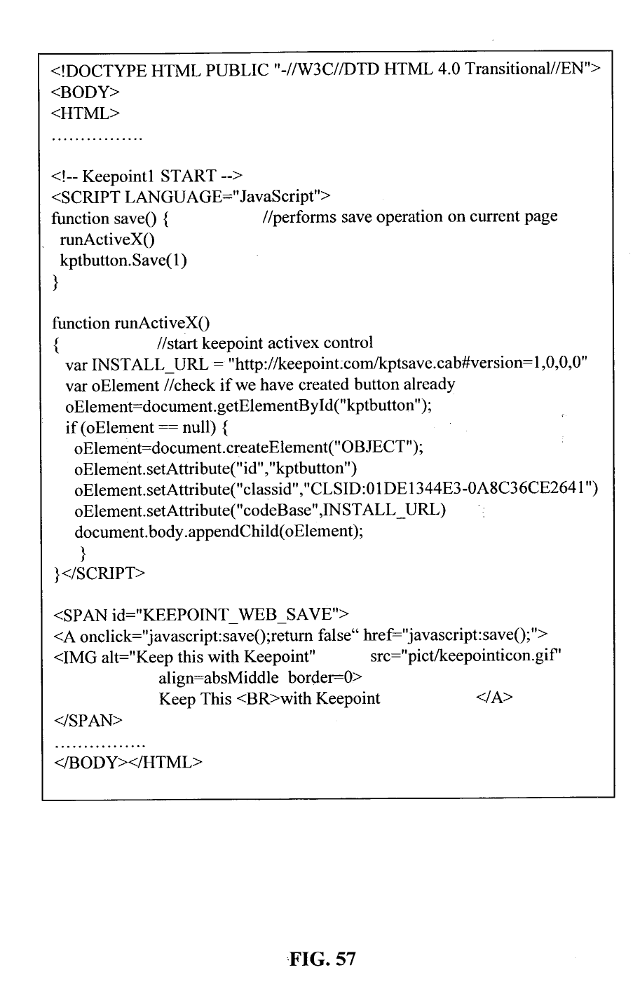

FIG. 57 shows an example JavaScript program embedded within the web page shown in FIG. 56. When the user clicks either on the button or on the anchor in FIG. 56, JavaScript program embedded within the web page is executed, to actually embed and hence create the ActiveX control as shown in the figure.

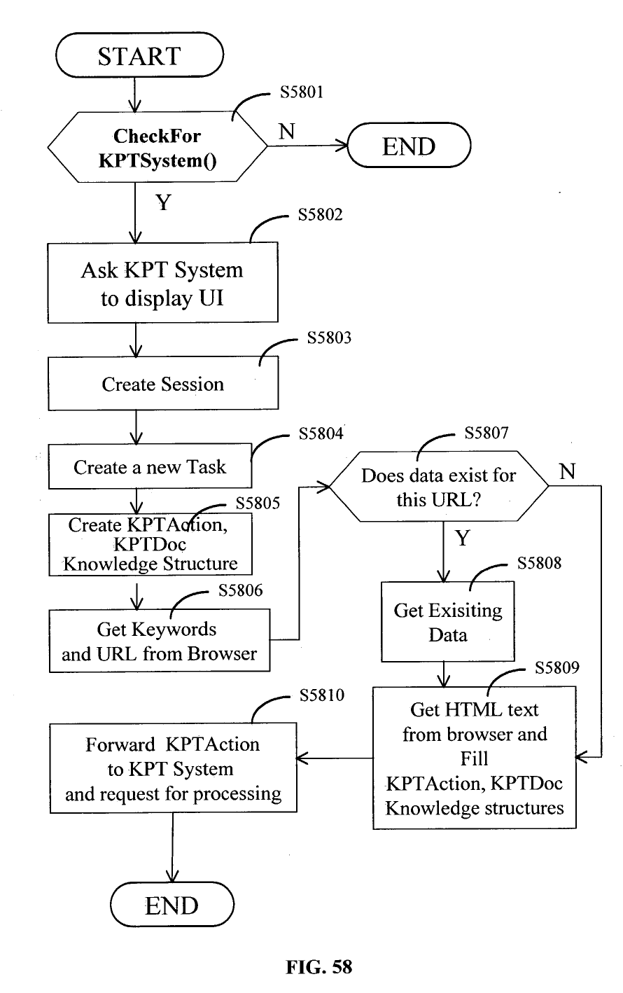

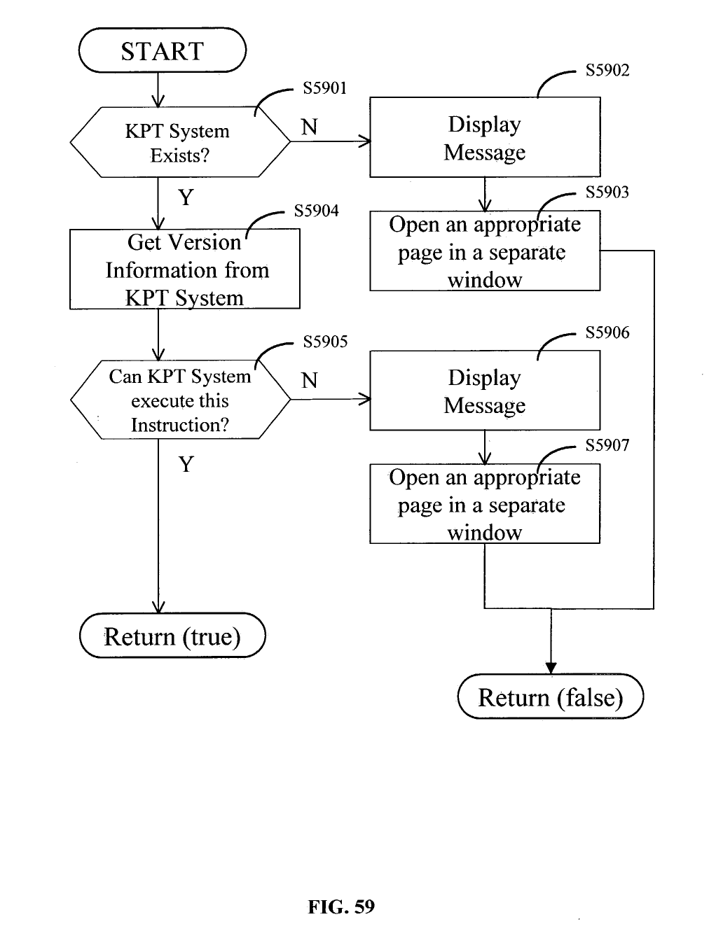

FIG. 58 is a flowchart of the procedural steps of Broker Agent. A check is made in step S5801 using CheckForKPTSystem, details of which are explained in FIG. 59. If the function returns No, then the process ends. Otherwise, in step S5802, a request is sent to KPT System to display the user interface. In step S5803, a new session is created and in step S5804, a new task is created. In step S5805, the required KPTAction and KPTDocument knowledge structures are created. In step S5806, the keywords, URL and other information obtained from the browser. A check is made in step S5807 to determine, if any previous information for the current URL already exists in the knowledge base. If so, the previous information is obtained in step S5808. In either case, the process moves to step S5809, wherein the HTML text is obtained from the browser, along with other information and the KPTAction and KPTDocument structures are filled with the obtained information. In step S5810, the filled KPTAction and KPTDocument structures are passed on to the KPT System along with the request to process the user command.

FIG. 59 is a flowchart of the procedural steps of CheckForKPTSystem. A check is made in step S5901 to determine if KPT System exists in the client machine i.e., if KPT System is installed on the machine. If not, step S5902 is executed wherein a message is displayed to the user and a detailed information—explaining the need to download and install the KPT System along with instructions and system requirements in shown in step S5903 and the process returns false. Otherwise, in step S5904, the version information of KPT System is obtained and a check is made in step S5905 to determine if the KPT System can execute the given command. If so, the process return true, otherwise a message is displayed to the user in S5906 and detailed information requesting the user to either upgrade the KPT System manually or prompt the user for automatic upgrade etc . . . is performed in step S5907 and the process returns false.

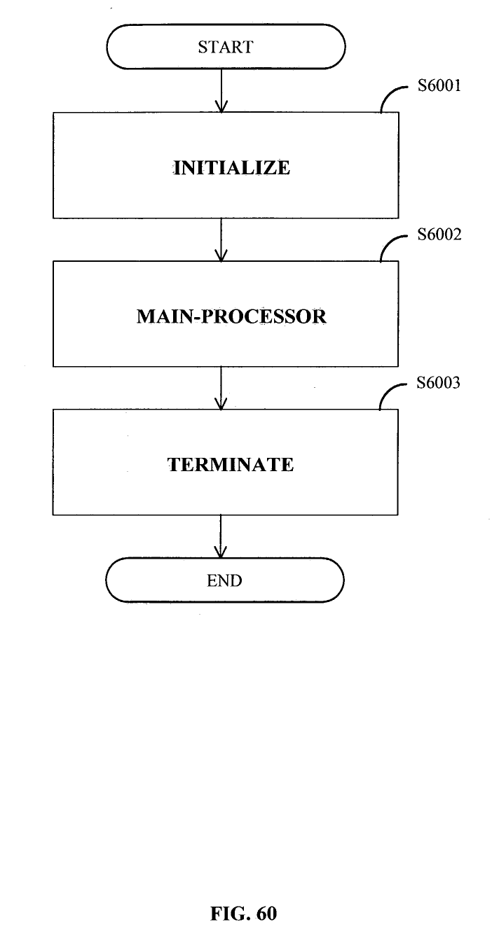

FIG. 60 is a flowchart of the main procedural steps of KPT System. In step S6001, initialization processes to connect to the Internet are executed. In step S6002, main function processing browsing, annotating, saving etc. of this embodiment is performed. In step S6003, terminate or clean-up processing is executed.

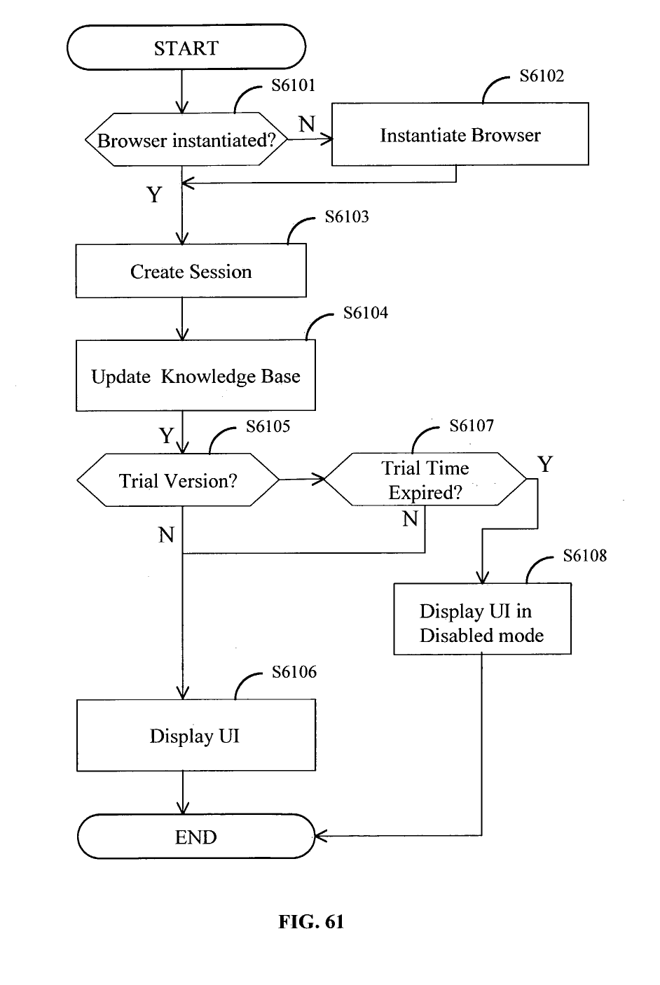

FIG. 61 is a flowchart of INITIALIZE procedure of step S6001. In step S6101 a check is made to determine if the browser needs to be instantiated or not. If browser is not instantiated, it is instantiated in step S6102. In step S6103, a new session is created. In step S6104, the knowledge base is updated. A check is made in step S6105 to determine if this is a trial version i.e., a special version that allows all the features to be used and explored before actually purchasing a product. If so, a check is made in step S6107 to determine if the trial period has expired. For example, a 30 day or 1 week trial period can be set. If not the step S6106 is executed where in the main user interface of the embodiment is displayed and the process ends. Otherwise, step S6108 is executed, wherein the main user interface is displayed in disabled mode to prevent the user to actually use the main functionality of the system and the process ends.

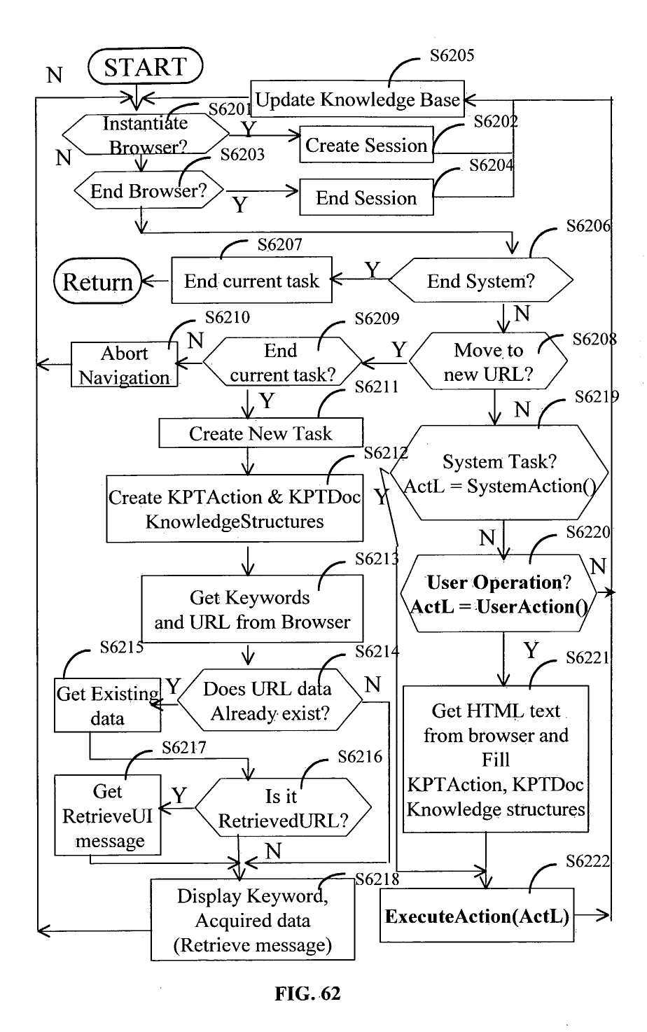

FIG. 62 is a flowchart of MAIN-PROCESSOR of step S6002. In step S6201, a check is made to determine if the browser was instantiated or not. If so, a new session is created in step S6202 and the process proceeds to step S6205, wherein the knowledge base is updated. If not, a check is made in step S6203 to determine if the browser was terminated or ended. If so, the session associated with the browser is ended and proceeds to step S6205. If not, a check is made in step S6206 to determine if an action was performed to end the system. If so, all the current tasks are terminated in step S6207 and the process returns.

If not, a check is made in step S6208 to determine if the user is navigating to a new URL. If so, a check is made in step S6209 to confirm with the user that the current task should be terminated. If not, the process proceeds to step S6210, where the navigation is aborted and the process continues to step S6201. If the current task is to be ended in step S6209, step S6211 is executed wherein, the previous task is terminated and then a new task is created. In step S6212, the knowledge structures KPTAction and KPTDocument are created.

In step S6213, the URL and the keywords are obtained from the Browser. A check is made in step S6214 to determine if the URL data already exists in the knowledge base. If so, all the existing data for the current URL is procured from the knowledge base in step S6215 and moves to step S6216, where a check is made to determine if it is a RetrievedURL i.e., the user is trying to view the contents of an already stored page. If so, step S6217 is executed to get the RetrieveUI message and control goes to S6218. If URL data does not already exist in step S6214, step S6218 is executed to display the keywords, other acquired data from browser like the URL, page title etc . . . and other existing data if any from the knowledge base like Keep As, validity period etc . . . and the process proceeds to step S6201.

In step S6208, if the user is not moving to a new URL, a check is made in step S6219 to determine if any SystemTask ActL needs to be executed. If so, step S6222 ExecuteAction (ActL) is executed and the control moves to step S6205 to update the knowledge base. If not, a check is made in step S6220 to determine if any User Operation was performed. If not, step S6205 is executed, otherwise in step S6221, the HTML text is obtained from the browser and the KPTAction and KPTDocument structures created in step S6212 are updated and ExecuteAction (ActL) for the UserAction is executed in step S6222 and the process moves to step S6205 to update the knowledge base.

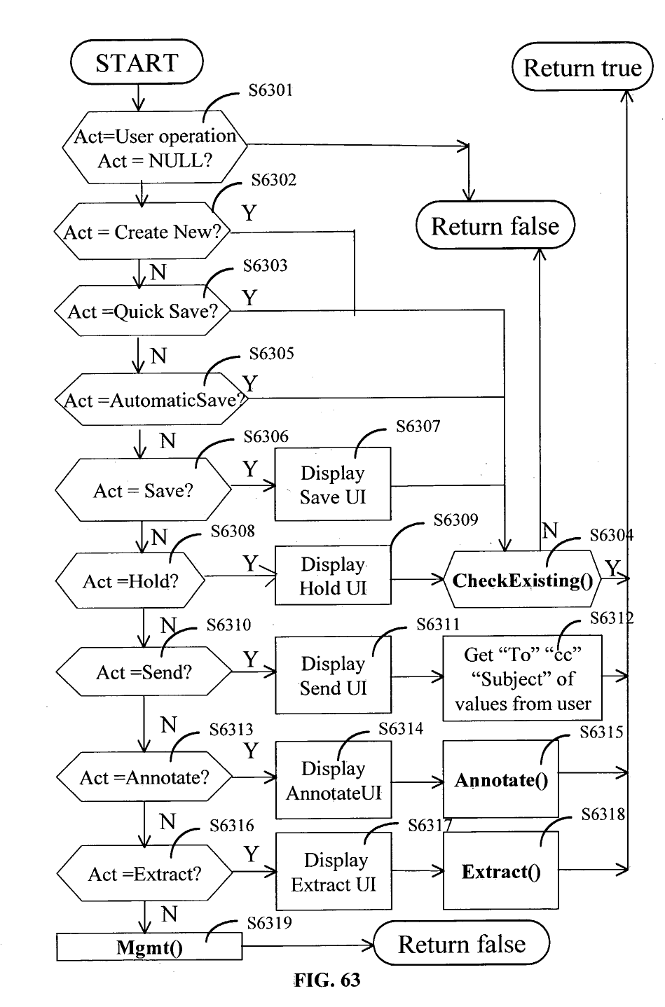

FIG. 63 is a flowchart of the procedural steps of S6220 UserAction. A check is first made in step S6301 to set Act equal to the User operation performed by user and to determine if Act is equal to NULL. If so, the process returns false. If it is not NULL, the process proceeds to step S6302, a check is made to determine whether Act is Create New. If so, the process proceeds to step S6304. If not, the process proceeds to step S6303, a check is made to determine whether Act is Quick Save. If so, the process proceeds to step S6304. If not, a check is made in step S6305 to determine whether Act is Automatic Save. If so, the process proceeds to step S6304. If not, a check is made in step S6306 to determine whether Act is Save. If Act is Save, Save UI, an example of which is shown in FIG. 13, is displayed in step S6307 and proceeds to step S6304. If not, a check is made in step S6308 to determine if the Act is Hold. If so, Hold UI is displayed in step S6309 and proceeds to step S6304. In step S6304, a check is made to determine if the information being saved or held is already exists using CheckExisting, which is explained in detail later and if so, returns true, otherwise return false.

In step S6308, if Act is not Hold, a check is made in step S6310 to determine if the Act is Send. If so, Send UI, an example of which is shown in FIG. 20, is displayed in step S6311 and the recipients (To, CC) information, Subject, Contents and/or the like are obtained from the user in step S6312 and proceeds to step S6320. If not, a check is made in step S6313 to determine if Act is Annotate. If so, Annotate UI, an example of which is shown in FIG. 22 is displayed in step S6314 and the actual Annotations executed using Annotate, which is explained in detail later, in step S6315 and process returns true. If not, a check is made in step S6316 to determine if Act is Extract.

If so, Extract UI, an example of which is shown in FIG. 26, is displayed in step S6317 and the actual Extract information executed using Extract, which is explained in detail later, in step S6318 and process returns true. If not, Mgmt, which is explained in detail later is executed in step S6319 and process returns false.

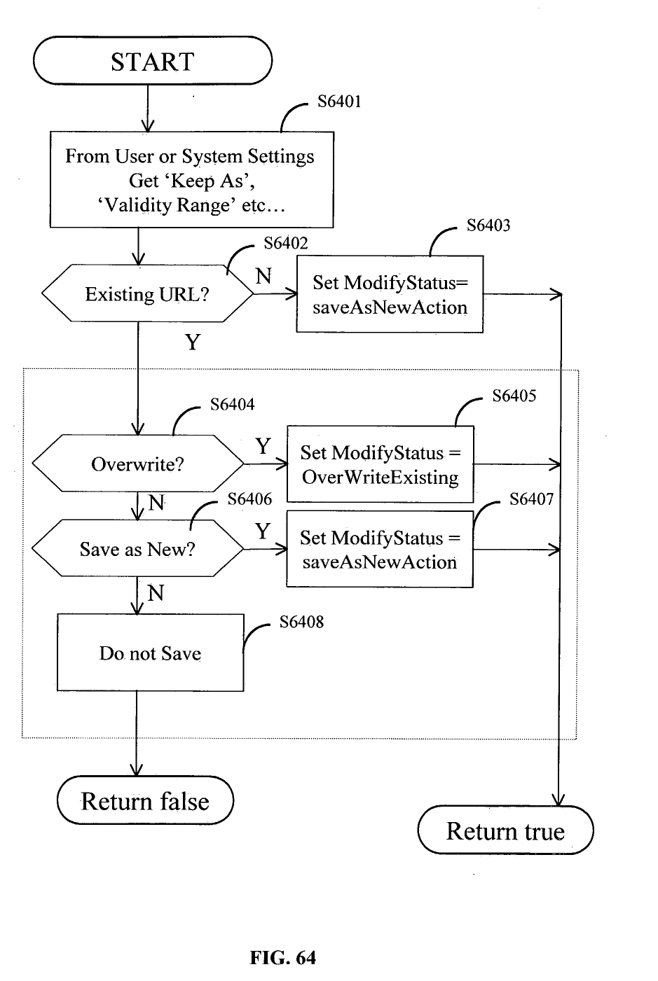

FIG. 64 is a flowchart of the procedural steps of S6304 CheckExisting to check if the information already exists in the knowledge base or not. In step S6401, the values of Keep As, Validity Range etc . . . are either obtained from the user or from the system settings. In step S6402, a check is made to determine whether the URL already exists. If URL does not exist, the process proceeds to step S6403 where Modifystatus is set to SaveAsNewAction is set to and returns true. If URL exists, a check is made in step S6404 to determine if the information needs to be over-written (i.e., update or modify the previous information). This is done either by asking the user, whether he would like to overwrite the existing information, save as new do not save or based on the user settings. If so, in step S6405, ModifyStatus is set to OverWriteExisting and the process returns true. If not, a check is made in step S6406 to determine if the information needs to be saved as new, (i.e., without modifying the existing information, save the current information as a separate entity). If so, ModifyStatus is set to saveAsNewAction and the process returns true. If not, the process returns false.

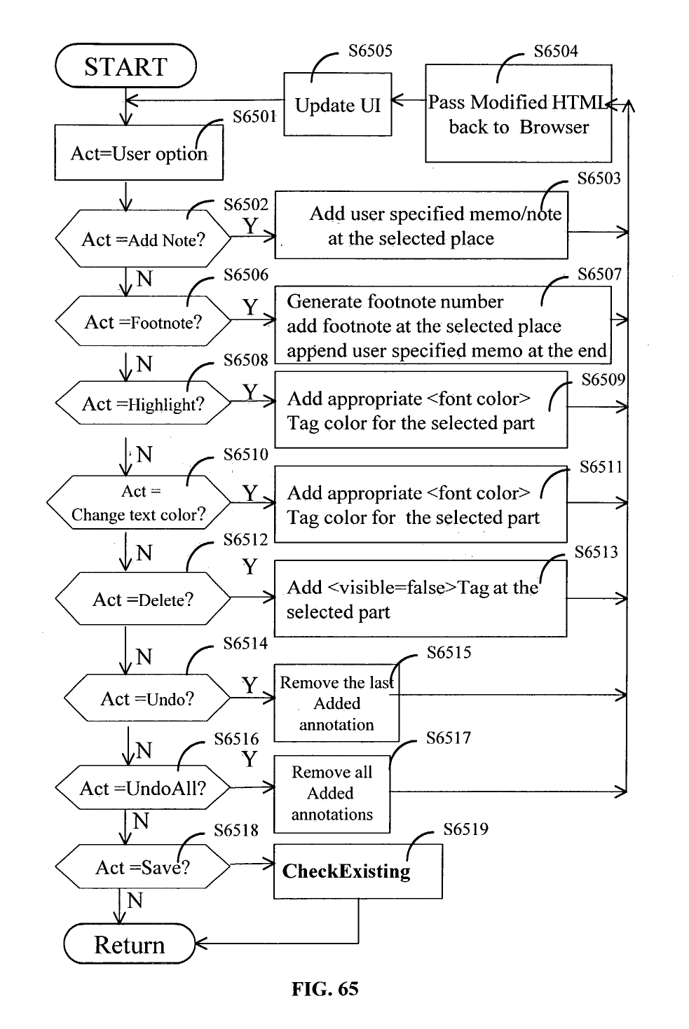

FIG. 65 is a flowchart of the procedural steps of S315 Annotate and FIG. 22 shows an example user interface for Annotating a web page currently being browsed. In step S6501, the user-performed operation is set to Act. A check is made in step S6502 to determine if Act is Add Note. If so, the user specified memo/note is added to the selected place in step S6503 and goes to step S6504. If not, a check is made in step S6506 to determine if the Act is Footnote. If so, the footnote number is created based on a sequence and the footnote number is added to the selected place in the page and the actual contents of the footnote are added to the end of the page in form of a table and proceeds to step S6504. The notes added to the page are added based on user settings, to set the “annotation demarkers”, “default annotation text”, the color of annotation etc. The annotations are added as standard HTML tags. If Act is not Footnote in step S6506, a check is made in step S6508 to determine if the Act is Highlight. If so, a Font tag <font bgcolor= . . . > is added around the selected text with the background color set to the selected color in step S6509 and proceeds to step S6504. If not, a check is made in step S6510 to determine if the Act is Change text color. If so, a Font tag <font color= . . . > is added around the selected text with the foreground color set to the selected color in step S6511 and proceeds to step S6504. If not, a check is made in step S6512 to determine if Act is Delete. If so, the tag is modified to <visible=false> to hide the selected part of the text in step S6513 and proceeds to step S6504. If not, a check is made in step S6514 to determine if Act is Undo. If so, the last performed annotation is undone and proceeds to step S6504. If not, a check is made in step S6516 to determine if Act is UndoAll. If so, all the annotation performed by the user on this page during this session are removed and proceeds to step S6504.If not a check is made in step S6518 to determine if the Act is Save, in which case step S6519, CheckExisting explained earlier is executed. In either case the function returns, if no more action needs to be performed by the user. In step S6504, the modified HTML tag page is passed back to the browser, which will render and update the UI in step S6505 and return to step S6501. If Act is none of the ones specified in the flowchart, the function returns.

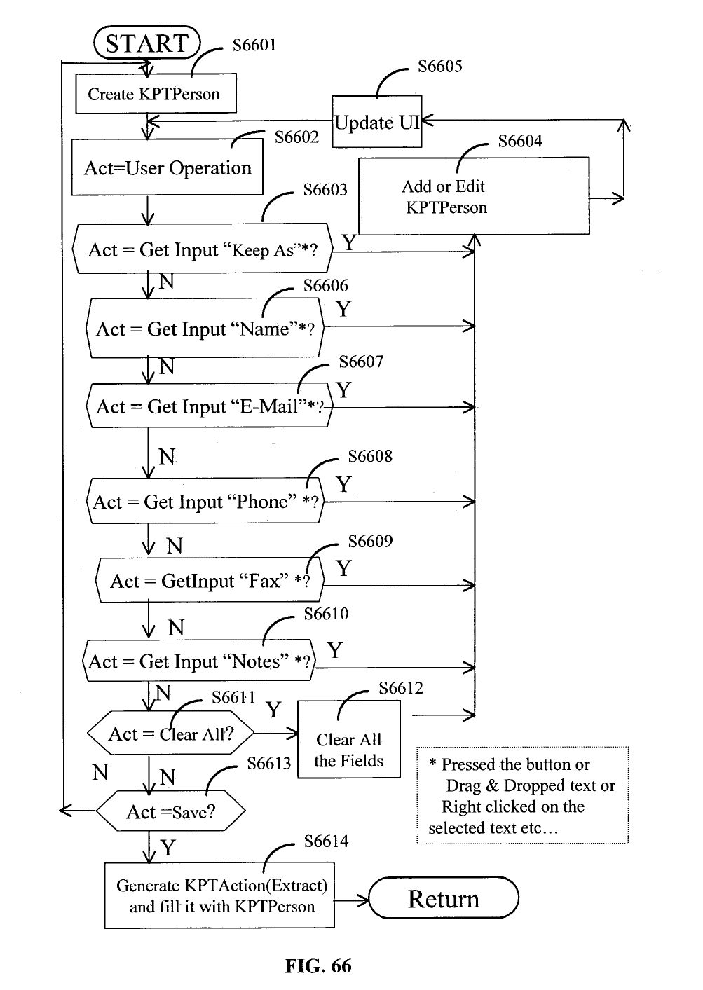

FIG. 66 is a flowchart of the procedural steps of S6138 Extract. In step S6601, an instance of the knowledge structure for person—KPTPerson is created. In step S6602, the User operation is set to Act. An example User interface to describe some of the action is shown in FIG. 26. First a check is made to determine the type of Act (i.e., if Keep As, Name, Email, Phone, Fax, Notes) was input by the user (steps S6603, S6607˜S6610). This action can be performed in various ways, like first selecting the text to be extracted and pressing a predefine button, or dragging and dropping the text to be extracted to the appropriate field or by right clicking on the selected text and specifying it to be the extracted data. If so, the KPTPerson knowledge structure is modified appropriately in step S6604 and the UI gets updated in step S6605 and the process returns to S6602. If the Act is Clear All (step S6611), all the fields are cleared in step S6612 and process proceeds to S6604. If the Act is Save (step S6613), a new action KPTAction is created of type Extract and the KPTPerson is filled as associate object and the process returns.

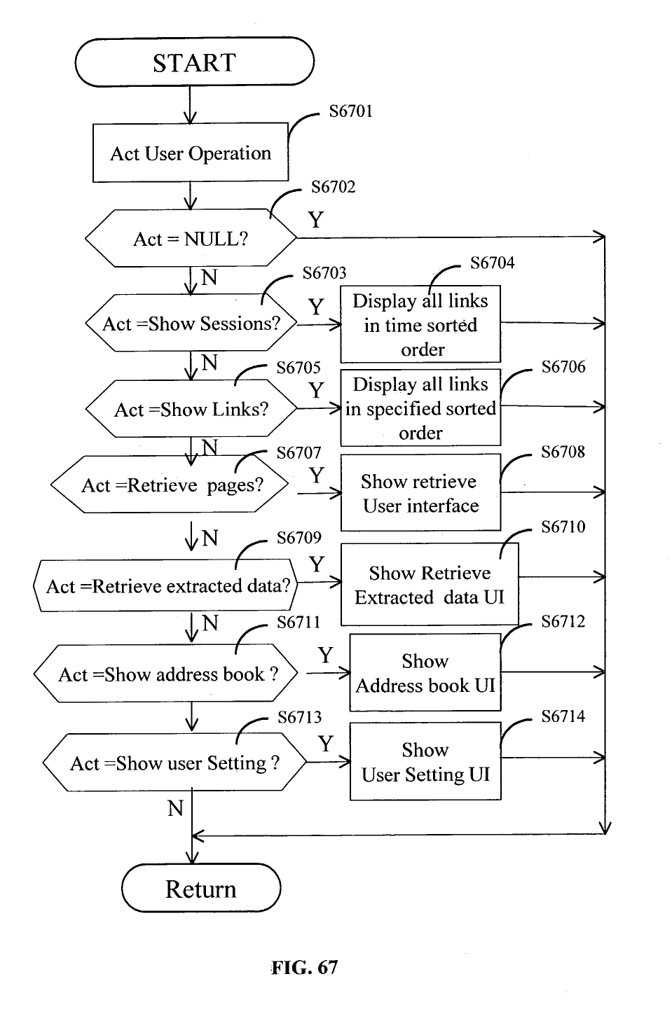

FIG. 67 is a flowchart of the procedural steps of S6319 Mgmt. In step S6701, Act is set to the user-performed operation. In step S6702, a check is made to determine if Act is NULL. If so, the process returns. If not, a check is made in step S6703 to determine if Act is Show Sessions. If so, all the links are sorted in time order and displayed in step S6704 and the process returns. If not, a check is made in step S6705 to determine if the Act is Show Links. If so, all the links are sorted in the specified order and displayed in step S6706 and the process returns. If not, a check is made in step S6707 to determine whether Act is Retrieve pages. If Act is to retrieve a page, the process proceeds to step S6708 where RetrieveUI is displayed. If not, a check is made in step S6709 to determine if Act is Retrieve extracted data. If so, Show Retrieve Extracted data UI is displayed. If not, a check is made in step S6711 to determine if Act is Show address book. If so, Show Address book UI is displayed and the process returns. If not a check is made in step S6713 to determine if Act is Show User Settings. If so, the user settings are displayed to the user in step S6714 and the process returns.

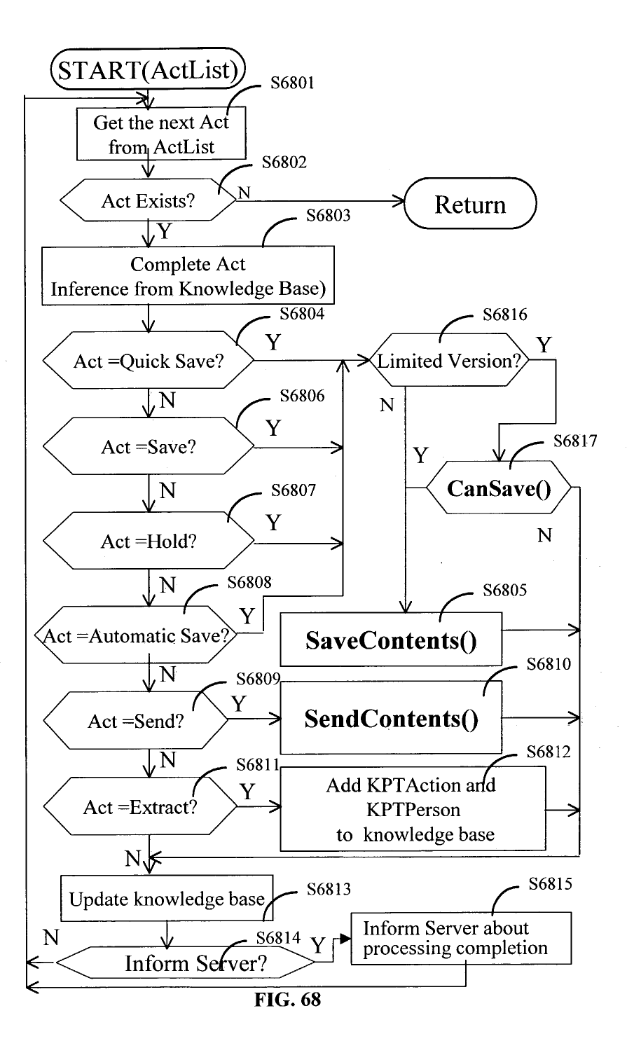

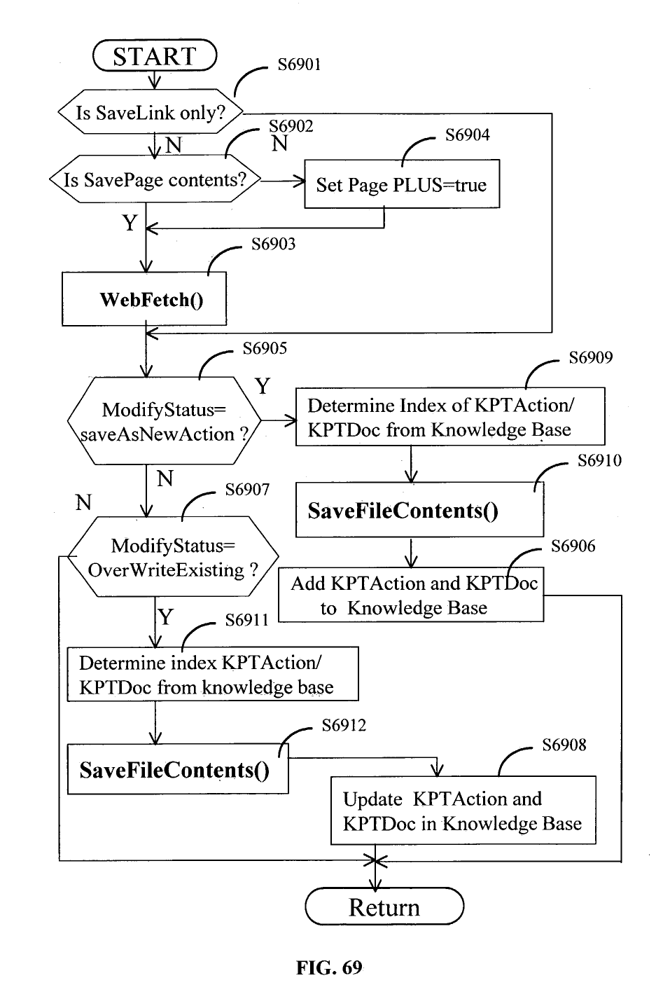

FIG. 68 is a flowchart of the procedural steps of S6022 ExecuteAction. In step S6801, the next Act is got from the ActList. In step S6802, a check is made to determine if Act exists. If not, the process returns. Otherwise, in step S6803 inference is made using the knowledge base to complete the Act. A check is made in steps S6804˜S6808 to determine if Act is Quick Save or Save or Hold or Automatic Save and if either one of them is true, step S6805, SaveContents as explained later in FIG. 69. is executed and goes to step S6813. Otherwise a check is made in step S6809 to determine if Act is send. If so, SendContents, as explained later in FIG. 69 is executed and goes to step S6813. If not, a check is made in step S6811 to check if Act is Extract. If so, the KPTAction and the corresponding KPTPerson are added to the knowledge base in step S6812 and in step S6813 the knowledge base is updated. A check is made in step S6814 to determine if the completed action needs to be informed to a server for purpose of logging or otherwise. If so, step S6815 is executed wherein the actual information is sent to either a predefined or user specified server about the processing completion and the process returns to step S6801 to fetch the next action from the ActList, till there are no more action left to be processed, at which stage the process returns.

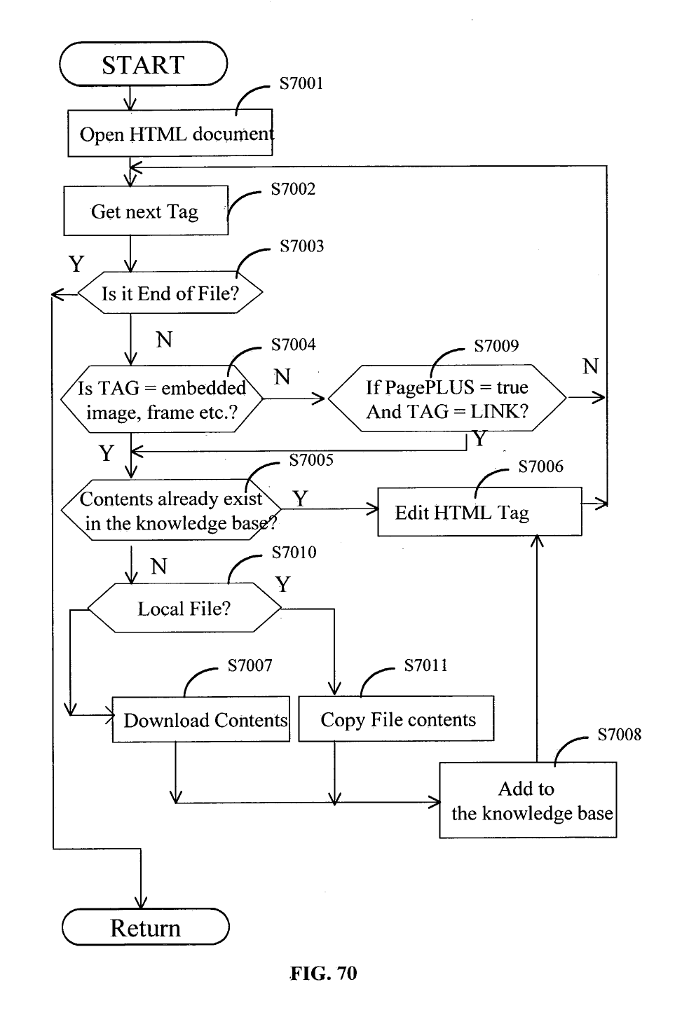

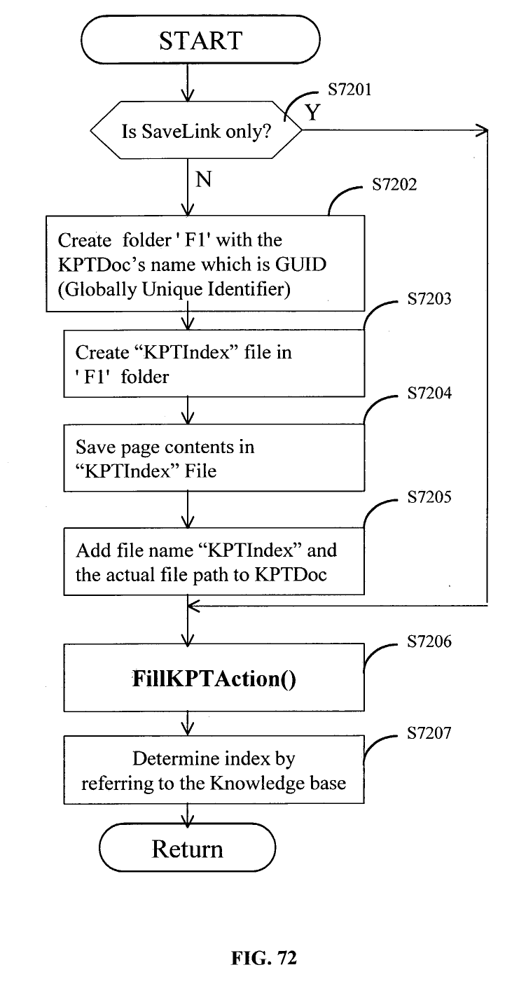

FIG. 69 is a flowchart of the procedural steps of SaveContents in step S6805 of this embodiment. A check is made in step S6901 to determine if it is a SaveLink only operation. If so, process proceeds to step S6905. Otherwise, a check is made to determine if it is a SavePage contents operation in step S6902. If so, Page PLUS is set to true in step S6904. In either case, step S6903, WebFetch is executed, which is explained in detail later in FIG. 70, in step S6903. In step S6905, a check is made to determine if ModifyStatus is saveAsNewAction or not. If so, indices of KPTAction and the associated KPTDocument is determined from Knowledge Base in step S6909 and SaveFileContents is executed as explained in FIG. 72, in step S6901. The KPTAction and KPTPerson are added to Knowledge Base in step S6906 and the process returns. If ModifyStatus is not saveAsNewAction, check is made in step S6907 to determine if it is OverWriteExisiting. If not the process returns, otherwise, in step S6911 indices of KPTAction and the associated KPTDocument is determined from Knowledge Base in step S6911 and SaveFileContents is executed as explained in FIG. 72, in step S6902. The KPTAction and KPTPerson are updated in the Knowledge Base in step S6908 and the process returns.

FIG. 70 is a flowchart of the procedural steps of WebFetch in step S6903 of this embodiment. In step S7001, HTML document obtained from the browser is opened. In step S7002, next tag is got. In step S7003, a check is made to determine if the end of file has been reached. If so the process returns. If not, a check is made to determine if the tag is for an embedded image, frame etc. in step S7004. If so, step S7005 is executed. If not, a check is made in step S7009 to determine if PagePLUS is true and the Tag type is of LINK. If not the process returns back to step S7002 to fetch the next tag. Otherwise, step S7005 is executed in which a check is made to see if the contents (i.e., embedded images etc.) already exist in our knowledge base and they are up to date in step S7005. If so, the HTML tag is edited in step S7006 to change the absolute or original path to the local path of the system where the file exists and process returns to step S7002. If not, a check is made to determine if the file to be fetched is a local file in step S7010. If so, the file contents are just copied, using a simple file copy command in step S7011, otherwise the contents are downloaded from the internet in step S7007. In either case step S7008 is executed, wherein the knowledge base is modified to update the information downloaded etc. and process returns to step S7002 to fetch the next tag in the HTML document. The process continues till end of file is reached at which instant the process returns.

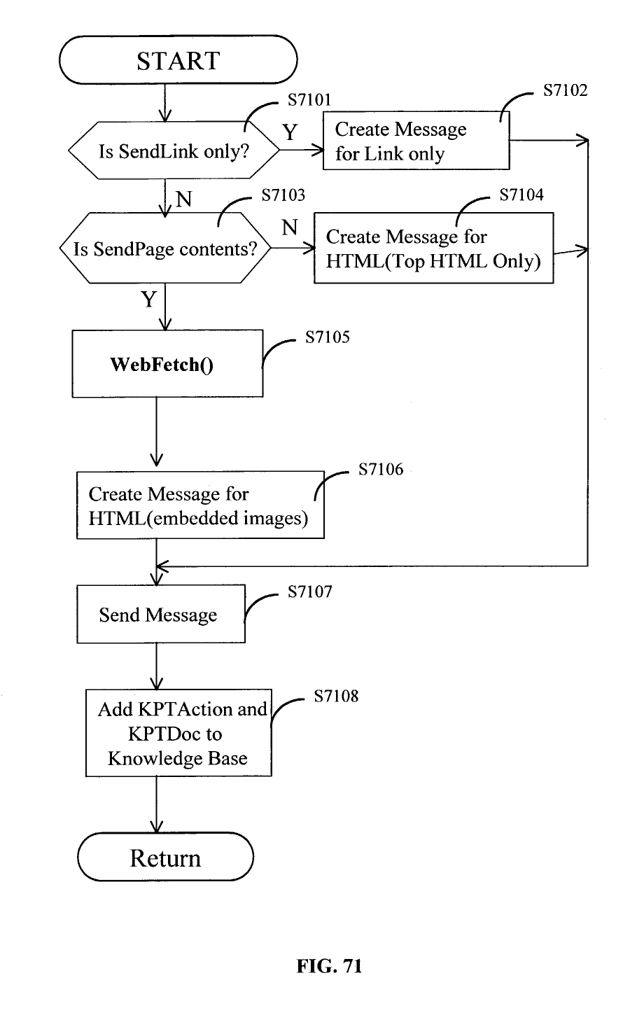

FIG. 71 is a flowchart of the procedural steps of SendContents in step S6810 of this embodiment. In step S7101, a check is made whether the contents to be sent are SendLink only. If so, a message is created with the given Link in step S7102 and proceeds to step S7107. If not so, a check is made to determine if the contents to be sent are SendPage (i.e., send the HTML page including the embedded images etc.), in step S7103. If not so, a message for only top HTML is created and proceeds to step S7107. Otherwise, Webfetch is executed as explained in FIG. 70 in step S7105. In step S7107, the created message is sent and the knowledge structures KPTAction and KPTDocument are added to knowledge base in step S7108 and the process returns.

FIG. 72 is a flowchart of the procedural steps S6910, S6912 SaveFileContents of this embodiment. A check is made in step S7201 to determine if the contents to be saved is SaveLink only. If so, the process continues to step S7206. In step S7202, a folder F1 with the name based on the KPTDocument's name, which is a Globally unique identifier (GUID) is created, which ensures that the folder to be created is unique within and across the local system.

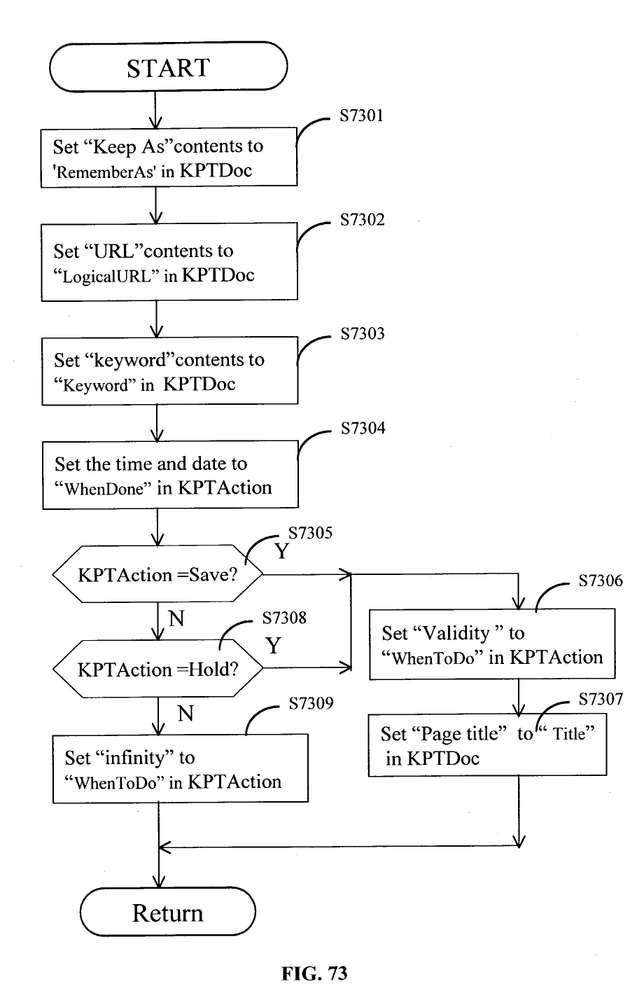

In step S7203, a file called KPTIndex is created in the folder created in previous step. The actual page contents (i.e., HTML text) are saved to the file created in the previous step. The fully qualified file name (i.e., the folder name and the file name) is stored as the physical URL location of the KPTDocument. In step S7206, FillKPTAction is executed which is explained in detail in FIG. 73 and the other required indices are determined by referring to the knowledge base in step S7207 and the process returns.

FIG. 73 is a flowchart of the procedural steps of S7206, FillKPTAction of this embodiment. In step S7301, the contents of ‘Keep As’ are set to ‘Remember As’ field of KPTDocument. In step S7302, the contents of ‘URL’ are set to ‘LogicalURL’ field of KPTDocument. In step S7303, the contents of ‘keyword’ are set to ‘Keyword’ field of KPTDocument. In step S7304, the time and date are set to ‘WhenDone’ field of KPTAction. In step S7305, a check is made to determine if KPTAction is Save. If so, step S7306 is executed. If not, a check is made in step S7308 to determine if KPTAction is Hold. If so, in step S7306, the ‘Validity’ is set to ‘WhenToDo’ field of KPTAction and in step S7307, ‘Page title’ is set to ‘Title’ of KPTDocument and process returns. If not, step S7309 is executed, in which the ‘WhenToDo’ field of KPTAction is filled with value ‘infinity’ and the process returns.

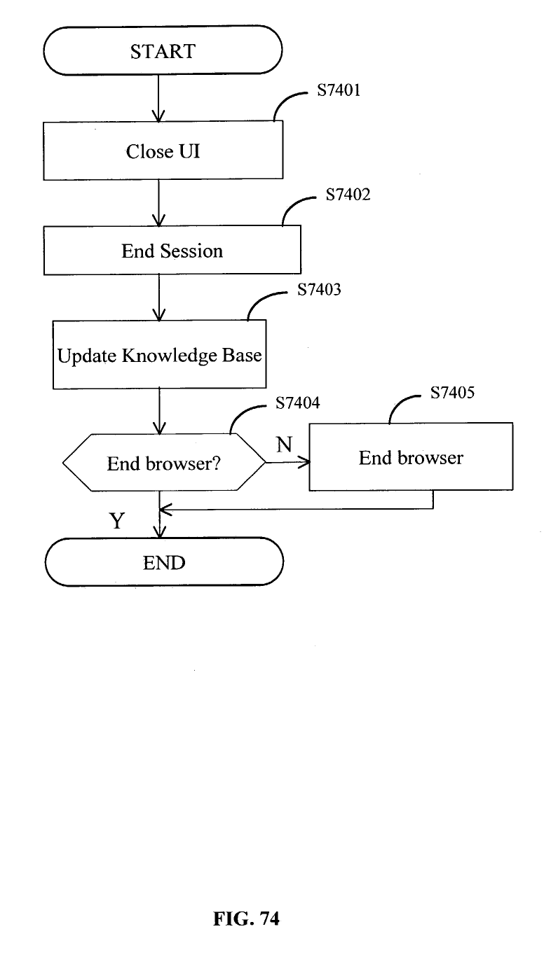

FIG. 74 is a flowchart of the procedural steps of TERMINATE of step S6003 of this embodiment. In step S7401, the UI on display are closed. In step S7402, all the current sessions are ended. In step S7403, Knowledge base is updated. A check is made in step S7404 to determine if browser needs to be ended or terminated. If so, the browser will be terminated in step S7405 and the process ends.

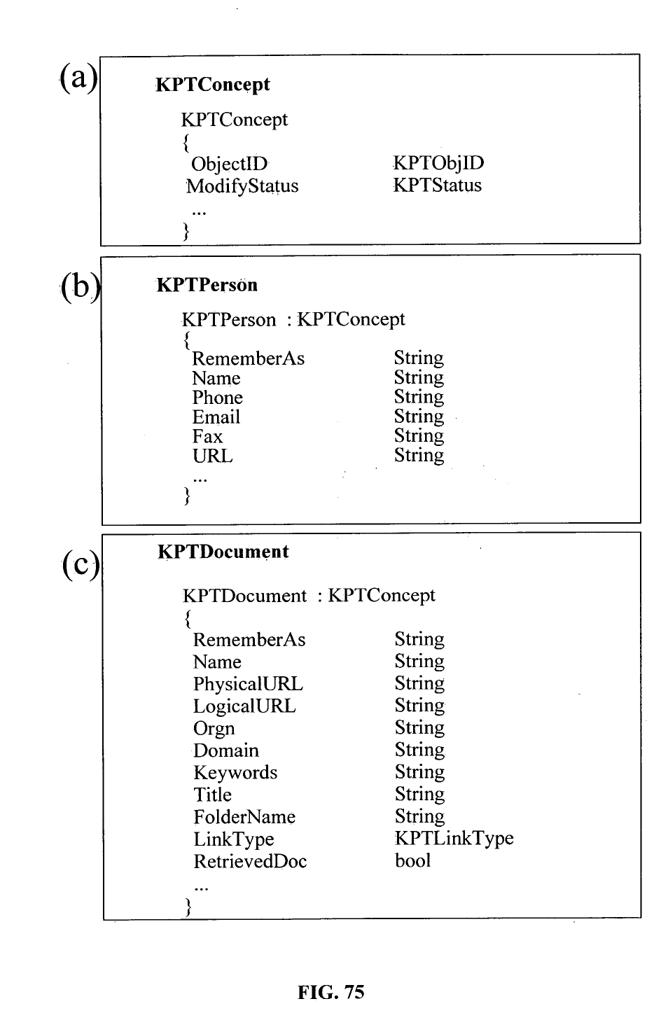

FIG. 75 shows an example of the knowledge structures in the knowledge base. (a), (b), (c) are the knowledge structure definitions for KPTConcept, KPTPerson and KPTDocument respectively.

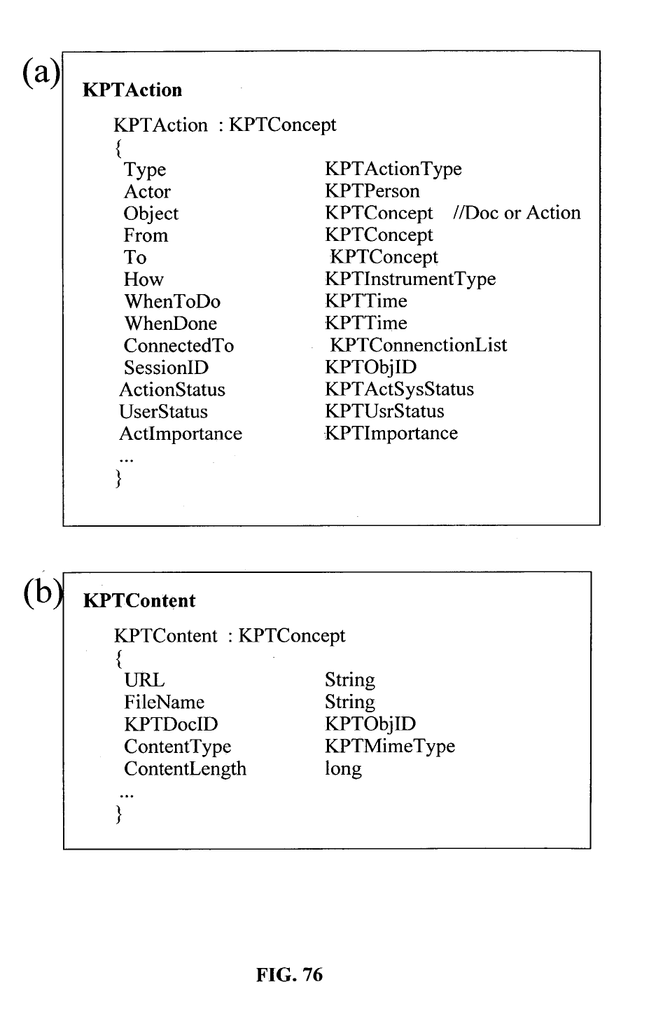

FIG. 76 shows an example of the knowledge structures in the knowledge base. (a), (b) are the knowledge structure definitions for KPTAction and KPTContent respectively.

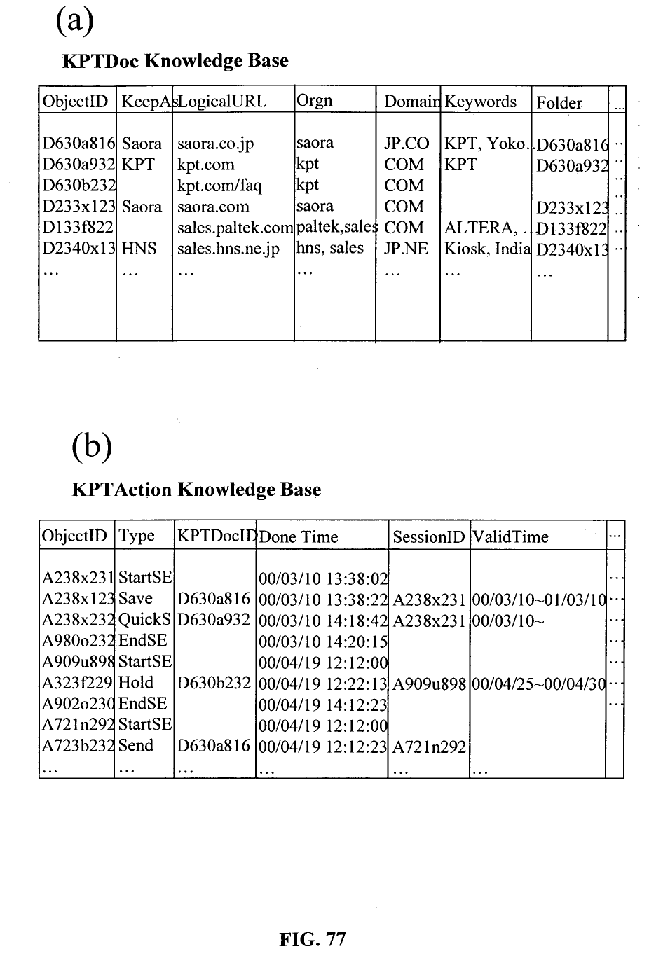

FIG. 77 shows an example content of the knowledge base. (a), (b) are the contents of the knowledge base for KPTDocument and KPTAction respectively.

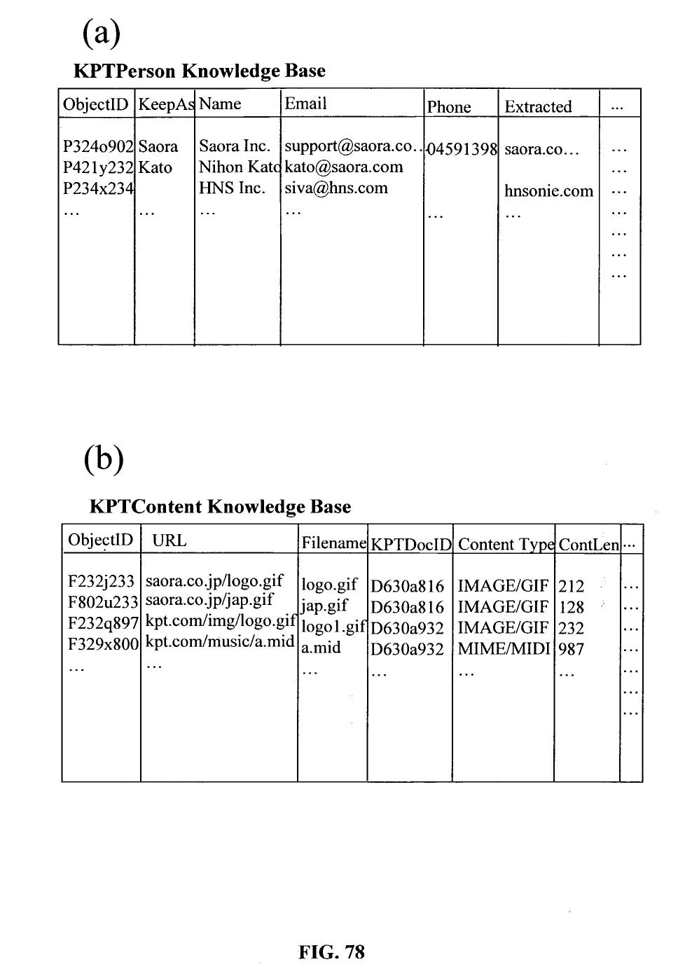

FIG. 78 shows an example content of the knowledge base. (a), (b) are the contents of the knowledge base for KPTPerson and KPTContent respectively.

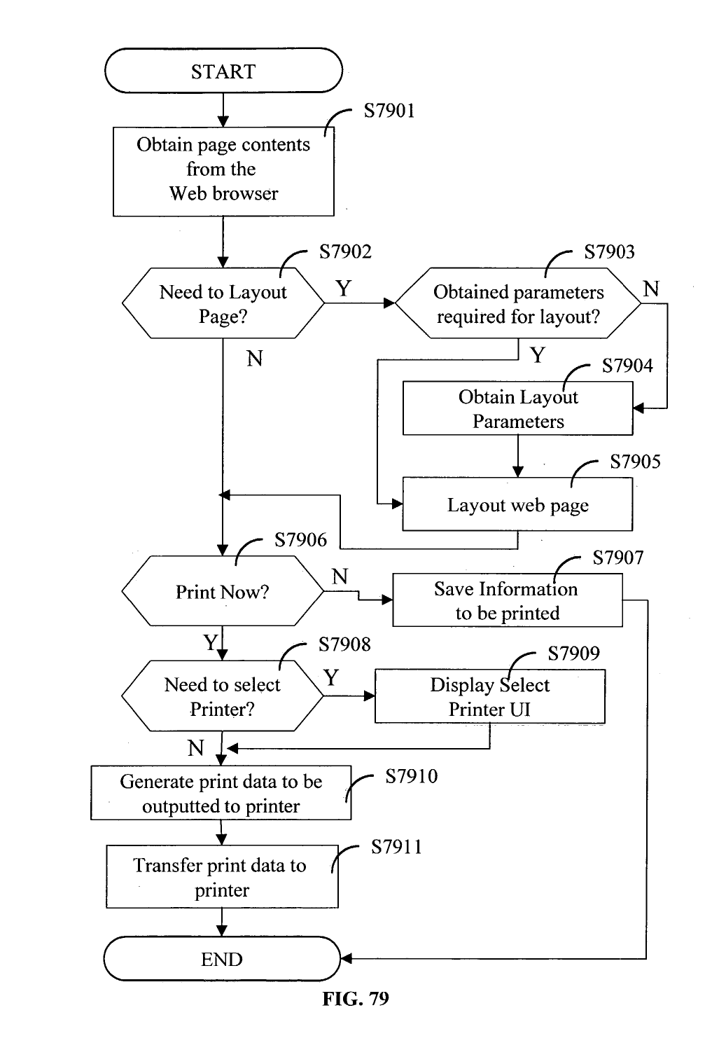

FIG. 79 is a flowchart of the procedural steps to process the PRINT command.

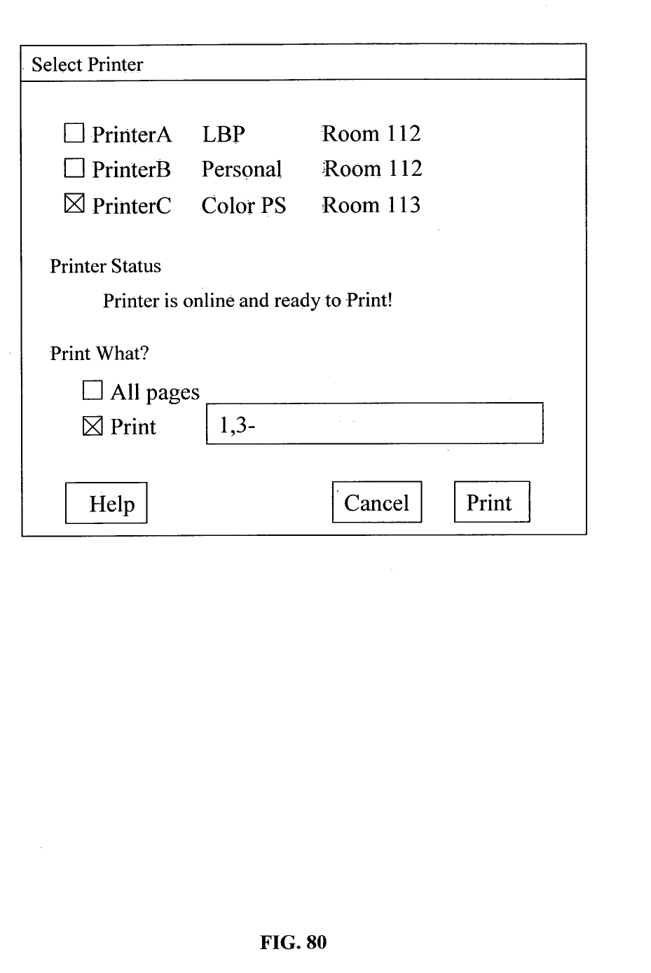

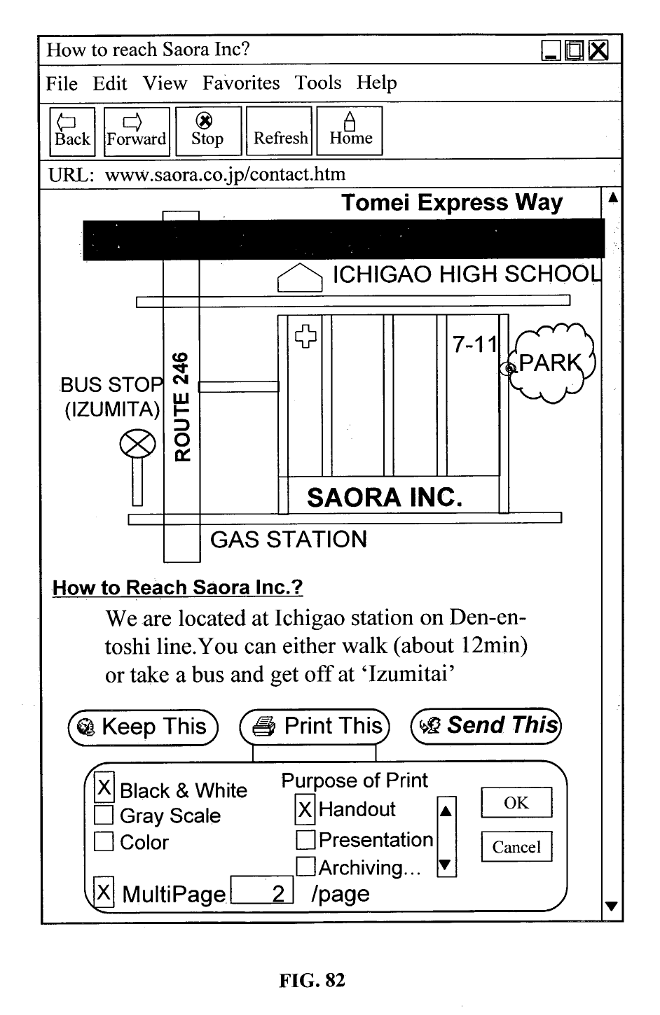

Unlike the Print option associated with the browser, this options lets the user to not only print the currently displayed page, but also allows for reformatting, laying out multiple pages onto a single page etc . . . When ‘Print This’ is clicked, for example in FIG. 3, the page contents are obtained from the web browser, in step S7901. In step S7902, a check is made to determine if page layout needs to be done. If so, a check is made in step S7903 to determine, if the parameters required for the layout have already been obtained. If not, the parameters are obtained in step S7904, an example of which is shown in FIG. 82. In either case, the process proceeds to step S7905, wherein the output contents are laid out and process proceeds to step S7906. In S7906, a check is made to determine if the print operation has to be performed immediately. If not, the print command is saved in S7907, and will be picked up later by the daemon process and the process ends. Otherwise, a check is made in step S7908, to determine if a printer for outputting needs to be selected either by the system or the user. If user is to select the printer, step S7909 is executed, wherein the Select Printer UI is displayed, an example of which is shown in FIG. 80. In either case step S7910 is executed, wherein the necessary print data is generated and the actual print data transferred to the printer for printing in step S7911

FIG. 80 is an example of Select Printer UI, of step S7909. As can be seen from the figure, it is not only possible to select the printer but also specify details of print.

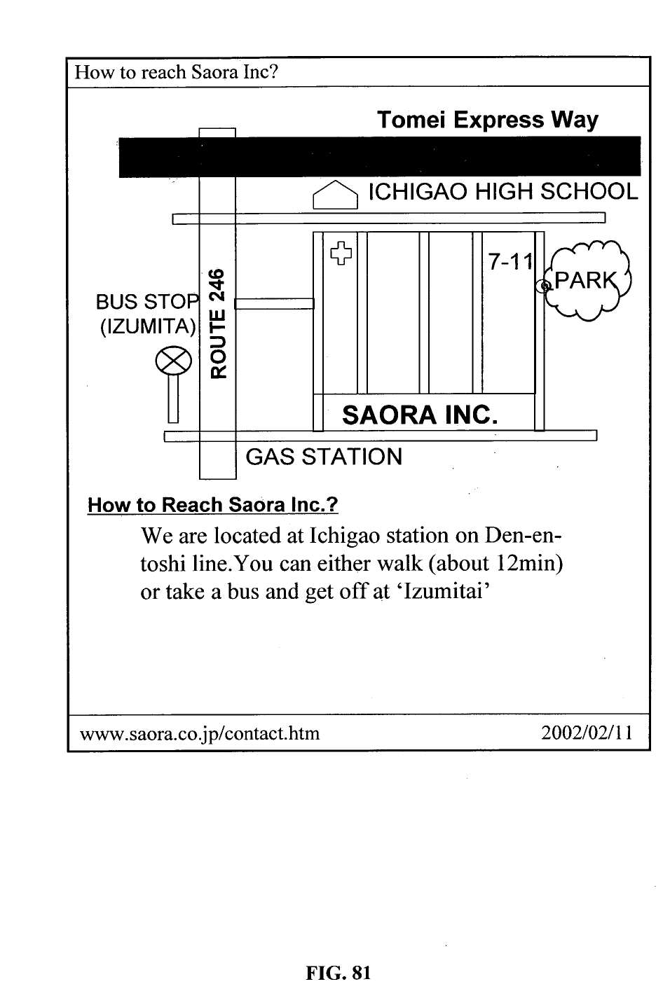

FIG. 81 is an example print output of the web page, which has not been laid out.

FIG. 82 is an example user interface within the web page to obtain the various parameters for PRINT. As can be seen from the figure, it is possible to specify various parameters—number of pages to be printer per physical page, purpose of print etc . . .

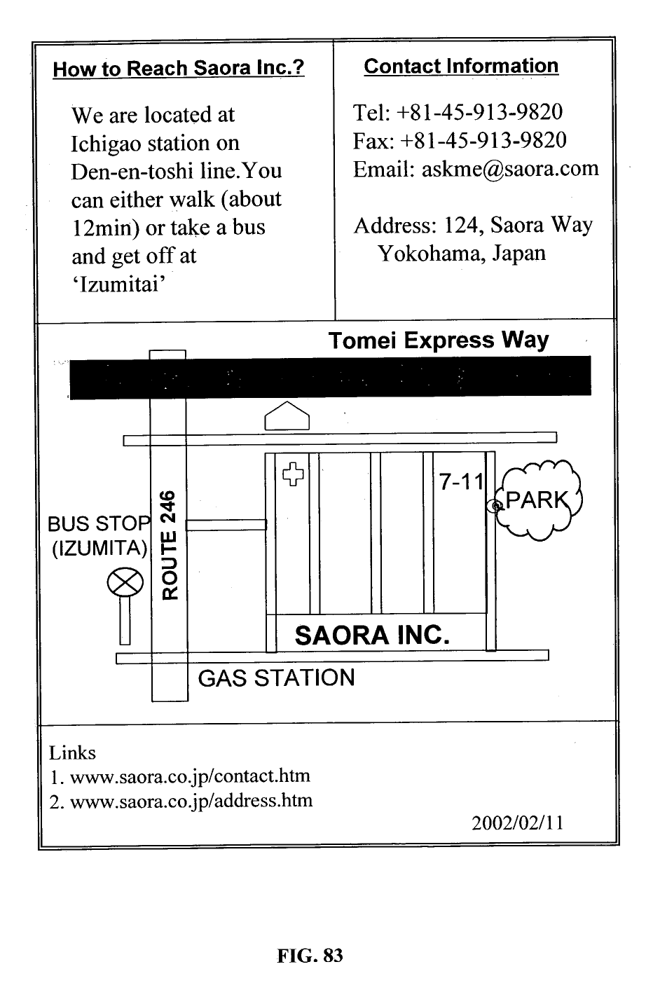

FIG. 83 is an example print output of multiple web pages laid out to a single page.

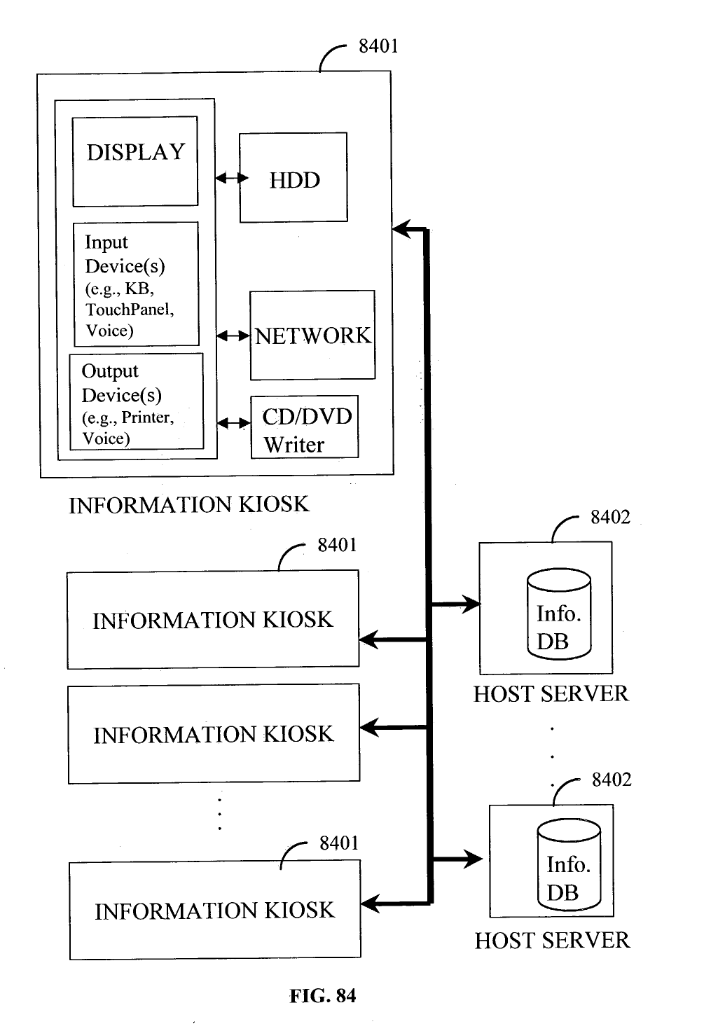

FIG. 84 shows another system architecture for this embodiment, when applied to Information Kiosk, which can be placed in public places like Hotels, Airport, Tourist sites, City office etc. The information can be maintained on a host server, which can be hosted separately by an organization or city office etc. It should be noted that traditional methods to send information by email is not possible, since the information is stored in a private place and sending only the link or the URL by email is of no use, since the information will not be accessible from anywhere else. As can be seen from the figure, the input devices can be Keyboard, Touch panel, Voice etc. and output devices can be either one or more of Printer, Voice etc., also all the above devices including the hard disk to store the information may be optionally present.

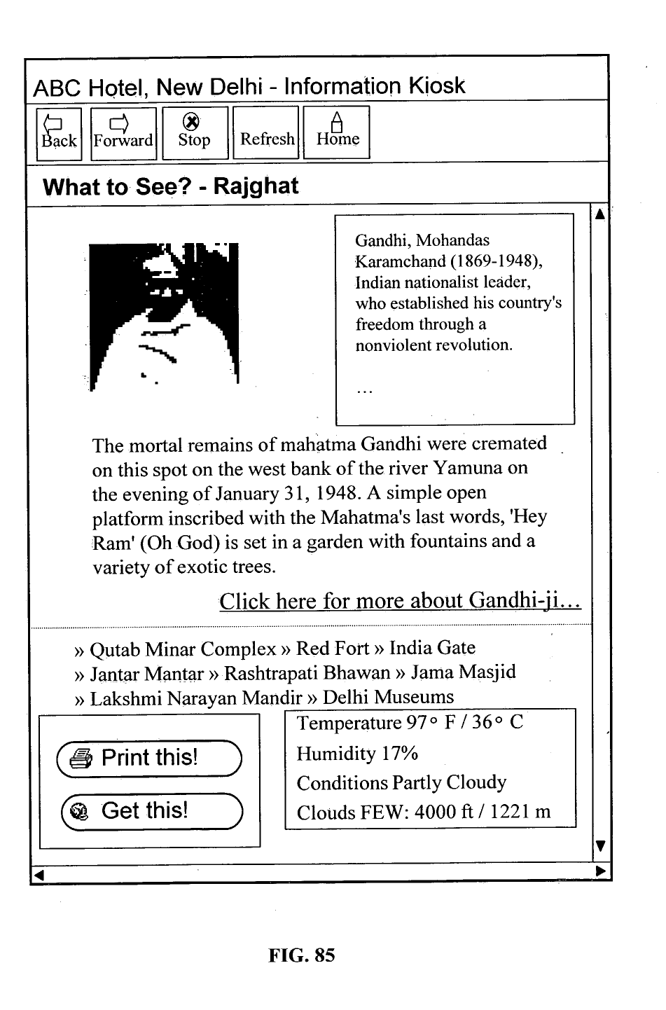

FIG. 85 shows an example web page displayed on the Information Kiosk along with commands embedded within the web page. As the user navigates through the information on the kiosk, he can choose to collect the information he would like to read later or get it by using the ‘Get this’ functionality.

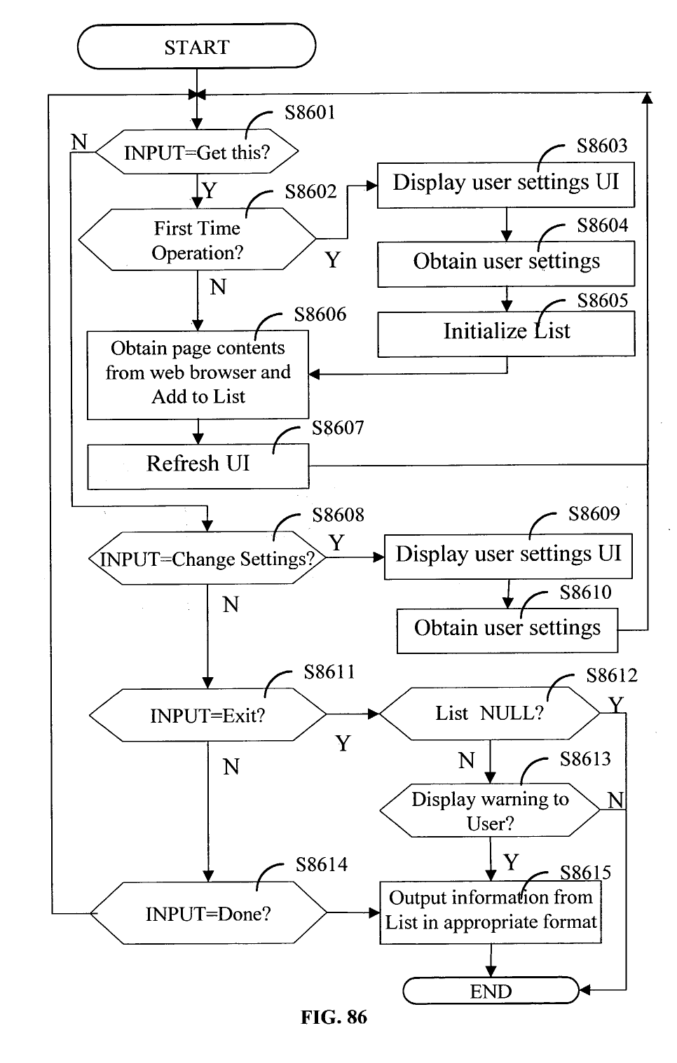

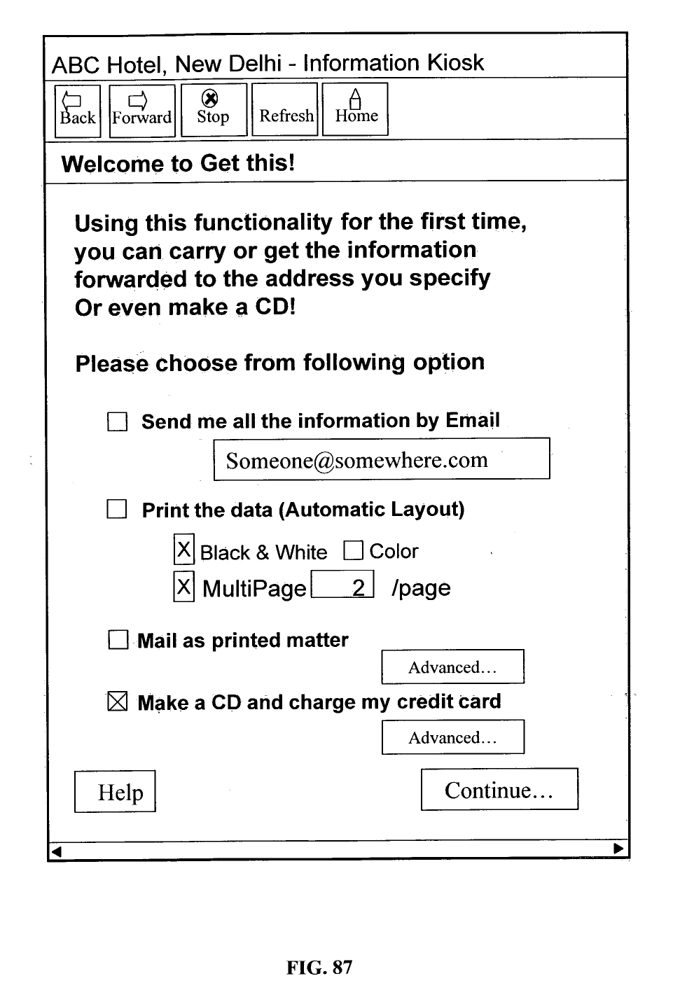

FIG. 86 is a flowchart of the procedural steps to process the commands on the Information Kiosk. A check is made in step S8601 to determine if the input command is ‘Get this’. If so, step S8602 is executed, wherein a check is made to determine if it is a First time operation. If so, the user settings are displayed in S8603, an example of which is shown in FIG. 87 and the settings obtained from the user in S8604 and the information list initialized in step S8605. In step S8606, the page contents are then obtained from the web browser and added to the List and the UI is refreshed in step S8608 to reflect the changes in the list and the process moves to step S8601. A check is made in step S8608 to determine, if the input is ‘Change Settings’, in which case step S8609 is executed to display the current settings to the user and any changes to the current settings obtained from the user in step S8610 and saved before returning back to step S8601. A check is made in step S8611 to determine if the input is ‘Exit’, in which as check is made in step S8612 to determine if user had collected any information in the list, if not the process ends, otherwise a check is made in step S8613 to determine if a warning message needs to be displayed to the user, if not the process ends. Otherwise the process moves to step S8615, which is also executed if the input is ‘Done’ from step S8614, to output the selected information in the appropriate format as selected by the user. It should be noted that the above process can either be executed on client as explained in FIG. 6 or can be performed on the server as explained in FIG. 37.

FIG. 87 shows an example UI of user settings. As can be seen from the figure, the information of interest can be collected and emailed, along with actual page contents, since the content may reside in a local or private server or get a print out either in AS IS or laying out for example, multiple pages onto a single page etc . . . or get the printed stuff, mailed as printed matter or sent out as a catalog or burn a CD-R or DVD of the information collected etc . . .

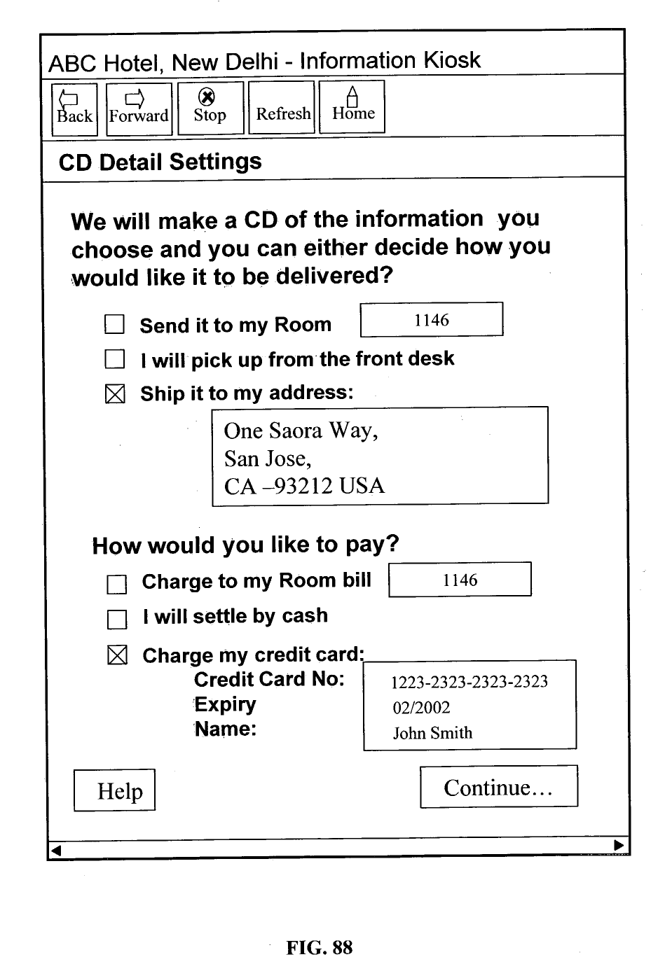

FIG. 88 shows an example UI of user settings for making a CD/DVD for the information selected by the user. As can be seen from the figure, the user can specify for example, the room number to which he would like the CD/DVD to be sent and also details of payment options.

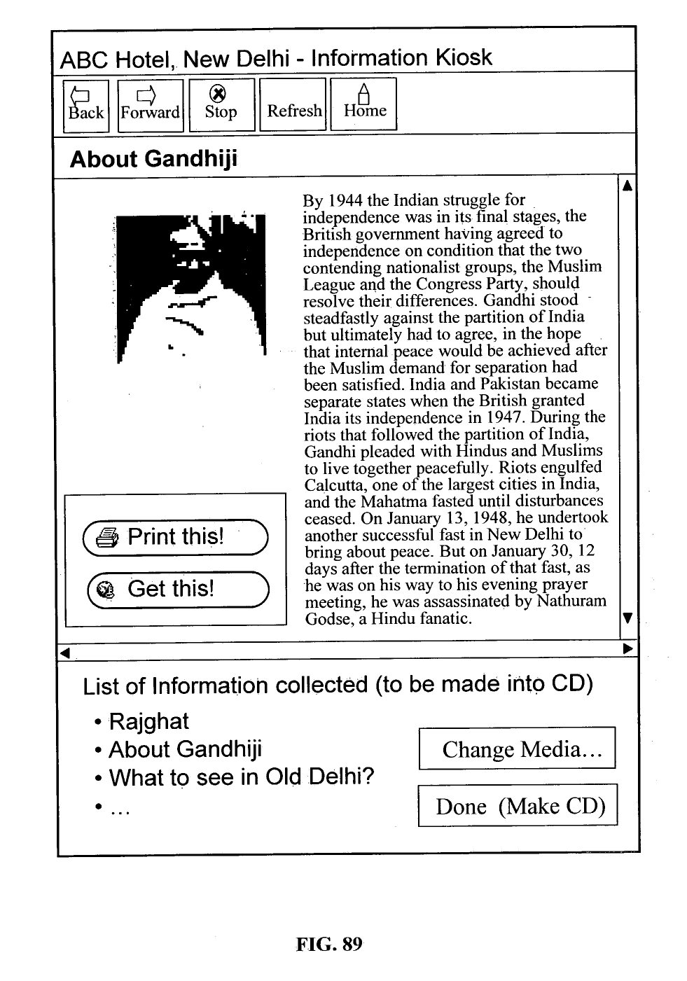

FIG. 89 shows an example UI for making the CD for the information collected by the user. User collects the information he is interested in by pressing the ‘Get this!’ button and the information currently collected can be seen in the bottom half of the screen and pressing ‘Done’ will result making of a CD as per user settings.

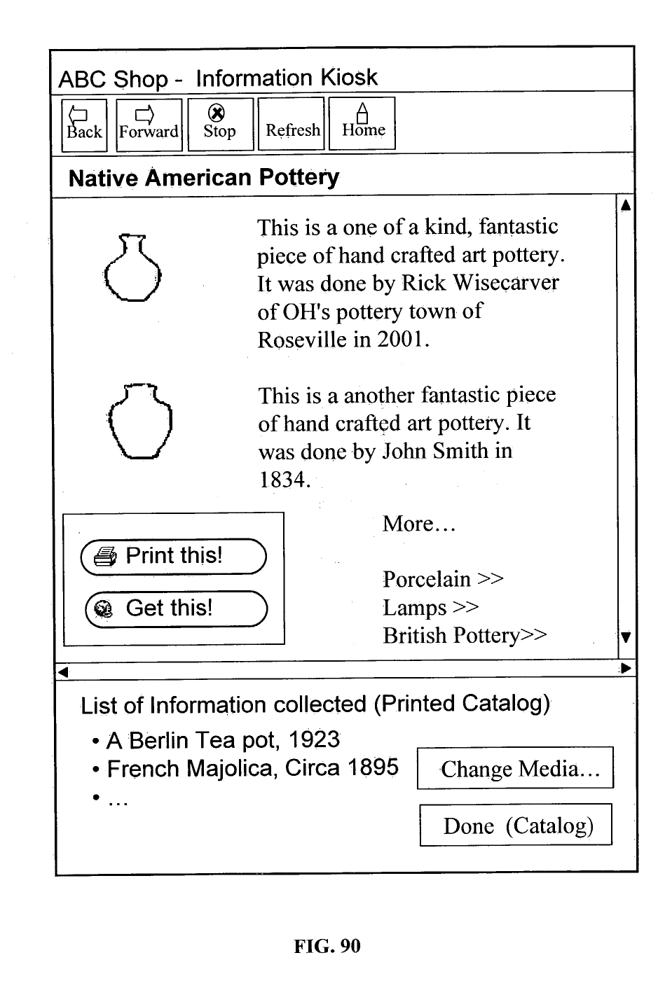

FIG. 90 shows another example of web page related to historic information with ‘Get this!’ button. This can be an E-Commerce site or a shop to make a customized personal catalog matching the interests of the user or customer. User can use the ‘Change Media’ option to change output form or media at any time. Also, it is possible that the user can choose to get all the information on a same CD or choose multiple CD option or choose a mixture of media, for example, a few pages on CD and rest as printed matter etc.

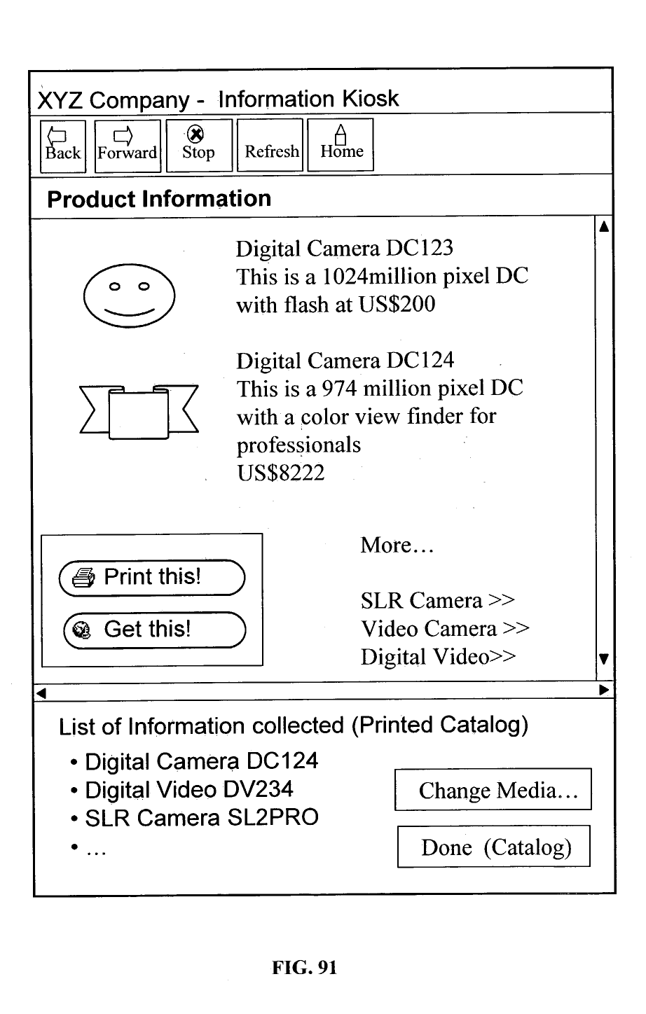

FIG. 91 shows another example of web page related to product information with ‘Get this!’ button. Information Kiosk can be set up for e.g., in company headquarters, branch office or showroom, which normally has the information from the intranet, to enable the customer to collect the product or other non-confidential information regarding the corporation.

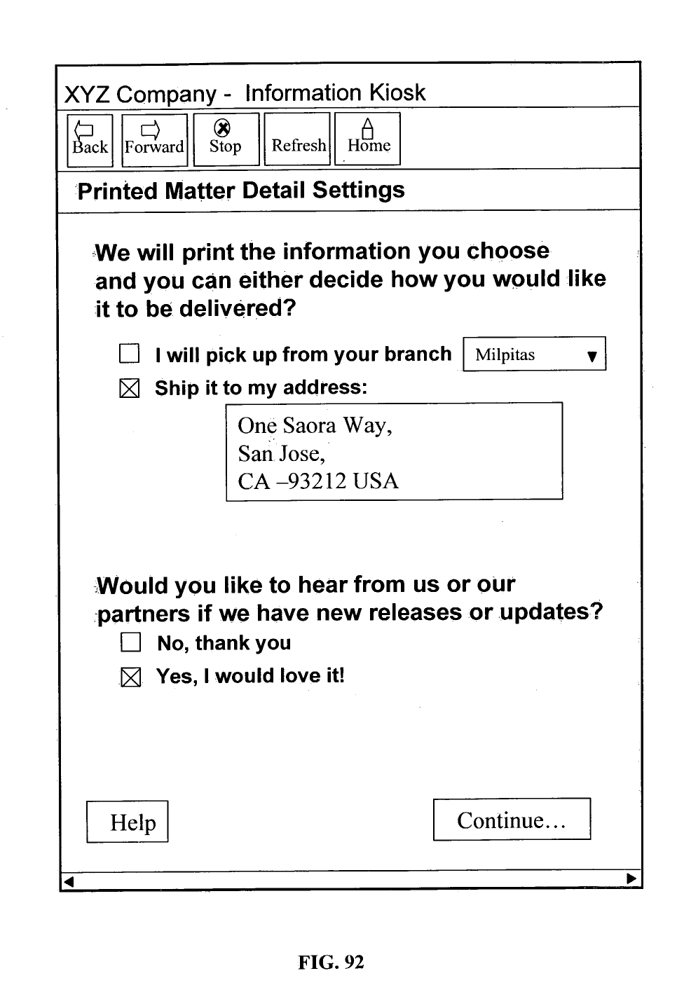

FIG. 92 shows an example user settings for printed matter delivery.

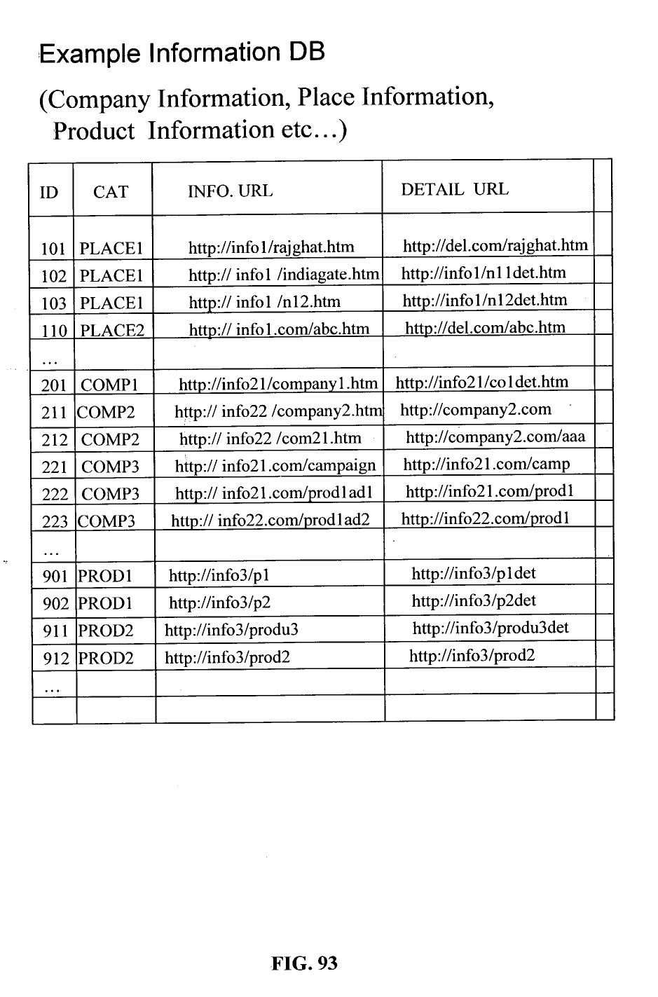

FIG. 93 shows an example information database for this embodiment.

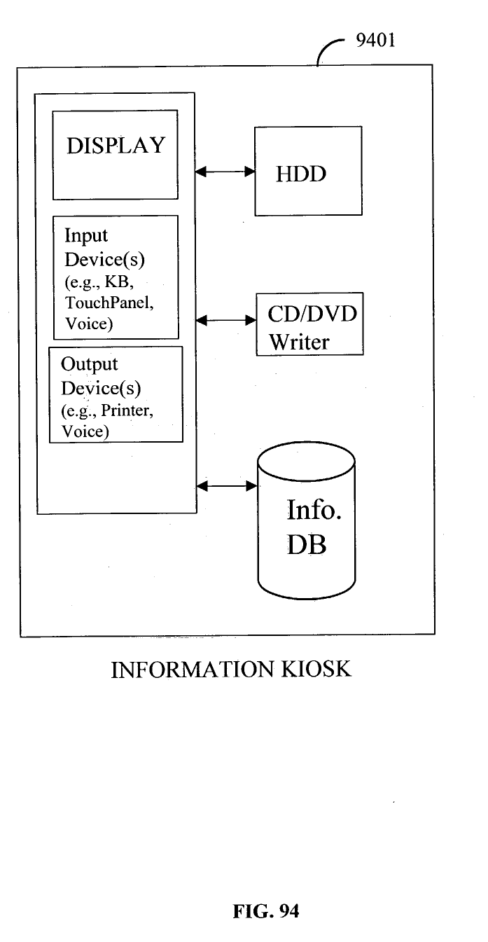

FIG. 94 shows another system architecture for the implementation of a standalone Information Kiosk for this embodiment. As can be seen from the figure, CD-R, Printer and the information database exist within the kiosk 9401. Since this is a standalone kiosk, there is no option to send the contents of the information by email.

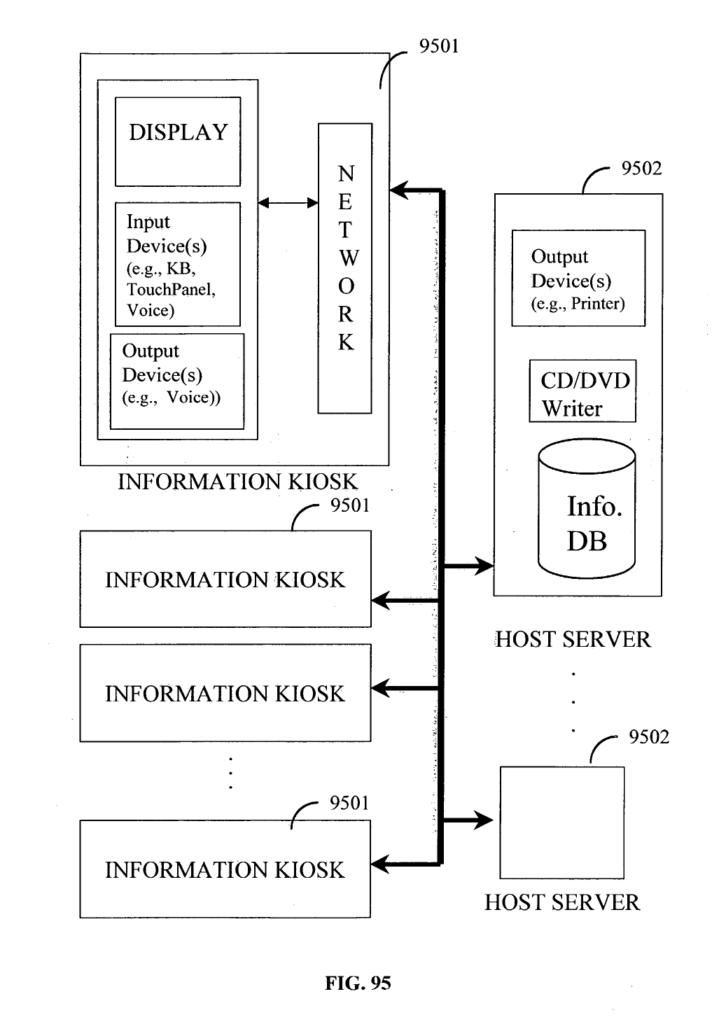

FIG. 95 shows another system architecture for the implementation of a networked Information Kiosk for this embodiment. As can be seen from the figure, multiple Information kiosks 9501 are connected on network to multiple Host Servers 9502, which has necessary output generation media like Printer, CD/DVD writer.

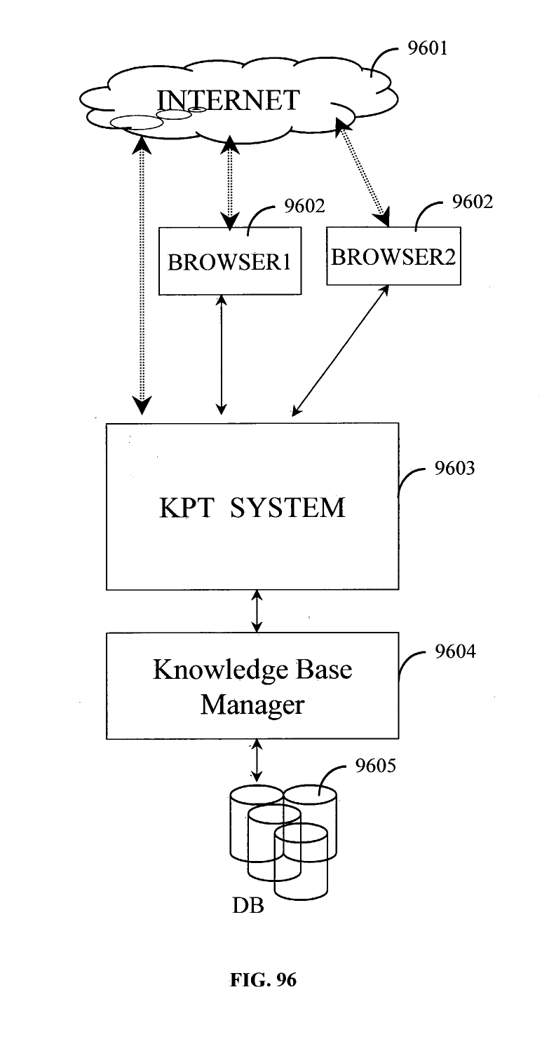

FIG. 96 shows example architecture, when multiple clients access the embodiment. Thus if multiple users use the same client then information is stored separately for each login user and is not visible to other users, to protect the privacy of the data. This can be implemented by either storing it in different databases or in separate tables, within a same database.

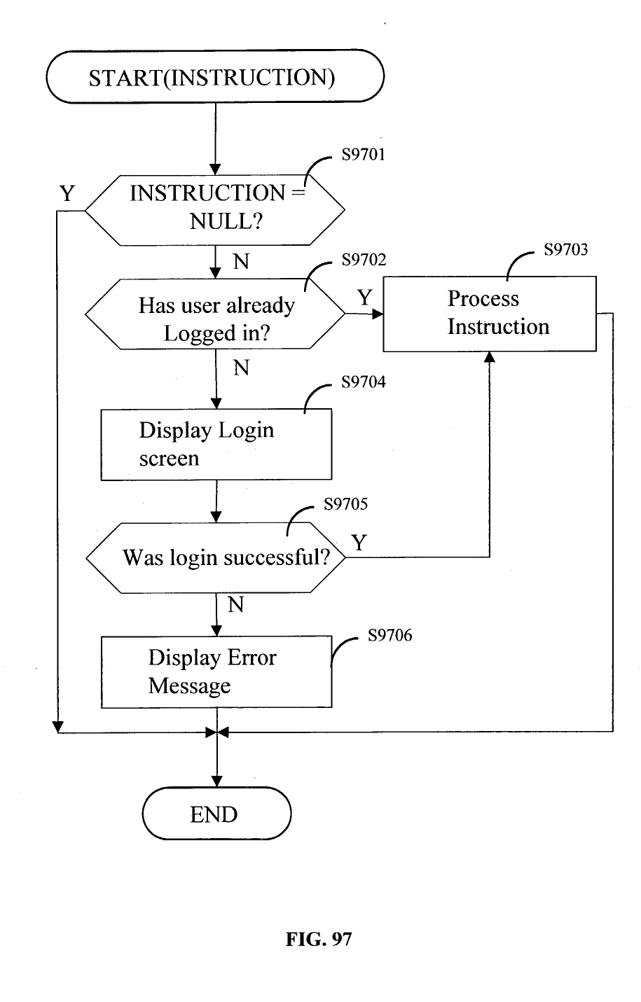

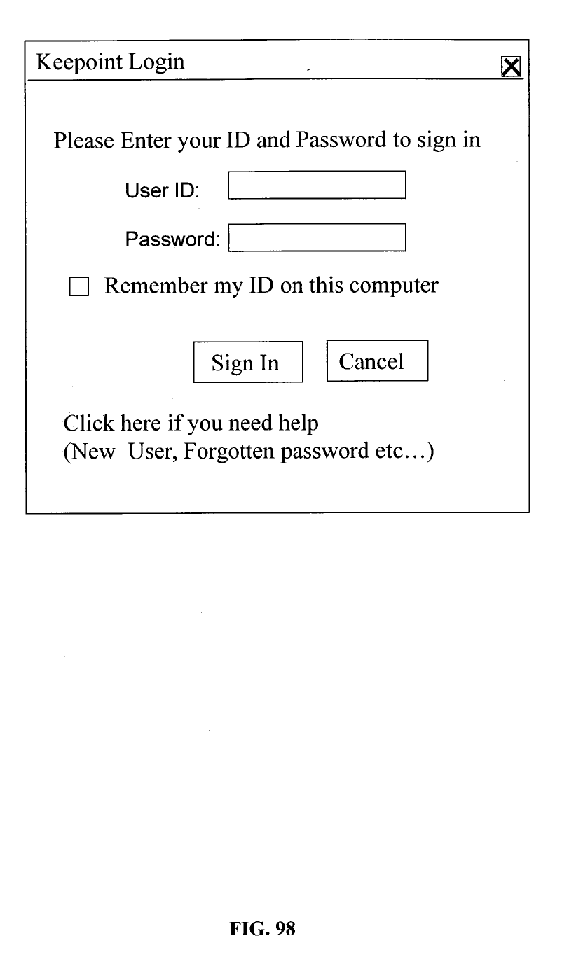

FIG. 97 is a flowchart of the procedural steps of INITIALIZE for the system shown in FIG. 96. As can be seen from the figure, a check is made in step S9701 to determine if the Instruction is Null. If so, the process ends otherwise, a check is made in step S9702 to determine if the user has already logged in. If so, the instruction is processed in step S9703 and the process returns, otherwise, login screen is shown to the user, an example of which is shown in FIG. 98. A check is made in step S9705 to determine, if the login was successful. If so, the process proceeds to step S9703, otherwise an error message is displayed in step S9706 and the process ends.

FIG. 98 is an example Login UI for the step S9704.

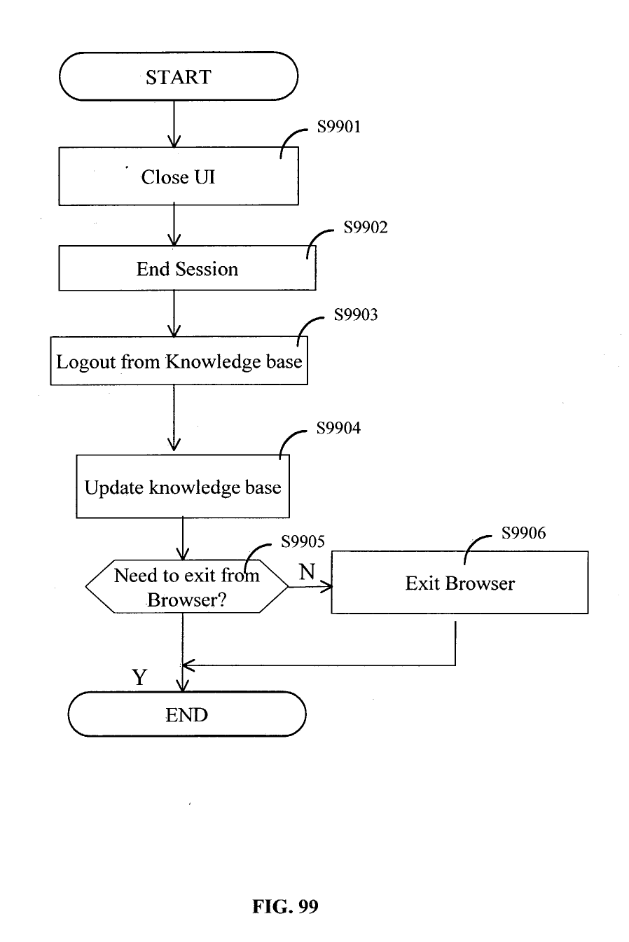

FIG. 99 is a flowchart of the procedural steps of TERMINATE for the system shown in FIG. 96. As can be seen from the figure, in step S9901, the UI on display are closed. In step S9902, all the current sessions are ended. The user is logged out from the knowledge base in step S9903 and in step S9904, Knowledge base is updated. A check is made in step S9905 to determine if browser needs to be ended or terminated. If so, the browser will be terminated in step S9906 and the process ends.

The present invention described above may be applied to a system constituted of a plurality of computers, or a specific computer within a system. The object of the present invention can also be achieved by supplying a storage medium storing program codes of software for implementing the function of the above embodiment to a system or an apparatus, and reading out and executing the program codes stored in the storage medium by a computer (or a CPU or MPU) of the system or apparatus. In this case, the program codes read out from the storage medium implement the function of the present invention, and the storage medium storing these program codes constitutes the invention. Also, besides the function of the above embodiment is implemented by executing the readout program codes by the computer, the present invention includes a case where an OS (Operating System) or the like running on the computer performs a part or the whole of actual processing in accordance with designations by the program codes and thereby implements the function of the above embodiment.

Furthermore, the present invention also includes a case where, after the program codes read out from the storage medium are written in a memory of a function extension board inserted into the computer or of a function extension unit connected to the computer, a CPU or the like of the function extension board or function extension unit performs a part or the whole of actual processing in accordance with designations by the program codes and thereby implements the function of the above embodiment.

Although the present invention has been described in its preferred form with a certain degree of particularity, many apparently widely different embodiments of the invention can be made without departing from the spirit and scope thereof. It is to be understood that the invention is not limited to the specific embodiments thereof except as defined in the appended claims.

What is claimed is:

1. An information processing method comprising the steps of:
obtaining a processing instruction from a displayed web page; and
transferring the obtained processing instruction to a processing unit which is able to execute the processing instruction.

2. The method according to claim 1, wherein in said obtaining step, the processing instruction is obtained in response to an operation of a button or a mark provided on the page in correspondence with the processing instruction.

3. The method according to claim 1, further comprising the processing step of executing the processing instruction.

4. The method according to claim 3, wherein said processing step including the steps of:
assigning to the web page a predetermined index containing an identifier of the page;
storing the assigned index to a database; and
processing the displayed web page.

5. The method according to claim 3, wherein in said processing step, the displayed web page is saved.

6. The method according to claim 5, wherein in said processing step, a search is performed in the saved web page.

7. The method according to claim 1, wherein in said processing step, the displayed web page is sent.

8. The method according to claim 1, wherein in said processing step, an annotation to the displayed web page is performed.

9. The method according to claim 1, wherein in said processing step, data is extracted from the displayed web page.

10. The method according to claim 1, wherein in said processing step, the displayed web page is printed.

11. The method according to claim 10, wherein in said processing step, the displayed web page is printed in a layout set by a user.

12. The method according to claim 1, wherein in said processing step, a plurality of data is extracted from a plurality of the web page.

13. The method according to claim 12, wherein in said processing step, the plurality of extracted data is stored in a removable media, sent, or printed.

14. The method according to claim 1, further comprising the steps of:
determining whether or not a processing program for executing the processing instruction exists; and
requesting to obtain the processing program if the program is not exist.

15. The method according to claim 14, wherein in said requesting step, a user is requested to obtain the program.

16. The method according to claim 14, wherein in said requesting step, a downloading unit is requested to download the program.

17. The method according to claim 1, wherein the processing unit is in a server.

18. The method according to claim 17, further comprising the steps of:
informing a type of the processing instruction to the server; and
the type of the processing instruction is registered in correspondence with an address of the page in the server

19. The method according to claim 1, further comprising the steps of:
determining whether or not a parameter is required for executing the processing instruction; and
requesting a user to input the parameter if the parameter is required.

20. The method according to claim 19, wherein in said requesting step, a box for inputting the parameter is displayed on the page or outside of a window in which the page is displayed.

21. The method according to claim 5, wherein in said processing step, the displayed web page is saved with a name input by a user.

22. The method according to claim 5, wherein in said processing step, the displayed web page is stored without requiring a user to input a name.

23. The method according to claim 5, wherein in said processing step, a first process in which the displayed web page is stored without requiring a user to input a name is performed and if the first process cannot be performed, a second process in which the displayed web page is stored with a name input by a user is performed.

24. The method according to claim 1, wherein in said obtaining step, one of a first and second save instructions is obtained in response to an operation of one of a first and second save buttons, respectively, and in said transfer step, the first save instruction is transferred to a process for saving the page and the second save instruction is transferred to a process for saving a link to the page.

25. The method according to claim 1, wherein in said transfer step, the processing instruction is transferred to a process for sending an image of the page, if the processing instruction is a send instruction.

26. The method according to claim 1, wherein in said obtaining step, one of a first and second send instructions is obtained in response to an operation of one of a first and second send buttons, respectively, and in said transfer step, the first send instruction is transferred to a process for sending an image of the page and the second send instruction is transferred to a process for sending a link to the page.

27. The method according to claim 1, wherein in said transfer step, the processing instruction is transferred to a process for performing an annotation to the page, if the processing instruction is an annotation instruction.

28. The method according to claim 1, wherein in said transfer step, the processing instruction is transferred to a process for extracting data from the page, if the processing instruction is an extraction instruction.

29. The method according to claim 1, wherein in said transfer step, the processing instruction is transferred to a process for saving the page in a server, if the processing instruction is a save instruction, and the processing instruction is transferred to a process for searching the page, if the processing instruction is a search instruction.

30. The method according to claim 3, wherein in said processing step, the result of executing the processing instruction is informed to a user.

31. The method according to claim 3, wherein in said processing step, the execution of the processing instruction is inhibited if a condition is not satisfied.

32. The method according to claim 3, wherein in said processing step, the execution of the processing instruction is inhibited if the page is not within a predetermined site.

33. The method according to claim 3, wherein in said processing step, the execution of the processing instruction is inhibited if a number or quantity of saved data exceeds a limitation.

34. The method according to claim 1, wherein said transferring step is performed by a program embedded in the page.

35. The method according to claim 4, wherein in said storing step, the index is stored for each of a plurality of users.

36. An information processing method comprising the steps of:
obtaining a processing instruction from a displayed web page; and
executing the obtained processing instruction.

37. The method according to claim 36, wherein said executing step is performed by a program embedded in the page.

38. The method according to claim 37, wherein in said executing step, the result of executing the embedded program is transferred to a process independent of the embedded program.

39. The method according to claim 36, further comprising the steps of:
determining whether or not a parameter is required for executing the processing instruction; and
requesting a user to input the parameter if the parameter is required.

40. The method according to claim 39, wherein in said requesting step, a box for inputting the parameter is displayed on the page or outside of a window in which the page is displayed.

41. The method according to claim 36, wherein in said processing step, an annotation to the displayed web page is performed.

42. The method according to claim 36, wherein in said processing step, data is extracted from the displayed web page.

43. An information processing apparatus comprising:
obtaining means for obtaining a processing instruction from a displayed web page; and
transfer means for transferring the obtained processing instruction to a processing unit which is able to execute the processing instruction.

44. The apparatus according to claim 43, wherein the processing unit is provided in said apparatus.

45. The apparatus according to claim 43, wherein the processing unit is provided outside of said apparatus.

46. An information processing apparatus comprising:
obtaining means for obtaining a processing instruction from a displayed web page; and
execution means for executing the obtained processing instruction.

47. An information processing system in which a plurality of client terminals are connected to a server via a network, wherein each of said client terminals comprising:
obtaining means for obtaining a processing instruction from a displayed web page; and
transfer means for transferring the obtained processing instruction to a processing unit which is able to execute the processing instruction.

48. The system according to claim 47, wherein the processing unit is provided in each of said client terminals.

49. The system according to claim 47, wherein the processing unit is provided in said server.

50. A computer-executable program for controlling a computer to perform information processing, said program comprising codes for causing the computer to perform:
obtaining a processing instruction from a displayed web page; and
transferring the obtained processing instruction to a processing unit which is able to execute the processing instruction.

51. A computer-executable program for controlling a computer to perform information processing, said program comprising codes for causing the computer to perform:
obtaining a processing instruction from a displayed web page; and
executing the obtained processing instruction.
